(19) United States
(12) Patent Application Publication
(10) Pub. No.: US 2026/0221482 A1
(43) Pub. Date: Jul. 30, 2026

(54) REDOX FLOW BATTERY

(71) Applicant: CAMBRIDGE ENTERPRISE LIMITED, Cambridge (GB)

(72) Inventors: Mark CARRINGTON, Cambridge (GB); Kamil SOKOLOWSKI, Cambridge (GB); Clare Philomena GREY, Cambridge (GB); Oren SCHERMAN, Cambridge (GB)

(73) Assignee: CAMBRIDGE ENTERPRISE LIMITED, Cambridge (GB)

(21) Appl. No.: 19/147,681

(22) PCT Filed: Jan. 12, 2024
(86) PCT No.: PCT/EP2024/050728

§ 371 Date: Jul. 11, 2025

(30) Foreign Application Priority Data
Jan. 13, 2023 (GB) 2300538.2

(51) Int. Cl. H01M 8/18

(52) U.S. Cl. CPC H01M 8/188; H01M 2300/0002

(57) ABSTRACT

The present invention relates to redox flow batteries (RFBs) which are tolerant to dioxygen, a method of preparing a RFB in the presence of dioxygen, and a method of charging and/or discharging a RFB and its use in the presence of dioxygen. The RFB comprises an electrolyte, the electrolyte comprising an organic redox-active molecule comprising a redox-active unit with two or more heteroarylene groups wherein the two or more heteroarylene groups are conjugated within the redox-active unit and at least a portion of the redox-active units are present as a complex formed of a singly reduced form of the redox-active unit, and wherein molecular dioxygen (O2) dissolved in the electrolyte. The RFB of the invention can be operated in the presence of dioxygen, removing the need for the creation of strict dioxygen-free conditions by purging, sealing and flowing inert gas through the RFB.

### RELATED APPLICATIONS

This application is a U.S. national stage application under 35 U.S.C. § 371 of International Application No. PCT/EP2024/050728, filed on Jan. 12, 2024, which claims the priority to, and the benefit of, United Kingdom Application No. 2300538.2 filed on Jan. 13, 2023. The entire contents of each priority application are incorporated herein by reference.

The work leading to this application has received funding from the European Union's Horizon 2020 research and innovation programme (European Research Council grant agreements No. 726470 and 835073 and Marie Sklodowska-Curie grant agreement No. 706425).

### FIELD OF THE INVENTION

The present invention relates to redox flow batteries (RFBs) which are tolerant to dioxygen, a method of preparing a RFB in the presence of dioxygen, and a method of charging and/or discharging a RFB and its use in the presence of dioxygen.

### BACKGROUND

A RFB is a type of electrochemical storage device in which energy is stored in a liquid electrolyte rather than in a solid electrode material. This feature allows the capacity of a RFB to be scaled up in a cost-efficient way simply by changing the size of the electrolyte reservoir. Their layout can also be flexible, as the electrochemical cells components and the electrolyte reservoirs can be situated in separate locations. Accordingly, RFBs are a promising approach for large-scale energy storage such as power network or grid-storage. RFBs may provide an important form of grid storage to smooth energy fluctuations from intermittent renewable energy sources such as solar and wind.

During battery operation, the electrolytes—known as catholyte and anolyte—flow through an electrochemical cell where they undergo redox reactions, either storing or releasing charge. The electrolytes are then stored in an electrolyte reservoir in their reduced or oxidised state. The electrolyte comprises a redox-active species which facilitates the reduction or oxidation.

Among redox-active species, those based on organic molecules provide both substantial cost benefits over existing chemistries (e.g. zinc or vanadium-based electrolytes), and offer good energy density.

Viologens (4,4′-bispyridinium compounds) are organic redox-active species that often provide good aqueous solubility, negative potentials, and electrochemical stability under neutral conditions, as needed for RFBs. Acidic or basic conditions may also be used to solubilise organic redox-active species.

Viologens have been demonstrated as RFB redox-active species in a variety of single and double-electron couples (DeBruler et al., Beh et al., Luo et al.). They have also been incorporated into larger organic materials, such as organic polymers (Janoschka et al.) and polypeptides (Nguyen et al.) to provide a redox-active species for RFB electrolytes.

A common problem with RFBs (e.g. viologen based RFBs) is degradation of the redox-active species in the electrolyte by parasitic side-reactions during cell cycling. One proposed problem with such RFBs is degradation of the redox-active species due to association at high concentrations (see Kwabi et al.). It is thought that the redox-active species undergo intermolecular association (e.g. dimerisation) and/or electrolyte-electrode association, which contributes to degradation. However, it is desirable to operate RFBs at a high concentration of redox-active molecules in the electrolyte, to maximise energy density—but doing so is thought to promote degradation.

Above concentrations of about 0.1 mM in aqueous environments, assembled structures may form among reduced viologen organic redox-active species such as π-dimers, σ-dimers and charge transfer complexes. The formation of dimers has been previously linked to capacity fade (Kwabi et al.). Thus, the design of viologen redox-active species and electrolytes has sought to supress such dimerisation processes.

Side-reactions with dioxygen are also particularly problematic. The redox-active species in the electrolyte may exist as mono- and di-radicals in RFB systems during cell cycling, which can transfer electrons to dissolved dioxygen to form reactive dioxygen species (such as peroxides, superoxides, and hydroxyl radicals). These reactive dioxygen species take part in parasitic side-reactions during cell cycling. Specifically, viologen mono- and di-radicals in RFB systems are known to readily transfer electrons to dissolved dioxygen, leading to the formation of reactive oxygen species (ROS) (Bird et al.).

In order to supress dioxygen-mediated side-reactions, RFBs are cycled under strict dioxygen-free conditions. For example, gaseous dioxygen is excluded from the head space over the electrolytes in the electrochemical cell and electrolyte reservoir, and dissolved dioxygen is removed from the electrolyte itself. During preparation of known RFBs, dissolved dioxygen is typically removed by purging the electrolyte with an inert gas. The head space is also purged with inert gas during preparation, and is then sealed from air during operation. The electrolyte headspace may also be put under a positive flow of inert gas during operation, to remove any dioxygen generated during operation.

The sensitivity to dioxygen is particularly problematic for aqueous electrolytes. In water, dioxygen can be generated in situ by cycling the RFB at voltages outside of the stability window of water (e.g. an open circuit voltage of more than about 1.23V). As a result, most aqueous RFBs to date are cycled at open-circuit voltages of less than 1.23V, to avoid in-situ generation of dioxygen by splitting of water (Perry et al.). This maximum operation voltage is very low compared to many common battery technologies (e.g. lithium ion batteries) which operate at around 3 to 4V per cell. This restricts the energy density and electrical efficiencies of RFBs. High currents are often required to compensate for the low voltage, which reduces efficiency.

All viologen RFB cycling studies to date have been run under a rigorously air free environment. It is well known that viologen RFBs are sensitive to dioxygen molecules, and so dioxygen is removed from the RFB by purging. Removal of dioxygen is ubiquitous with RFB preparation and operation.

However, the additional steps required to keep the RFBs dioxygen-free make manufacture and operation of RFBs complex and costly. This is a significant barrier to large scale adoption of RFBs. Relatedly, the low voltages needed to avoid in-situ dioxygen generation for aqueous RFBs is inhibiting large scale adoption, as energy densities are limited compared to higher-voltage systems.

Accordingly, there is a need for RFBs, particularly RFB organic electrolytes, which can be used in the presence of dioxygen without it being detrimental to performance.

### SUMMARY OF THE INVENTION

At its most general, the present invention provides a redox flow battery (RFB) that comprises molecular dioxygen (O2) dissolved in the electrolyte. The RFB can be cycled in the presence of dioxygen, such as in air.

Generally, the invention relates to a RFB that comprises an electrolyte, the electrolyte comprising:
an organic redox-active molecule, wherein at least a portion of the organic redox-active molecule is present as a complex formed of a reduced form of the organic redox-active molecule, and
molecular dioxygen (O₂) dissolved in the electrolyte.

The complexation of the reduced form of the organic redox-active molecule affords dioxygen tolerance to the redox-active species, by providing a competing pathway to degradation reactions with dioxygen. This in turn affords dioxygen tolerance to the RFB.

In a general aspect of the invention there is provided a redox flow battery comprising an electrolyte, the electrolyte comprising:
an organic redox-active molecule comprising a redox-active unit with two or more heteroarylene groups wherein the two or more heteroarylene groups are conjugated within the redox-active unit and at least a portion of the redox-active units in the electrolyte are present as a complex formed of a singly reduced form of the redox active unit, and
molecular dioxygen (O₂) dissolved in the electrolyte.

In a first aspect of the invention there is provided a redox flow battery comprising an electrolyte, the electrolyte comprising:
an organic redox-active molecule comprising a redox-active unit with two or more heteroarylene groups wherein the two or more heteroarylene groups are conjugated within the redox-active unit, and at least a portion of the redox-active units in the electrolyte are present as a complex formed of a singly reduced form of the redox active unit, and
molecular dioxygen (O₂) dissolved in the electrolyte;
where the complex is an intermolecular complex of redox-active units, such as a homodimer, an intramolecular complex of redox-active units, or the complex is a combination of intermolecular and intermolecular complexed redox-active units.

In some embodiments there is provided a redox flow battery comprising an electrolyte, the electrolyte comprising:
an organic redox-active molecule comprising two or more heteroarylene groups wherein the two or more heteroarylene groups are conjugated, and at least a portion of the organic redox-active molecule is present as a complex formed of a singly reduced form of the organic redox-active molecule, and
molecular dioxygen (O₂) dissolved in the electrolyte.

In some embodiments the complex is a dimer, such as a homodimer, formed of a singly reduced form of the organic redox-active molecule.

In some embodiments the organic redox-active molecule comprises a redox-active unit of Formula (I-A):

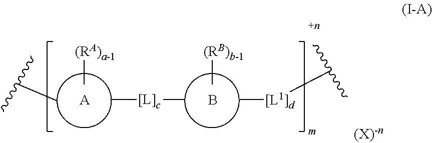

wherein:
-A- and -B- are each independently C₅₋₁₀ arylene;
each -L- is independently selected from C₅₋₁₄ arylene, a bond, C₂₋₆ alkenylene, C₂₋₄ alkynylene, wherein the C₅₋₁₄ arylene and C₂₋₄ alkenylene are optionally substituted with one or more —R^{C} groups;
-L¹- is independently selected from a bond, C₁₋₆ alkylene, C₅₋₁₄ arylene, —N(H)—, and —(CH₂O)ₐ₁—(C₂H₄O)ₐ₂—(C₃H₆O)ₐ₃—(CH₂C(O))ₐ₄—, wherein the C₁₋₆ alkylene and C₅₋₁₄ arylene are optionally substituted with one or more —R^{D} groups, and
   wherein a1, a2, a3 and a4 are each independently selected from 0 to 12 and the sum of a1, a2, a3 and a4 is from 1 to 12;
each of —R^{A}, —R^{B}, —R^{C} and —R^{D} where present, is a hydrophilic group;
X is one or more counter anions;
n is from 2 to 4;
a and b are independently from 1 to 5;
c and d are independently from 1 to 5;
two or more of -A-, -B- and -L- are C₅₋₁₀ heteroarylene; and
m is 1 or more.

In some embodiments, the organic redox-active molecule is of Formula (I-B):

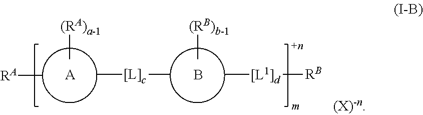

wherein -A-, -B-, -L-, -L¹-, —R^{A}, —R^{B}, —R^{C}, —R^{D}, X, a, b, c, d, n and m are as defined for Formula (I-A).

In some embodiments the organic redox-active molecule is of Formula (I-C):

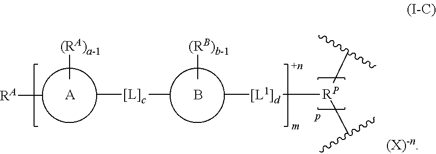

wherein:
-A-, -B-, -L-, -L¹-, —R^{A}, —R^{B}, —R^{C}, —R^{D}, X, a, b, c, d, n and m are as defined for Formula (I-A);
R^{P} is a polymer repeating unit;
p is 2 or more.

In some embodiments the organic redox-active molecule is of Formula (I-D):

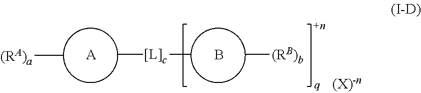

wherein:
-A-, -B-, -L-, —R^{A}, —R^{B}, —R^{C}, X, a, b, c, and n are as defined for Formula (I-A); and
q is from 1 to 5.

In some embodiments, the organic redox-active molecule is of Formula (I):

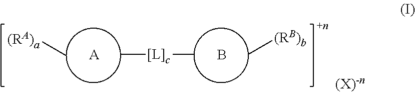

wherein
-A- and -B- are each independently C₅₋₁₀ arylene;
each -L- is independently selected from C₅₋₁₄ arylene, a bond, C₂₋₆ alkenylene, and C₂₋₄ alkynylene, wherein the C₅₋₁₄ arylene and C₂₋₆ alkenylene are optionally substituted with one or more groups —R^{C};
at least one of —R^{A} and —R^{B}, and —R^{C} where present, is independently a hydrophilic group;
X is one or more counter anions;
n is from 2 to 4;
each of a, b and c is independently from 1 to 5; and
two or more of -A-, -B- and -L- are C₅₋₁₀ heteroarylene.

In some embodiments, the organic redox-active molecule is of Formula (II):

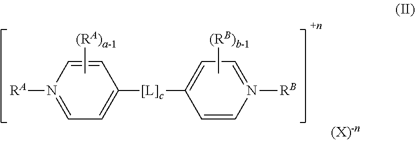

wherein -L-, —R^{A}, —R^{B}, X, n, a, b and c are as defined for Formula (I).

In some embodiments, the organic redox-active molecule is a viologen or extended viologen.

Traditionally, complexation, such as dimerisation, has been attributed to capacity fade and is connected with precipitation of the reduced electrolyte molecules, for example due to electrolyte-electrode interactions. Precipitation at the RFB electrode is also known to cause electrode degradation. As a result, known organic redox-active molecules and electrolytes have been actively designed to prohibit dimerisation, so as to avoid the capacity fade and solubility issues.

However, the present inventors have identified that capacity fade of RFBs can be minimised in the presence of dioxygen using this complexation (e.g., dimerisation). The redox-active molecules and electrolyte conditions developed by the inventors ensure that both the propensity of the reduced form of the electrolyte material for complexation is increased and the associated radical complex retains solubility in the electrolyte. This has been achieved by the provision of a redox-active species having a conjugated heteroarene system and solubilising groups (e.g. hydrophilic groups), such as the organic redox-active species of the Formulas shown above, which may be viologen or extended viologen species.

Without wishing to be bound by theory, it is thought that the complex acts to stabilise the redox-active species through radical pairing by providing charge transfer interactions, as well as steric protection and multiple resonance structures. Moreover, the radical pairing effectively lowers the radical concentration, while keeping the oxidation state of the species unchanged.

In addition to complexation, the inventors have also identified that a wide singlet-triplet gap (E_{ST}) as stabilising the doubly reduced redox-active species to dioxygen via intramolecular electron pairing. In particular, a negative E_{ST} indicates that the singlet state is energetically favoured, and a large negative E_{ST} means the more reactive triplet state is inaccessible at typical operating temperatures.

Accordingly, in some embodiments the doubly reduced form of the organic redox-active molecule has a singlet-triplet energy gap (E_{ST}) of less than 0 kcal mol⁻¹ (0 kJ mol⁻¹), preferably −6.0 kcal mol⁻¹ (−25.1 kJ mol⁻¹) or less.

The combination of stabilisation through complexation and a large E_{ST} has been achieved by the provision of a redox-active species having a conjugated heteroarene system and solubilising groups (e.g. hydrophilic groups), such as the organic redox-active species of Formulas (I) or (II) described herein, which may be viologen or extended viologen species.

The dioxygen tolerant electrolyte has various advantages for RFBs. For example, it may allow RFBs to be prepared and cycled in the presence of dioxygen, removing the need for the creation of strict dioxygen-free conditions. By no longer needing to purge, seal and flow inert gas through the RFB, the cost of producing and operating an RFB can be reduced.

In addition, by making the redox-active species dioxygen tolerant, it is also possible to cycle aqueous electrolyte based RFBs at higher voltages. As explained above, cycling at voltages above the stability window of water (i.e. 1.23 V or more) is possible without causing degradation mediated by the dioxygen generated in the electrolyte. As a result of the higher voltage, the energy density and electrical efficiencies of the cell can be increased.

The above advantages remove various barriers previously hindering large scale adoption of RFBs. The present invention provides a promising approach for large-scale adoption of RFBs, such as grid scale storage batteries.

In a second aspect of the invention there is provided a a method of preparing a redox flow battery, the method comprising:
preparing an electrolyte by combining an organic redox-active molecule with a liquid carrier, wherein the organic redox-active molecule comprises a redox-active unit with two or more heteroarylene groups and the two or more heteroarylene groups are conjugated within the redox-active unit;
adding the electrolyte to the redox flow battery wherein molecular dioxygen (O₂) is dissolved in the electrolyte, and reducing the organic redox-active molecule to provide a singly reduced form of the redox-active unit which forms a complex,
   where the complex is an intermolecular complex of redox-active units, such as a homodimer, an intramolecular complex of redox-active units, or the complex is a combination of intermolecular and intermolecular complexed redox-active units.

In some embodiments, the method comprises:
preparing an electrolyte by combining an organic redox-active molecule with a liquid carrier, wherein the organic redox-active molecule comprises two or more heteroarylene groups and the two or more heteroarylene groups are conjugated,
adding the electrolyte to the redox flow battery wherein molecular dioxygen (O₂) is dissolved in the electrolyte, and
reducing the organic redox-active molecule to provide a singly reduced form of the organic redox-active molecule which forms a complex.

In a third aspect of the invention there is provided a redox flow battery obtained or obtainable by the method of the second aspect.

In a fourth aspect of the invention there is provided a method of charging and/or discharging a redox flow battery in the presence of molecular dioxygen, the redox flow battery comprising an electrolyte, the electrolyte comprising:
an organic redox-active molecule comprising a redox active unit with two or more heteroarylene groups wherein the two or more heteroaryl groups are conjugated within the redox-active unit, and
molecular dioxygen (O₂) dissolved in the electrolyte;
   the method comprising:
reducing the redox-active unit to provide a complex formed of a singly reduced form of the redox-active unit, and/or
oxidising a double reduced form of the redox-active unit to provide a complex formed of a singly reduced form of the redox-active unit,
   where the complex is an intermolecular complex of redox-active units, such as a homodimer, an intramolecular complex of redox-active units, or the complex is a combination of intermolecular and intermolecular complexed redox-active units.

In some embodiments the redox flow battery comprises an electrolyte, the electrolyte comprising:
an organic redox-active molecule comprising two or more heteroarylene groups wherein the two or more heteroaryl groups are conjugated and
molecular dioxygen (O₂) dissolved in the electrolyte, the method comprising:
reducing the organic redox-active molecule to provide a complex formed of a singly reduced form of the organic redox-active molecule, and/or
oxidising a double reduced form of the organic redox-active molecule to provide a complex formed of a singly reduced form of the organic redox-active molecule.

In a fifth aspect of the invention there is provided a use of redox flow battery for charging and/or discharging in the presence of molecular dioxygen, the redox flow battery comprising an electrolyte, the electrolyte comprising:
an organic redox-active molecule comprising a redox-active unit with two or more heteroarylene groups wherein the two or more heteroarylene groups are conjugated within the redox-active unit, and at least a portion of the redox-active units are present as a complex formed of a singly reduced form of the redox-active unit, and
molecular dioxygen (O₂) dissolved in the electrolyte;
where the complex is an intermolecular complex of redox-active units, such as a homodimer, an intramolecular complex of redox-active units, or the complex is a combination of intermolecular and intermolecular complexed redox-active units.

In some embodiments, the redox flow battery comprises an electrolyte, the electrolyte comprising:
an organic redox-active molecule comprising two or more heteroarylene groups wherein the two or more heteroarylene groups are conjugated, and at least a portion of the organic redox-active molecule is present as a complex formed of a singly reduced form of the organic redox-active molecule, and
molecular dioxygen (O₂) dissolved in the electrolyte.

In some embodiments of the second to fifth aspects, the organic redox-active molecule comprises a unit of formula (I-A), as defined above.

In some embodiments of the second to fifth aspects, the organic redox-active molecule is of formula (I-B), as defined above.

In some embodiments of the second to fifth aspects, the organic redox-active molecule is of formula (I-C), as defined above.

In some embodiments of the second to fifth aspects, the organic redox-active molecule is of formula (I-D), as defined above.

In some embodiments of the second to fifth aspects, the organic redox-active molecule is of formula (I), as defined above. In some embodiments of the second to fifth aspects, the organic redox-active molecule is of formula (II), as defined above.

In some embodiments of the second to fifth aspects, the organic redox-active molecule is a viologen or extended viologen species.

In some embodiments of the second to fifth aspects, the complex is a dimer, such as a homodimer, formed of a singly reduced form of the organic redox-active molecule.

### SUMMARY OF THE FIGURES

The present invention is described with reference to the figures listed below.

FIG. 1 is a ¹H NMR spectrum of compound 1 synthesised using palladium on activated carbon as a catalyst.

FIG. 2 is a (a) Comparison between classical diradical hydrocarbons and bispyridinium diradicals. (b) Schematic representation of compounds 10-19. (c) Linear correlations obtained between DFT-calculated redox potential values and tabulated experimental meta Hammett constant values (σₘ) for R-groups introduced to pyridinium nitrogens. Trendlines indicate least squares linear fits obtained for first and second redox events. (d) Plot of solubility versus first reduction potential for compounds 10-19. Filled circles indicate electrochemically reversible compounds. Empty circles indicate electrochemically irreversible compounds. The shaded region indicates compounds with reduction potentials below those of any bispyridinium electrolyte featuring an unsubstituted core reported to date. The dashed line (grey) indicates the lowest reduction potential reached by a bispyridinium RFB electrolyte—substituted or unsubstituted (e) Voltammograms for compounds 10-19 ordered by their respective singlet-triplet gap (E_{ST}) values.

FIG. 3 is coupled in situ NMR and EPR spectroscopy where 10 mM (a) 10, (e) 11, (i) 13 in 100 mM NaCl and 20 mM 4-hydroxy-TEMPO in 100 mM NaCl full cell as a function of time for one full charge-discharge cycle. A current of 2 mA cm⁻² was used. Cutoff voltages of 0.5 V (10, 11 & 13), 1.90 V (10), 1.95 V (11) and 2.00 V (13) were used with 1 h potential holds being applied at the respective cutoff values. NMR (b,f,j) and EPR (c,g,k) spectra collected over the charge-discharge cycle. (d,h,l) Oxidation states of 10, 11 and 13 and their respective NMR proton assignments. Chloride counterions are omitted for clarity. The proton assignment e* indicates that proton e undergoes fast hydrogen-deuterium exchange, reducing its intensity and limiting observation by NMR.

FIG. 4 shows coupled in situ NMR and EPR spectroscopy for 17 and 18. Voltage of a 10 mM (a) 17, (e) 18 in 100 mM NaCl and 20 mM 4-hydroxy-TEMPO in 100 mM NaCl full cell as a function of time for one full charge-discharge cycle. A current of 2 mA cm⁻² was used. Cutoff voltages of 0.5 V (17 & 18), 1.75 V (17), and 1.85 V were used with 1 h potential holds being applied at the respective cutoff values. NMR (b,f) and EPR (c,g) spectra collected over the charge-discharge cycle. (d,h) Oxidation states of 17 and 18 and their respective NMR proton assignments. Chloride counterions are omitted for clarity.

FIG. 5 shows Coupled in situ NMR and EPR spectroscopy for 11 at 1 mM. Voltage of a 1 mM (a) 11 in 100 mM NaCl and 2 mM 4-hydroxy-TEMPO in 100 mM NaCl full cell as a function of time for one full charge-discharge cycle. A current of 0.2 mA cm⁻² was used. Cutoff voltages of 0.5 V and 1.95 V were used with 1 h potential holds being applied at the respective cutoff values. NMR (b) and EPR (c) spectra collected over the charge-discharge cycle. EPR spectral features indicate the presence of ultra-trace quantities of 4-OH-TEMPO crossover. (d) Structure of 11 and its respective NMR proton assignments.

FIG. 6 displays performance characteristics of 17 and 18. Voltage versus discharge capacity over five full charge-discharge cycles for 10 mM (a) 17 and (b) 18 in 100 mM NaCl and 20 mM 4-hydroxy-TEMPO in 100 mM NaCl full cells. A current of 2 mA cm⁻² was used in all cases. Cutoff voltages of 0.5 V (17 & 18), 1.75 V (17) and 1.85 V (18) were used with 1 h potential holds being applied at the respective cutoff values.

FIG. 7 is a Normalised discharge capacity versus cycle number for 17, and 18 at 10 mM concentrations. Coulombic efficiencies for 17 and 18 were 78.6±0.3 and 79.7±2.8 respectively.

FIG. 8 shows reduced bispyridinium compounds, their performance characteristics and dimerisation propensity. (a) Radical concentration profiles for 10, 11, and 13 during charge derived from spin counting based on the EPR data shown in FIG. 2. (b) Spectroelectrochemical data for 10, 11, and 13 at a concentration of 1 mM. Bands assigned to singly-reduced and π-dimeric species are shown. (c) Voltage versus discharge capacity over five full charge-discharge cycles for 10 mM 10, 11 and 13 in 100 mM NaCl and 20 mM 4-hydroxy-TEMPO in 100 mM NaCl full cells. A current of 2 mA cm⁻² was used in all cases. For compound 11, voltage versus discharge capacity data over five full charge-discharge cycles for 5 mM and 1 mM 11 full cells are overlaid. The 5 mM 11 in 100 mM NaCl and 10 mM 4-hydroxy-TEMPO in 100 mM NaCl full cell was cycled at a current of 1 mA cm⁻². The 1 mM 11 in 100 mM NaCl and 2 mM 4-hydroxy-TEMPO in 100 mM NaCl full cell was cycled at a current of 0.2 mA cm⁻². Cutoff voltages of 0.5 V (10, 11 & 13), 1.90 V (10), 1.95 V (11) and 2.00 V (13) were used with 1 h potential holds being applied at the respective cutoff values. (d) Discharge capacity versus cycle number for 11 at 10 mM, 5 mM and 1 mM concentrations. (e) Normalised discharge capacity versus cycle number for 10, 11, and 13 at 10 mM concentrations.

FIG. 9 shows the influence of dioxygen on viologen redox processes and its suppression through π-dimerisation. (a) Operando online electrochemical mass spectrometry (OEMS) of a 1 mM 11 in 100 mM NaCl and 2 mM 4-hydroxy-TEMPO in 100 mM NaCl H-cell during one full charge discharge cycle in an atmosphere of 1% O₂ in Ar. A current of 0.2 mA was used. A potential hold of 2 h was applied at 1.95 V after 8 h of charging. (b) Voltage, normalised discharge capacity and Coulombic efficiency of a 25 mM 11 in 500 mM NaCl and 50 mM 4-hydroxy-TEMPO in 500 mM NaCl full cell cycled 6 times in N₂, 5 times in air, and 10 times in N₂. A current of 5 mA cm⁻² was used. (c) Voltage, normalised discharge capacity and Coulombic efficiency of a 50 mM 11 in 500 mM NaCl and 100 mM 4-hydroxy-TEMPO in 500 mM NaCl full cell cycled 6 times in N₂, 5 times in air, and 10 times in N₂. A current of 5 mA cm⁻² was used. (d) OEMS of 50 mM H-cells subjected to a 2 h potential hold at 1.95 V under atmospheres of 1% O₂ in Ar and 20% O₂ in Ar respectively, relative to that of the 1 mM H-cell described in FIG. 4a. A current of 1.55 mA was used in both cases. (e) Voltage, normalised discharge capacity and Coulombic efficiency of a 250 mM 11 and 250 mM 4-hydroxy-TEMPO in 1 M NaCl full cell cycled 5 times in N₂ at a current density of 20 mA cm⁻², 15 times in air at a current density of 20 mA cm⁻², 111 times in air at a current density of 40 mA cm⁻², 5 times in air at a current density of 20 mA cm⁻², and 200 times in air at a current density of 30 mA cm⁻². Cutoff voltages of 0.5 V and 1.65 V were used.

FIG. 10 shows the influence of dioxygen on viologen redox processes and its suppression through π-dimerisation for compound 17. Voltage, normalised discharge capacity and Coulombic efficiency of a 50 mM 17 in 500 mM NaCl and 100 mM 4-hydroxy-TEMPO in 500 mM NaCl full cell cycled 5 times in N₂, 5 times in air, and 8 times in N₂. A current of 5 mA cm⁻² was used.

FIG. 11 shows repeat cycling of 17 at high concentrations, illustrating the air tolerance of 17. Voltage, normalised discharge capacity and Coulombic efficiency of a 250 mM 17 and 250 mM 4-hydroxy-TEMPO in 1 M NaCl full cell cycled 5 times in N₂ at a current density of 20 mA cm⁻², 15 times in air at a current density of 20 mA cm⁻², 67 times in air at a current density of 40 mA cm⁻², 5 times in air at a current density of 20 mA cm⁻², and 100 times in air at a current density of 30 mA cm⁻². Cutoff voltages of 0.5 V and 1.60 V were used.

FIG. 12 shows (A) voltammograms for compound 10 at a concentration of 1 mM under nitrogen (dashed line), compound 20 at a concentration of 1 mM under nitrogen (dark blue line) and compound 20 at a concentration of 1 mM under air (light blue line). The reversible potentials of −0.147 V and −0.386 V were calculated from the peaks in the voltammogram. (B) shows a ¹H NMR spectrum for compound 20.

### DETAILED DESCRIPTION OF THE INVENTION

The present invention provides a redox flow battery (RFB) that comprises molecular dioxygen (O₂) dissolved in the electrolyte. The RFB can be cycled in the presence of dioxygen, such as in air.

Generally, the present invention provides an electrolyte for a RFB including a redox-active species which is tolerant to molecular dioxygen. The redox-active species is configured to complex in its singly reduced form, which provides improved tolerance to molecular dioxygen.

More specifically, the invention relates to a RFB that comprises an electrolyte, the electrolyte comprising:
an organic redox-active molecule, wherein at least a portion of the organic redox-active molecule is present as a complex formed of a reduced form of the organic redox-active molecule, and
molecular dioxygen (O₂) dissolved in the electrolyte.

In a first aspect of the invention there is provided a redox flow battery comprising an electrolyte, the electrolyte comprising:
an organic redox-active molecule comprising a redox-active unit with two or more heteroarylene groups wherein the two or more heteroarylene groups are conjugated within the redox-active unit, and at least a portion of the redox-active units in the electrolyte are present as a complex formed of a singly reduced form of the redox active unit, and
molecular dioxygen (O₂) dissolved in the electrolyte;
where the complex is an intermolecular complex of redox-active units, such as a homodimer, an intramolecular complex of redox-active units, or the complex is a combination of intermolecular and intermolecular complexed redox-active units.

In some embodiments, the complex is a dimer.

In some embodiments, the organic redox-active molecule is of formula (I):

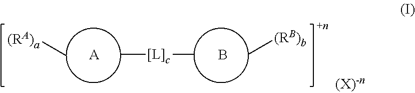

wherein:
-A- and -B- are each independently C₅₋₁₀ arylene;
each -L- is independently selected from C₅₋₁₄ arylene, a bond, C₂₋₆ alkenylene and C₂₋₄ alkynylene, wherein C₅₋₁₄ arylene and C₂₋₆ alkenylene are optionally substituted with one or more groups —R^{C};
at least one of —R^{A} and —R^{B}, and —R^{C} where present, is independently a hydrophilic group;
X is one or more counter anions;
n is from 2 to 4;
each of a, b and c is independently from 1 to 5; and
two or more of -A-, -B- and -L- are C₅₋₁₀ heteroarylene.

In some embodiments, the organic redox-active molecule is of formula (II):

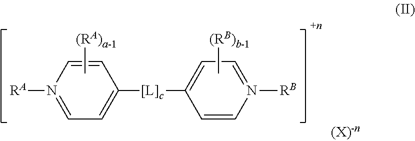

wherein -L-, —R^{A}, —R^{B}, X, n, a, b and c are as defined for formula (I).

In some embodiments, the organic redox-active molecule is a viologen or extended viologen.

The present invention achieves dioxygen tolerance by providing a redox-active species which has an increased propensity for complexation, such as dimerisation, in the singly reduced form (e.g. by using an extended aromatic core) and has improved aqueous solubility of the redox-active species complex (e.g. by using hydrophilic appendages). In known systems, singly reduced forms of the redox-active species are prone to side reactions. However, complexation (e.g., dimerisation) of the redox-active species has now been found to compete with the side reactions, limiting degradation through side reactions.

Some specific organic redox-active species are known.

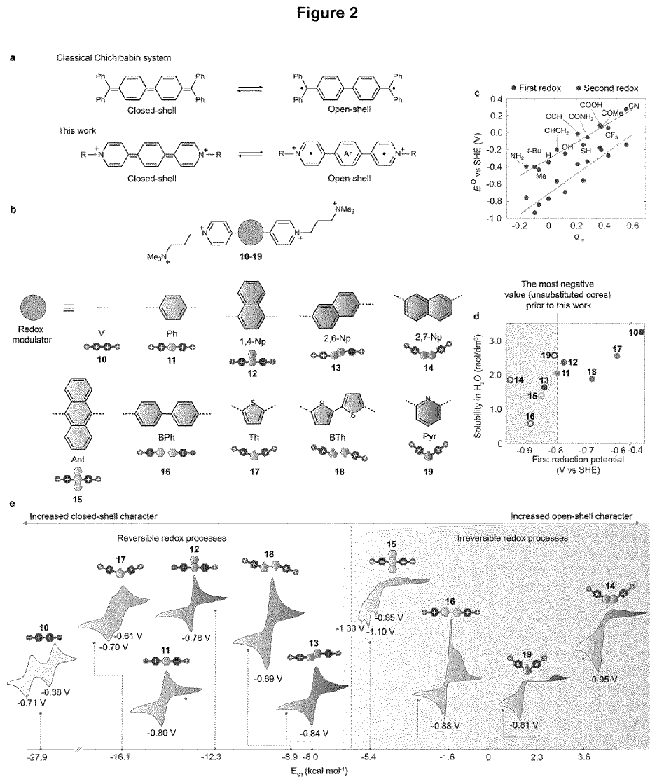

Tang et al. describes viologens, phenyl extended viologens and methyl substituted phenyl extended viologens as redox-active species for RFB electrolytes. All of the RFBs described are operated in an dioxygen free environment. This can be seen by the absence of dioxygen from the voltammograms in Tang et al. (see FIGS. 2 and S9). In addition, the absence of dioxygen is apparent from the high columbic efficiency of from about 95 to 100% (see Table S2).

Tang et al. also teaches to propensity for dimerisation of the viologen, because it is thought to promote degradation by side-reactions and result in precipitation of the redox-active species during reduction. This leads to capacity fade during cell cycling. Dimerisation is said to increase at high concentrations of redox-active species, and so the concentration of redox-active species in the electrolyte is kept low at 10 mM. Tang et al. focuses on redox-active species which propensity for dimerisation due to steric or electronic constraints. Methylated viologen electrolytes are preferred because they do not dimerise, due to higher steric hinderance. Thus, Tang et al. does not describe an RFB comprising dimerised redox-active species where dioxygen is present in the electrolyte and/or electrolyte reservoir.

Luo et al. (and the corresponding patent application US 2020/016891) describe 4,4′-(thiazolo[5,4-d]thiazole-2,5-diyl)bis(1-(3-(trimethylammonio)propyl)pyridin-1-ium) tetrachloride. The thiazolo[5,4-d]thiazole extended viologen was tested as a redox-active species for an RFB electrolyte. The RFBs described are operated in an dioxygen free environment.

The thiazolo[5,4-d]thiazole extended viologen electrolyte showed poorer capacity retention and energy efficiency at higher concentrations, which was thought to be due to increased electrolyte-electrolyte interaction and dimerisation. Luo et al. reports that the improved pi-conjugation provided by the thiazolo[5,4-d]thiazole core is important for the performance of the electrolyte.

Luo et al. comments on the dioxygen insensitivity of the reduced 2+ form of the thiazolo[5,4-d]thiazole extended viologen redox-active species. The stability is demonstrated is said to be due to the pi-conjugation provided by the thiazolo[5,4-d]thiazole core. The document does not test the viologen electrolyte during cell cycling or at any other oxidation state, and does not provide a redox flow cell where the electrolyte and/or electrolyte reservoir do not include dioxygen molecules.

Beh et al. describes RFBs using viologen redox-active species. The RFBs described are operated in a dioxygen free environment. Beh et al. confirms that viologen redox-active species show a very fast drop in discharge capacity and poor columbic efficiency when operated in air (see Figure S5 of Beh et al.).

WO 2021/055275 relates to 2,5-dimercapto-1,3,4-thiadiazole based electrolytes for redox flow batteries. The example electrolytes tested include heteroarylene groups separated by one or more sulphur atoms, so there is no conjugation between the heteroarylene groups. The electrolytes are described as dimerising through the formation of S—S covalent bonds when oxidised (see paragraph [0005] and structures in paragraph [0031]). This contrasts to the preferred σ or π dimerisation which occurs for the reduced species of the present invention.

WO 2023/046710 relates to viologen electrolytes using a variety of terminal groups (see FIG. 2). D2 does not describe dimerisation of the viologen electrolytes. D2 also does not describe air stability of the viologen. It is well known that RFBs containing standard viologen anolytes require oxygen free atmosphere for operation (for example, see Janoschka et al. and Luo et al.). Beh et al. also shows that a compound of this type is unstable to air.

US 2022/0384834 and US 2022/0020990 describe RFB electrolyte compositions including TEMPO-based redox-active species, standard viologens, extended viologens or a mixture of these components. The preferred embodiments relate to a viologen with an appended TEMPO group (see Examples 3, 4, 6 and 7). These compounds differ from the preferred redox-active species of the invention. The documents do not describe dimerisation of the viologen species or oxygen tolerance of the RFB electrolyte.

US 2022/0020990 explains that an organic RFB must be kept oxygen free.

US 2022/0190374 describes a viologen electrolyte for RFBs, with terminal groups intended to lower the viologen melting point. The document does not describe the preferred redox-active species of the invention. The document explains that the electrolyte solution was purged with nitrogen gas, and nitrogen was maintained in the cell headspace when carrying out CV tests (see paragraph [0059]). There is no description of oxygen tolerance or dimerisation of the redox-active species.

CN 112500329 describes a TEMPO and viologen RFB electrolyte. The document suggests that the electrolyte does not need to be cycled under an inert atmosphere when used in a salt cavern battery, where air exposure is inherently limited (see paragraph [0028]). This appears to be achieved by using TEMPO to react with reactive oxygen species (ROS). TEMPO can quench ROS and when present in the anolyte solution can improve air-tolerance. However, the preferred redox-active species of the present invention are not mentioned in the document, and the dimerisation of the redox-active species is also not described. The dimerisation of the redox-active species of the invention is thought to result in oxygen stability without the need for a sacrificial electrolyte component to consume ROS, such as TEMPO.

WO 2022/236241 describes viologens as anolytes for RFBs. Paragraphs [0102] and [0106] describe the oxygen sensitivity of the reduced viologen forms of the compounds. The associated literature paper explains that the cells were tested in an oxygen free glovebox (see Sullivan et al.). The document does not describe the preferred redox-active species of the present invention, and the dimerisation of the redox-active species is also not described.

### Redox Flow Battery

The RFB may be a full flow battery or hybrid flow battery.

The RFB may comprise multiple electrochemical cells, typically arranged in parallel.

Electrochemical cells are typically assembled into stacks. The stacks may be connected in series or parallel, and are preferably connected in in parallel.

An RFB typically comprises an electrochemical cell, an electrolyte reservoir in fluid communication with the cell, wherein the electrolyte is provided in each of the cell and the reservoir.

A battery headspace is generally present in contact with the electrolyte. The battery headspace may be located in an electrolyte reservoir or in an electrochemical cell.

The RFB comprises an electrochemical cell, an electrolyte reservoir and an electrolyte. Typically, the RFB comprises a flow circuit for circulation of an electrolyte between the electrochemical cell and the electrolyte reservoir. In other words, the electrochemical cell and the electrolyte reservoir may be in fluid communication. The RFB may comprise a pump for circulating the electrolyte between the electrochemical cell and the electrolyte reservoir. The type of pump is not particularly limited. A piston, peristaltic or rotary pump may be used.

The pump may circulate the electrolyte at any suitable rate, as would be known to the skilled person in the art. The flow rate will depend on the size of the RFB and the total volume of the electrolyte. The flow rate may be equal to about 25-150%, of the total electrolyte volume per minute. For example, for 30 ml of electrolyte, the flow rate may be from 7.5 to 45 ml/min. Larger volumes of electrolyte may have a lower flow rate.

Redox reactions occur within the electrode, storing or releasing charge from the electrolyte by oxidation or reduction. The electrolyte is then flowed back to the electrolyte reservoir to store the oxidised/reduced electrolyte.

The RFB includes an electrolyte comprising a redox-active species, as described below.

The redox-active species may be present in the electrolyte at a concentration of 50 mM or more, preferably 250 mM or more, more preferably 500 mM or more, yet more preferably 1 M or more. The redox-active species may be present in the electrolyte at a concentration of 2 M or less, preferably 1.8 M or less, more preferably 1.6 M or less. The redox-active species may be present in the electrolyte at a concentration of from 50 mM to 2 M, preferably from 250 mM to 1.8 M, more preferably from 500 mM to 1.6 M, yet more preferably from 1 M to 1.5M.

In some embodiments, the redox-active species may be present in the electrolyte at a concentration of 50 mM or more, preferably 150 mM or more, more preferably 250 mM or more. The redox-active species may be present in the electrolyte at a concentration of from 50 mM to 250 mM.

The RFB typically comprises two electrolytes, known as the catholyte and the anolyte. The anolyte and catholyte each include a redox-active species. Preferably, the redox-active species of the present invention is included in the anolyte.

Any suitable redox-active species may be used in the catholyte. In some embodiments, the catholyte may include a ferrocene based redox-active species, a TEMPO based redox-active species, or a thiourea species. Preferably, the catholyte is a TEMPO based redox-active species, such as 4-hydroxy-TEMPO.

A mixture of different redox-active species may be used in each electrolyte. Preferably at least one of the redox-active molecules has the exemplary properties described herein.

The electrolyte may further comprise a supporting electrolyte. The supporting electrolyte is typically present at a higher concentration than the redox-active species, such as a 2× higher concentration, a 5× higher concentration or a 10× higher concentration. Alternatively, the supporting electrolyte is present at the same or lower concentration than the redox-active species. Typically, the supporting electrolyte is present at a concentration of 100 mM or more, preferably 1 M or more. The supporting electrolyte may be a metal salt, such as NaCl.

The electrolyte may be an organic electrolyte (e.g. wherein the solvent is an organic solvent) or an aqueous electrolyte (e.g. wherein the solvent is water). Preferably, the electrolyte is an aqueous electrolyte.

Preferably, the electrolyte is an aqueous organic electrolyte, wherein the redox-active species is an organic molecule and the solvent is water. In some embodiments the solvent is predominantly water, such as 90 wt. % or more water based on the mass of solvent, preferably 95 wt. % or more water, more preferably 98 wt. % or more water, yet more preferably 99 wt. % or more water. It is thought that complexation, such as π dimerisation, of the redox-active species is enhanced in aqueous solutions, which further enhances the stability of the redox-active species of the present invention to dioxygen.

The RFB comprises an electrolyte reservoir. The reservoir is a means to contain and store the electrolyte.

The electrolyte reservoir may have a headspace above the electrolytes, which is in contact with the electrolyte. This may be termed the electrolyte reservoir headspace. The reservoir headspace typically includes gas. The reservoir headspace is usually needed to allow for expansion and changes in volume of the electrolyte during operation of the RFB.

In embodiments where the RFB comprises a catholyte and an anolyte, the RFB may comprise an anolyte reservoir, a catholyte reservoir, an anolyte flow circuit configured to permit the anolyte to circulate between the electrochemical cell and the anolyte reservoir, and a catholyte flow circuit configured to permit the catholyte to circulate between the electrochemical cell and the catholyte reservoir.

The electrochemical cell typically includes an electrode, an electrolyte and a separator. The cell may be formed of a frame to position the electrodes (e.g. cathode and anode) on either side of the separator to form the electrochemical cell.

Each RFB may include one or more electrochemical cells (e.g. assembled into stacks).

The electrochemical cell may have a headspace above the electrolytes. This may be termed the electrolyte cell headspace. The headspace typically includes gas. The cell headspace is usually needed to allow for expansion and changes in volume of the electrolyte during operation of the RFB.

The anolyte and catholyte typically flow across opposing sides of a membrane or separator in the electrochemical cell. The two sides of the cell may be termed the anolyte-side and catholyte-side of the electrochemical cell, respectively.

The membrane or separator permits the exchange of ions between the anolyte and catholyte side of the electrochemical cell. The membrane or separator may be an ionically conducive polymer. Preferably, the membrane or separator is selective for supporting electrolyte ions over the redox-active molecular ions present in the electrolytes. This reduces cross-over of the redox-active electrolyte species which may reduce capacity of the RFB.

Typical membrane or separator materials include fluorinated or perfluorinated polymers. Separators such as dialysis membranes, microporous hydrocarbon polymers, polymers of intrinsic microporosity (PIMs) and polyaromatic ionomers having pendant ionic functional groups may be used as appropriate, in particular where solvated polymeric species or particles are utilised as the redox-active species. Ceramic membranes, such as those that are conductive to a single ion, may also be used.

Examples of suitable fluorinate or perfluorinated polymers include sulfonated tetrafluoroethylene copolymers such as Nafion (Dupont), for example Nafion 115, 117 and 212. Examples of dialysis membranes include cellulose-based dialysis membranes. Examples of microporous hydrocarbon polymers include microporous polypropylene or polyethylene. Examples of PIMs include PIMs based on Troger's base and PIMs based on dibenzodioxin, such as those comprising amidoxime groups. Examples of anion exchange membrane include a 120 μm thickness <10 Å pore size membrane (Selemion, Japan).

Alternatively, membrane-free flow batteries are known. In a typical membrane-free flow battery, the catholyte and anolyte solutions pass through the electrochemical cell with little to no mixing. This may be achieved, for example, using immiscible electrolyte systems or laminar flow systems.

Typically, an electrode is positioned in each side of the electrochemical cell. The electrode positioned in the catholyte-side of the cell may be termed the positive electrode and the electrode positioned in the anolyte side of the cell may be termed the negative electrode. Redox reactions take place at the interface between the catholyte and the positive electrode, and between the anolyte and the negative electrode. In a RFB, the electrodes do not take part in the redox reactions, but provide an active surface for the redox reactions to take place.

Preferably, the electrodes have high electrical conductivity, high specific surface area and good stability in the operating potential range of the flow battery. Preferably, the electrodes have good resistance to corrosion by the electrolytes.

The electrodes preferably have good affinity for the electrolyte. For an aqueous based electrolyte, the electrode is preferably hydrophilic. For an organic based electrolyte, the electrode is preferably hydrophobic. For the electrolyte (e.g. anolyte) of the present invention, the electrode (e.g. the anode) is preferably hydrophobic.

Preferably the electrode is a carbon-based materials. Carbon-based materials are typically hydrophobic, and so provide good affinity for organic electrolytes. The carbon-based material is preferably not treated, for example not oxygen treated, in order to retain the electrode hydrophobicity. Examples of carbon-based electrodes include carbon-felt, carbon-paper and graphite-felt, preferably carbon-felt or carbon felt.

The positive and negative electrodes materials may be the same or different.

The electrochemical cell may comprise a current collector to collect electrical charge generated in the electrochemical cell. Typically, one current collector is positioned on the catholyte size of the electrochemical cell (the positive current collector) and is electrically connected to the positive electrode, and one current collector (the negative current collector) is positioned on the anolyte side of the electrochemical cell and is electrically connected to the negative electrode. The current collectors is typically electrically connected to an external circuit.

Typical current collector materials include metals such as aluminium, steel, gold and copper. Preferably the current collector material is aluminium, steel or copper.

In an alternative embodiment, the RFB is a hybrid flow battery. A hybrid flow battery is a battery where one of the electrolytes is in a different state, e.g. a solid or gas compared to the liquid electrolyte. The hybrid RFB may be a flow-liquid, a flow-metal, or a flow-gas battery. For example, a redox-active molecule may be deposited as a solid layer on or with one electrode during use. In such cases, a liquid electrolyte flows across the surface of the solid electrode in an electrochemical cell. The liquid electrolyte may be either the catholyte or anolyte, and the solid electrode may be either cathode or anode as appropriate. Preferably, the liquid electrolyte is the anolyte.

Dioxygen as referred to herein refers to molecular oxygen (O₂).

In conventional RFBs, dioxygen is removed from the electrolyte, for example by purging with an inert gas and/or sealing the RFB from air. During operation of conventional RFBs, dioxygen is removed from the electrolyte, electrolyte headspace and/or electrolyte reservoir using a positive pressure of inert gas.

In the present invention, the RFB can be operated in the presence of dioxygen. The electrolyte, electrolyte headspace and/or the electrolyte reservoir include dioxygen during operation of the RFB. Preferably, the anolyte, anolyte headspace and/or the anolyte reservoir includes dioxygen during operation. During operation refers to during cycling (i.e. charging and/or discharging) the RFB.

Operation in this context refers to charging and/or discharging the RFB, typically without significant degradation of the electrolyte due to oxygen mediated processes. In other words, the RFB operates as tough dioxygen is not present, for example with high coulombic efficiency and good capacity retention, despite the fact dioxygen is dissolved in the electrolyte.

Preferably, dioxygen is not removed from the RFB during operation. For example, the RFB is not sealed from the air and/or the RFB is not under a positive pressure of inert gas.

In some embodiments, dioxygen is not removed from the RFB during preparation of the RFB. For example, the electrolyte is not purged of dioxygen during preparation.

Dioxygen may originate ex-situ, for example from the atmosphere and dissolve in the electrolyte via the headspace of the electrolyte. Dioxygen may also originate in-situ, such as from the electrolyte itself. For example, in an aqueous electrolyte cycling at an open cell voltage over about 1.23V, water is typically split to produce dioxygen in the electrolyte.

Although some known RFBs have been described cycling at voltages over about 1.23 V, when organic redox species have been used in the electrolyte this had typically lead to a rapid degradation of the electrolyte. For this reason, known systems use periodic purging and/or a constant positive flow of inert gas through the electrolyte and cell to remove any molecular dioxygen from the electrolyte. The present invention is instead tolerant to the molecular dioxygen in the electrolyte, so does not require this purging or flow of inert gas.

Dioxygen is typically present in the electrolyte (e.g. anolyte) at a partial pressure equivalent to a concentration of 1% by volume or more, preferably at a concentration of 10% by volume or more, more preferably at a concentration of 15% by volume or more, yet more preferably at a concentration of about 20% by volume. Dioxygen is preferably present in the electrolyte (e.g. anolyte) at a partial pressure equivalent to the atmospheric abundance of dioxygen.

In some embodiments, the electrolyte contacts a battery headspace, the battery headspace comprising molecular dioxygen. In some such embodiments, the battery headspace comprises molecular dioxygen at a concentration of 1% by volume or more, preferably 10% by volume or more, more preferably 15% by volume or more, yet more preferably 20% by volume or more.

Dioxygen concentration in the headspace is measured at a pressure of 1-2 bar, preferably 1-1.5 bar, more preferably 1-1.2 bar at a temperature of 20° C. Typically Dioxygen concentration is measured at a pressure of about 1 bar at a temperature of 20° C.

In some embodiments, the molecular dioxygen dissolved in the electrolyte (on a partial pressure equivalent basis) is greater than the concentration by volume of molecular dioxygen in the battery headspace. The higher concentration of dioxygen in the electrolyte than the headspace is indicative of molecular dioxygen being generated in the electrolyte (e.g. due to in-situ electrolysis of water).

### Redox-Active Species

The redox-active species is present in the electrolyte, preferably the anolyte of the RFB.

A redox-active species is a species capable of reduction or oxidation, that is the loss or gain of electrons. The redox-active species is suitable for use in a redox-flow battery, to store and release electrical charge by reduction and oxidation of the redox-active species. Typically the RFB discharges and charges by cycling the redox-active species between an unreduced form, a singly reduced form (+1 electron) and a doubly reduced form (+2 electrons).

The singly reduced form of the redox-active species is the form produced by a single reduction (gain of one electron per molecule) compared to the unreduced species. The doubly reduced form is the form produced by a double reduction (gain of two electrons per molecule) compared to the unreduced species. Typically, the doubly reduced form is prepared by a further single reduction of the singly reduced form.

Discussion of the redox-active species encompasses all forms of the redox-active species (e.g. the unreduced form, singly reduced form, and doubly reduced form). Different forms of the redox-active species are specified where needed.

The redox-active species is an organic redox-active molecule. An organic molecule is typically a molecule comprising carbon-hydrogen and carbon-carbon bonds. An organic molecule may include heteroatoms, such as halo, oxygen, nitrogen, and sulfur, among others.

The organic redox-active molecule comprises a redox-active unit with two or more heteroarylene groups wherein the two or more heteroarylene groups are conjugated within the redox active unit. Conjugation typically refers to π conjugation, where three or more p-orbitals share electrons to form a conjugated π system. The heteroarylene groups may be conjugated directly, in other words a p-orbital on one heteroarylene group shares electrons with an adjacent p-orbital on another heteroarylene group. Alternatively, the heteroarylene groups may be conjugated indirectly, in other words where one heteroarylene group shares electrons with another heteroarylene group via a p-orbital or p-orbitals of an intermediate group.

Each organic redox-active molecule may have one or more redox-active units. The redox-active unit refers to the two or more conjugated heteroarylene groups which are able to be reduced to produce a singly reduced form and a doubly reduced form, as described herein. The redox-active unit is preferably of Formula (I-A).

In some embodiments the two or more heteroarylene groups are symmetrical. The two or more heteroarylene groups may be symmetrical about a plane between the heteroarylene groups. In some embodiments the two or more heteroarylene groups and any intermediate groups are symmetrical. The two or more heteroarylene groups may be symmetrical about a plane which intersects the intermediate group.

In some embodiments the two or more heteroarylene groups are different. In this way, the two or more heteroarylene groups are not symmetrical about a plane between the heteroarylene groups. In some embodiments any intermediate groups (such as -[L]_{c}-) are not symmetrical about a plane between the heteroarylene groups.

The two or more heteroarylene groups may comprise two or more pyridinylene groups.

The two or more heteroarylene groups may be connected by a linker, -[L]_{c}-. Each -L- is independently selected from a bond, C₂₋₆ alkenylene, C₂₋₄ alkynylene and C₅₋₁₄ arylene, wherein the C₂₋₆ alkenylene and C₅₋₁₄ arylene are optionally substituted with one or more groups R^{C}; wherein R^{C} where present, is a hydrophilic group, and c is independently from 1 to 5. Preferences for -[L]_{c}- are as described herein.

Preferably, the two or more heteroarylene groups are connected by a single linker, [L]_{c}.

In some embodiments, two or more pyridinylene groups may be connected by a linker, [L]_{c}. Preferences for [L]_{c} are as described herein. Preferably, the two or more pyridinylene groups are connected by a single linker, [L]_{c}.

The organic redox-active molecule is preferably of formula (I), more preferably of formula (II). Formula (I) and (II) are as described below. Preferably the organic redox-active molecule is a viologen or extended viologen.

The redox-active species forms a complex. The complex is formed by complexation. Complexation typically occurs by non-covalent interactions between separate instances of the two or more conjugated heteroarylene groups. These may be referred to redox-active units.

Typically, the complex is an intermolecular complex of redox-active units, such as a homodimer. The complex may also be an intramolecular complex of redox-active units. The complex may further be a combination of intermolecular and intermolecular complexed redox-active units.

The complex may form between similar redox-active units. In addition, or alternatively, the complex may form between different redox-active units.

A redox-active molecule may comprise one or more redox-active units. The complex may form between similar redox-active molecules. In addition, or alternatively, the complex may form between different redox-active molecules.

The complexation preferably occurs by an electron sharing interaction, preferably an electron sharing non-covalent interaction. The complexation is preferably not predominantly an electrostatic interaction (e.g., resulting from the ionic interaction between an anionic and cationic group).

The complex may refer to an intermolecular complex between two redox-active units or redox-active molecules (i.e., between two separate molecules). In addition, or alternatively, the complex may refer to an intramolecular complex between two redox-active units of the same redox-active molecule (i.e., between parts of the same molecule).

The complex may refer to a heterogeneous complex between two different redox-active molecules or units, or between two different redox-active units of the same redox-active molecule. In addition, or alternatively, the complex may refer to a homogenous complex between two of the same redox-active molecules or units, or between two of the same redox-active units of the same redox active molecule (e.g., two identical redox-active units of a polymeric redox-active molecule).

The complex may form between two or more redox-active units, such as three or more, such as four or more redox-active units. In this way, the complex may be a dimer, trimer, tetramer or oligomer. The complex may form between two, three or four redox active units, such as two or three redox-active units, such as two redox-active units.

The complex may form between two or more redox-active molecules, such as three or more, such as four or more redox active molecules. In this way, the complex may be a dimer, trimer, tetramer or oligomer. The complex may form between two, three or four redox active molecules, such as two or three redox active molecules, such as two redox active molecules.

The complex may be a dimer, such as a homodimer.

The redox-active species may dimerise to form a dimer. In particular, the singly reduced form of the organic redox-active molecule may dimerise to form a dimer.

The redox-active species may dimerise to form a homodimer. In particular, the singly reduced form of the organic redox-active molecule may dimerise to form a homodimer.

Dimerisation may refer to dimerisation between two redox-active species (i.e., between two separate molecules). In addition, or alternatively, dimerisation may refer to intra-molecule dimerisation between two parts of the redox-active species (i.e., between parts of the same molecule).

In particular, homodimerisation may refer to dimerisation between two of the same redox-active species (i.e., between two of the same, but separate molecules). In addition, or alternatively, homodimerisation may refer to intra-molecule homodimerisation between two corresponding parts of the redox-active species (i.e., between corresponding parts of the same molecule, such as two repeating units of a polymer). For example, in a molecule with multiple viologen units, intra-molecule homodimerisation may refer to dimerisation between the viologen units within the molecule.

Typically, the complex is formed reversibly and so the singly reduced species exists in an equilibrium between a non-complexed and a complexed species. This may be quantified in terms of K_{comp}. In this context, K_{comp} is the equilibrium constant for complexation of the singly reduced form of the redox-active species.

K_{comp} may be 0.1 mM⁻¹ or more, preferably 0.2 mM⁻¹ or more, more preferably 0.5 mM⁻¹ or more, yet more preferably 1 mM⁻¹ or more. Preferably, K_{comp} is from 0.2 to 80 mM⁻¹, more preferably from 10 to 80 mM⁻¹.

K_{comp} may be measured at a temperature of 20° C. using the methods described in the examples section.

The complex may be a 6-complex or a π-complex. Preferably the homodimer is a π-complex.

The σ-complex may be formed by the interaction of an orbital on two or more of the redox-active species, such as the p orbital system of the two or more heteroarylene groups.

The π-complex may be formed by the interaction of a conjugated π system on two or more of the redox-active species, such as the conjugated π system of the two or more heteroarylene groups. Preferably, the π-complex is supported by π-π stacking.

The complex may be formed by the interaction of multiple centres of the redox-active species. That is, the electrons involved in the complexation may be shared between multiple atomic centres in the redox-active molecule. The electrons involved in the complexation are preferably delocalised, such as delocalised π electrons. In this way, the complexation is a multi-centred complexation, preferably a multi-centred π-π complexation.

Typically, the singly reduced form exists in an equilibrium between a monomeric and dimeric species. This may be quantified in terms of K_{d}. In this context, K_{d} is the equilibrium constant for dimerisation, such as homodimerisation, of the singly reduced form of the redox-active species.

K_{d} may be 0.1 mM⁻¹ or more, preferably 0.2 mM⁻¹ or more, more preferably 0.5 mM⁻¹ or more, yet more preferably 1 mM⁻¹ or more. Preferably, K_{d} is from 0.2 to 80 mM⁻¹, more preferably from 10 to 80 mM⁻¹.

K_{d} may be measured at a temperature of 20° C. using the methods described in the examples section.

Where the organic redox-active molecule includes multiple redox-active units, the K_{d} may refer to the K_{d} for each redox-active unit.

The dimer, such as the homodimer, may be a σ-dimer or a π-dimer. Preferably the homodimer is a π-dimer.

The σ-dimer may be formed by the interaction of an orbital on two of the redox-active species, such as the p orbital system of the two or more heteroarylene groups.

The π-dimer may be formed by the interaction of a conjugated π system on two of the redox-active species, such as the conjugated π system of the two or more heteroarylene groups. Preferably, the π-dimer is supported by π-π stacking.

The homodimer may be formed by the interaction of multiple centres of the redox-active species. That is, the electrons involved in the dimerisation are shared between multiple atomic centres in the molecule. The electrons involved in the dimerisation are preferably delocalised, such as delocalised π electrons. In this way, the homodimerisation is a multi-centred homodimerisation, preferably a multi-centred π-π homodimerisation.

Dimerisation typically occurs by non-covalent interactions between the two or more conjugated heteroarylene groups. The dimerisation preferably occurs by electron sharing interaction, preferably an electron sharing non-covalent interaction. The dimerisation is preferably not predominantly an electrostatic interaction (e.g., resulting from the ionic interaction between an anionic and cationic group).

Preferably, in the compounds of formula (I), the non-covalent interactions are between the groups -A-, -B- and -[L]_{c}- of the respective molecules, more preferably between the groups -[L]_{c}-.

Complexation (such as dimerisation) of mono-reduced species can influence solubility of the reduced electrolyte and kinetics of electron transfer, both intermolecular and interfacial (electrode-electrolyte). The particular organic redox-active molecules are also resistant to precipitation during dimerisation, and thus the dimerisation provides a viable mechanism for dioxygen tolerance.

The doubly reduced form of the organic redox-active molecule may exist in a singlet or triplet form. This relates to the spin relationship of the electrons in the doubly reduced species. A singlet form refers to a molecule where each electron has another electron having an opposite (anti-correlated) spin. A triplet form refers to a molecule having two unpaired electrons wherein the electrons have the same (correlated) spin.

Preferably the doubly reduced form of the redox-active species thermodynamically favours a singlet structure.

The energetic difference between the singlet and triplet states of the doubly reduced form of the redox-active species can be quantified using E_{ST}. A negative E_{ST} indicates that the singlet state is energetically favoured, while a positive E_{ST} indicates that the triplet state is energetically favoured. Preferably the E_{ST} of the doubly reduced species is negative.

In some embodiments, the doubly reduced form of the organic redox-active molecule has a singlet-triplet energy gap (E_{ST}) of less than 0 kcal mol⁻¹ (0 kJ mol⁻¹), preferably −6.0 kcal mol⁻¹ (−25.1 kJ mol⁻¹) or less.

In some embodiments, the doubly reduced form of the organic redox-active molecule has an E_{ST} of from −30.0 kcal mol⁻¹ (−125.5 kJ mol⁻¹) to 0 kcal mol⁻¹ (0 kJ mol⁻¹), preferably from −30.0 kcal mol⁻¹ (−125.5 kJ mol⁻¹) to −6.0 kcal mol⁻¹ (−25.1 kJ mol⁻¹).

Where the organic redox-active molecule includes multiple redox-active units, the E_{ST} refers to each redox-active unit.

The doubly reduced form of the organic redox-active molecule may exist in an open-shell or a closed-shell structure. This relates to the number of unpaired electrons in the molecular orbitals. An open shell form refers to a species having one or more unpaired electrons, such as π electrons. A closed shell form refers to a structure having no unpaired electrons, such as π electrons.

Preferably, the doubly reduced redox-active species thermodynamically favours a closed shell structure. The singlet form is typically a closed shell structure.

The closed shell structure may be a Kekule structure. A Kekule structure has a closed shell structure with no unpaired π electrons. Preferably the doubly reduced redox-active species thermodynamically favours a Kekule structure.

A singlet and/or closed shell structure for the doubly reduced form facilitates improved electrochemical reversibility of the redox-active species. In particular, at an E_{ST} of 0 kcal mol⁻¹ (0 kJ mol⁻¹) or less, preferably −6.0 kcal mol⁻¹ (−25.1 kJ mol⁻¹) or less, the doubly reduced form favours the singlet state, and thus tends to display electrochemical redox reversibility. The more negative the E_{ST} is more likely the species will display electrochemical redox reversibility. This is advantageous for RFB cell cycling.

The particular K_{d} and E_{ST} values which favour dimerisation and redox reversibility can be quantified by equation (1), wherein Y is from 15 to 30.

$$Y \leq 3.64 * ln ( {K}_{d} ) - {E}_{S T} \qquad ( 1 )$$

The K_{d} and E_{ST} are defined as above. The range of K_{d} and E_{ST} values which satisfy the equation represent redox-active molecules with an excellent degree of dioxygen tolerance (by virtue of the dimerisation) as well as electrochemical redox reversibility (by favouring singlet closed-shell structures).

For equation (1), the (K_{d}) (mM⁻¹) is the equilibrium constant for formation of the singly reduced form of the organic redox-active molecules at a temperature of 20° C., and the E_{ST}(kcal mol⁻¹) is the doubly reduced form of the organic redox-active molecule.

Y may be from 15 to 30. Preferably Y is from 20 to 25, more preferably from 21 to 24.

For example, for a redox-active species having a K_{d} of 0.28 mM⁻¹ and an E_{ST} of −27.9 kcal mol⁻¹ (−116.7 kJ mol⁻¹) then Y is 23.28. Alternatively, for a redox-active species having a K_{d} of 11 mM⁻¹ and an E_{ST} of −12.3 kcal mol⁻¹ (−51.5 kJ mol⁻¹) then Y is 21.03. Furthermore, for a redox-active species having a K_{d} of 76 mM⁻¹ and an E_{ST} of −8.0 kcal mol⁻¹ (−33.5 kJ mol⁻¹) then Y is 23.76.

The organic redox-active molecule comprises two or more heteroarylene groups wherein the two or more heteroarylene groups are conjugated. The description of the organic redox-active molecules herein refers to the unreduced form of the organic redox-active molecule.

In some embodiments, the organic redox-active molecule is a viologen (4,4′-bispyridinium compound) or extended viologen (4,4′-bispyridinium with a linker between the pyridinium groups).

In some embodiments, the organic redox-active molecule comprises a redox-active unit of formula (I-A):

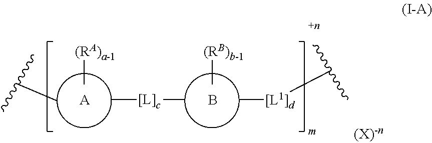

wherein:
-A- and -B- are each independently C₅₁₀ arylene;
each -L- is independently selected from C₅₋₁₄ arylene, a bond, C₂₋₆ alkenylene, C₂₋₄ alkynylene, wherein the C₅₋₁₄ arylene and C₂₋₄ alkenylene are optionally substituted with one or more —R^{C} groups;
-L¹- is independently selected from a bond, C₁₋₆ alkylene, C₅₋₁₄ arylene, —N(H)—, and —(CH₂O)ₐ₁—(C₂H₄O)ₐ₂—(C₃H₆O)ₐ₃—(CH₂C(O))ₐ₄—, wherein the C₁₋₆ alkylene and C₅₋₁₄ arylene are optionally substituted with one or more —R^{D} groups; and
   wherein a1, a2, a3 and a4 are each independently selected from 0 to 12 and the sum of a1, a2, a3 and a4 is from 1 to 12,
each of —R^{A}, —R^{B}, —R^{C} and —R^{D} where present, is a hydrophilic group;
X is one or more counter anions;
n is from 2 to 4;
c and d are independently from 1 to 5;
a and b are independently from 1 to 5;
two or more of -A-, -B- and -L- are C₅₋₁₀ heteroarylene; and
m is 1 or more.

In some embodiments the redox-active species is polymeric and includes multiple units of Formula (I-A). In such embodiments, m is 2 or more, such as 10 or more, 50 or more, or 100 or more. In some embodiments, m is 2 to 200, such as 10 to 100.

The multiple units of Formula (I-A) may be arranged as a linear, branched, dendritic or cyclic polymer. Preferably, the multiple units of Formula (I-A) are arranged as a linear or branched polymer, such as a linear polymer.

In some embodiments -L¹- is a bond and d is 1. In such embodiments the units of -A-[L]_{c}-B- are directly connected.

In some embodiments, -L¹- is independently selected from C₁₋₆ alkylene, —N—, —(CH₂O)ₐ₁—(C₂H₄O)ₐ₂—(C₃H₆O)ₐ₃—(CH₂C(O))ₐ₄— and C₅₋₁₄ arylene. In such embodiments, the units of -A-[L]_{c}-B- are not directly connected.

The linker -[L¹]_{d}- comprises d groups -L¹-, wherein d is from 1 to 5. Preferably d is from 1 to 4, more preferably 1 to 3, yet more preferably 1 or 2. In some embodiments, d is 1.

In some embodiments, -L¹- is independently selected from C₁₋₆ alkylene and —(CH₂O)ₐ₁—(C₂H₄O)ₐ₂—(C₃H₆O)ₐ₃—(CH₂C(O))ₐ₄. In this way, the units of -A-[L]c-B- are not π-conjugated.

-L¹- may be C₁₋₆ alkylene. C₁₋₆ alkylene is a divalent alkyl group having from 1 to 6 carbon atoms forming the alkylene chain. The alkylene chain may be linear or branched. For example, the alkylene group may be selected from methylene, ethylene, and propylene, including n-propylene and i-propylene, butylene, pentylene or hexylene. Preferably the C₁₋₆ alkylene is C₁₋₄ alkylene, such as C₁₋₃ alkylene, such as C₃ alkylene.

-L¹- may be —(CH₂O)ₐ₁—(C₂H₄O)ₐ₂—(C₃H₆O)ₐ₃—(CH₂C(O))ₐ₄. The group —(CH₂O)ₐ₁—(C₂H₄O)ₐ₂—(C₃H₆O)ₐ₃—(CH₂C(O))ₐ₄—R^{N} is a polyglycol chain.

The repeating unit —(CH₂O)ₐ₁— is a methylene glycol repeating unit. The number of repeating units a1 is typically 0-12. In some embodiments, a1 is 0. In other embodiments, a1 is from 1 to 12, preferably from 2 to 6.

The repeating unit —(C₂H₄O)ₐ₂— is an ethylene glycol repeating unit. The number of repeating units a2 is typically 0-12. In some embodiments, a2 is 0. In other embodiments, a2 is from 1 to 12, preferably from 2 to 6.

The repeating unit —(C₃H₆O)ₐ₃— is a propylene glycol repeating unit. The number of repeating units a3 is typically 0-12. In some embodiments, a3 is 0. In other embodiments, a3 is from 1 to 12, preferably from 2 to 6.

The —(CH₂C(O))ₐ₄— is an acetyl repeating unit. —R^{N} is a terminal C₁₋₆ alkyl. The number of repeating units a4 is typically 0-12. In some embodiments, a4 is 0. In other embodiments, a4 is from 1 to 12, preferably from 2 to 6.

Typically, a1, a2, a3 and a4 are each independently selected from 0 to 12, and the sum of a1, a2, a3 and a4 is 1 to 12. Preferably, a1, a2, a3 and a4 are each independently selected from 0 to 6, and the sum of a1, a2, a3 and a4 is 2 to 6.

-L¹- may be C₅₋₁₄ arylene. C₅₋₁₄ arylene is a divalent aromatic group having from 5 to 14 atoms forming the aryl ring or fused aryl rings. For example, the arylene group may be a 5 membered arylene group, such as thiophene, or a 6 membered arylene group, such as phenylene or pyridine, or a 10 membered arylene group, such as naphthylene, or a 14 membered arylene group, such as anthracenylene. An arylene may be carboarylene or heteroarylene.

-L¹- may be C₅₋₁₄ arylene, preferably as C₅₋₁₀ arylene, more preferably C₅₋₆ arylene. -L¹- may be C₅₋₁₀ heteroaryl or C₆₋₁₀ carboaryl. Preferably -L¹- is phenylene.

Where -L¹- is an alkylene or arylene, the alkylene or arylene groups are optionally substituted with one or more —R^{D} groups. —R^{D} is an optional substituent. Where multiple —R^{D} are present they may be the same or different. In addition, where two or more of —R^{c} and —R^{D} are present, the —R^{C} and —R^{D} may be the same or different.

Typically, adjacent units of Formula (I-A) are not conjugated. For example, -L¹- may include a saturated group which prevents conjugation between adjacent units of Formula (I-A).

Dimerisation may occur by non-covalent interactions between the two or more units of Formula (I-A) in the same molecule. Preferably, the non-covalent interactions are between the one or more of the groups -A-, -B- and -[L]_{c}- in Formula (I-A), more preferably between the group -[L]_{c}-.

The length of the group -[L¹]_{d}- may be such that units of Formula (I-A) in the same molecule are able to dimerise. The length of the group -[L¹]_{d}- may give sufficient steric freedom such that adjacent units of Formula (I-A) can π-dimerise.

In some embodiments, the length of the group -[L¹]_{d}- is 0.5 nm or more, preferably 0.8 nm or more, more preferably 1.0 nm or more. The length of the group -[L¹]_{d}- can be calculated using average bond lengths. For example, the length of the group -[L¹]_{d}- be equivalent to 2 or more —(CH₂)— units, preferably 4 or more —(CH₂)— units, more preferably 6 or more —(CH₂)— units.

Preferably, the redox-active species includes one unit of Formula (I-A). In such embodiments m is 1. Yet more preferably, m is 1, -L¹- is a bond and d is 1.

In some embodiments of the redox-active unit of Formula (I-A), the linker -[L]_{c}- may be attached to multiple -B-. For example, the linker -[L]_{c} may be attached to one -A- and one or more -B- groups, such as one -A- and from two to five -B- groups, such as one -A- and two or three -B- groups. In this way, the linker -[L]_{c} may be attached to a total of two to six -A- and -B- groups, such as a total of two to four -A- and -B- groups, such as three or four -A- and -B- groups.

In some embodiments, the organic redox-active molecule is of formula (I-B):

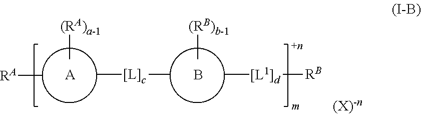

wherein:
-A-, -B-, -L-, -L¹-, —R^{A}, —R^{B}, —R^{C}, —R^{D}, X, a, b, n and m are as defined for Formula (I-A); and
two or more of -A-, -B- and -L- are C₅₋₁₀ heteroarylene.

The preferences for -A-, -B-, -L-, -L¹-, —R^{A}, —R^{B}, —R^{C}, —R^{D}, X, a, b, c, d, n and m are as described herein.

In some embodiments the redox-active species is polymeric and includes multiple units of Formula (I-B). In such embodiments, m is 2 or more, such as 10 or more, 50 or more, or 100 or more. In some embodiments, m is 2 to 200, such as 10 to 100.

The multiple units of Formula (I-B) may be arranged as a linear, branched, dendritic polymer. Preferably, the multiple units of Formula (I-B) are arranged as a linear or branched polymer, such as a linear polymer.

The multiple units of Formula (I-B), where present, are terminated with a group —R^{A} and —R^{B}. —R^{A} and —R^{B} are preferably both hydrophilic groups. The definition of —R^{A} and —R^{B}, as well as a and b, are described in more detail below.

In some embodiments L¹ is a bond and d is 1. In such embodiments the units of -A-[L]_{c}-B- are directly connected.

In some embodiments, the redox-active species includes one or two units of Formula (I-B). In such embodiments m is 1 or 2.

Preferably, m is 1. Particularly preferably, m is 1, -L¹- is a bond and d is 1.

In some embodiments, the organic redox-active molecule is of Formula (I-C):

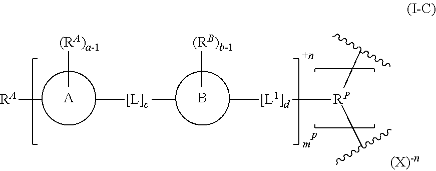

wherein:
-A-, -B-, -L-, -L¹-, —R^{A}, —R^{B}, —R^{C}, —R^{D}, X, a, b, n and m are as defined for Formula (I-A) and Formula (I-B);
R^{P} is a polymer repeat unit;
p is 2 or more; and
two or more of -A-, -B- and -L- are C₅₋₁₀ heteroarylene.

The preferences for -A-, -B-, -L-, -L¹-, —R^{A}, —R^{B}, —R^{C}, —R^{D}, X, a, b, n and m are as described herein.

Formula (I-C) describes a redox-active molecule of the invention as a pedant polymer. The polymer backbone (represented by [R^{P}]ₚ) has pendant groups attached. The pendant groups include one or more of the A-[L]_{c}-B moieties.

In the context of Formula (I-C), m represents the number of repeat units in the pendant group. Typically, m is 1 or more, such as 2 or more, or 10 or more. In some embodiments, m is 1 to 20, such as 2 to 10. Preferably, m is 1 or 2.

The value of p represents the number of repeat units in the polymer backbone. Typically, p is 2 or more, preferably or 10 or more, more preferably 20 or more, yet more preferably 50 or more. In some embodiments, p is 2 to 200, such as 10 to 100.

R^{P} may be any suitable polymer repeat unit. R^{P} is a repeat unit of a polymer and may be selected from the group consisting of polyethylene, polypropylene, polystyrene, polyacrylate, polymethacrylate, polyester, polyamide, polyethyleneterephthalate, and polysiloxane repeating unit. Preferably R^{P} is a polyethylene or polypropylene repeating unit, such as a polyethylene repeating unit.

In some embodiments, the organic redox-active molecule is of Formula (I-D):

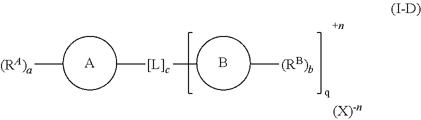

wherein:
-A-, -B-, -L-, —R^{A}, —R^{B}, —R^{C}, X, a, b, n are as defined for Formula (I-A) and (I-B); q is from 1 to 5; and
two or more of -A-, -B- and -L- are C₅₋₁₀ heteroarylene.

The preferences for -A-, -B-, -L-, —R^{A}, —R^{B}, —R^{C}, —R^{D}, X, a, b, n and q are as described herein.

The value of q dictates the number of groups -B- attached to -[L]_{c}-. Typically q is 1 to 5. In some embodiments q is 1 to 4, such as 1 to 3. Preferably q is 1 or 2, such as 1.

The linker [L]_{c} connects the groups -A- and the q groups of -B- in formula (I-D). The linker [L]_{c} comprises c groups L, wherein c is from 1 to 5. Preferably c is from 1 to 4, more preferably 1 to 3, yet more preferably 1 or 2. In some embodiments, c is 1.

Each -L- is independently selected from C₅₋₁₄ arylene, a bond, C₂₋₆ alkenylene and C₂₋₄ alkynylene, wherein the alkenylene and arylene are optionally substituted with one or more R^{C} groups.

Where q is 2 or more, -L- is typically C₅₋₁₄ arylene. Accordingly, -L- may C₆₁₄ carboarylene or C₅₋₁₀ heteroarylene.

Preferably, each -L- is independently selected from C₆₁₄ carboarylene, C₅₋₁₀ heteroarylene, a bond, C₂ alkenylene, and C₂ alkynylene, more preferably C₆₋₁₀ carboarylene, C₅₋₆ heteroarylene and a bond.

Where -L- is a carboarylene, the carboarylene may be independently selected from anthracenylene, naphthylene and phenylene. Preferably, the carboarylene is selected from naphthylene and phenylene.

In some embodiments, -[L]_{c}- is phenylene and q is 2. The -A- and two-B- groups may be attached to the phenylene at the 1, 3 and 5 positions.

Where -L- is a heteroarylene the heteroarylene may comprise a sulfur or oxygen heteroatom, preferably a sulfur heteroatom. Preferably, where -L- is a heteroarylene, the heteroarylene is thiophenylene or furanylene. Preferably, where -L- is a heteroarylene, the heteroarylene is thiophenylene.

Alternatively, in some embodiments, q is 2 or more, such as 3, and c is 3 or more, such as 3 or 4, and the -L- groups may be arranged in a cyclic configuration. In some such embodiments, q is 2 to 4, such as 3, and the group [L]_{c} may be a porphyrin group, such as porphyrin, porphycene, corrphycene, hemiporphycene, or isoporphycene.

Preferably, each of -A- and -B- in Formula (I-D) are independently a C₅₋₁₀ heteroarylene. The C₅₋₁₀ heteroarylene may be C₅₋₆ heteroarylene, preferably C₆ heteroarylene. Preferably the C₅₋₆ heteroarylene comprises one or more nitrogen as the heteroatom. More preferably the C₆ heteroarylene comprises one or more nitrogen as the heteroatom, such as one nitrogen as the heteroatom.

The nitrogen containing C₆ heteroarylene may be connected to adjacent groups (e.g. -L- and R^{A}/R^{B}) at the 1,2 position, 1,3 position, or 1,4 position. Preferably, the nitrogen containing C₆ heteroarylene is connected to adjacent groups (e.g. L and R^{A}/R^{B}) at the 1,4 position.

In some embodiments, the organic redox-active molecule is of formula (I):

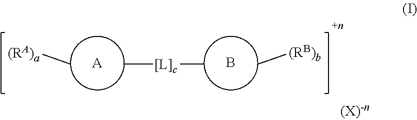

wherein:
-A- and -B- are each independently selected from C₅₋₁₀ arylene;
each -L- is independently selected from C₅₋₁₄ arylene, a bond, C₂₋₆ alkenylene, C₂₋₄ alkynylene, wherein the C₅₋₁₄ arylene and C₂₋₆ alkenylene are optionally substituted with one or more R^{C} groups;
at least one of —R^{A} and —R^{B}, and —R^{C} where present, is independently a hydrophilic group;
X is one or more counter anions;
n is from 2 to 4;
a, b and c are independently from 1 to 5; and
two or more of -A-, -B- and -L- are C₅₋₁₀ heteroarylene.

In some embodiments -A- and -B- are the same. In this way, the two or more heteroarylene groups are symmetrical.

In some embodiments (R^{A})ₐ and (R^{B})_{b} are the same. In this way, the groups (R^{A})ₐ and (R^{B})_{b} are symmetrical.

The groups -A- and -B- may be the same and the groups (R^{A})ₐ and (R^{B})_{b} may be the same. In this way, the redox-active molecule may be symmetrical about a plane between the heteroarylene groups -A- and -B-.

In some embodiments the two or more heteroarylene groups (-A- and -B-), the groups (R^{A})ₐ and (R^{B})_{b} and any intermediate groups -[L]_{c}- are symmetrical about a plane between the heteroarylene groups -A- and -B-, preferably a plane which intersects the intermediate group -[L]_{c}-, more preferably a plane which only intersects the intermediate group -[L]_{c}-.

In some embodiments -A- and -B- are different. In this way, the two or more heteroarylene groups are not symmetrical about a plane between the heteroarylene groups -A- and -B-.

In some embodiments (R^{A})ₐ and (R^{B})_{b} are different. In this way, the groups (R^{A})ₐ and (R^{B})_{b} are not symmetrical about a plane between the heteroarylene groups -A- and -B-.

The arylene is a divalent aryl group, such as a divalent carboaryl or divalent heteroaryl group. The arylene is optionally substituted, such as substituted. In one embodiment, the arylene is unsubstituted.

The C₅₋₁₄ arylene is a divalent aromatic group having from 5 to 14 atoms forming the arylene ring or fused arylene rings. For example, the arylene group may be a 5 membered arylene group, such as thiophene, or a 6 membered arylene group, such as phenylene or pyridine, or a 10 membered arylene group, such as naphthalene, or a 14 membered arylene group, such as anthracene. An arylene may be carboarylene or heteroarylene.

The heteroarylene is a divalent heteroaromatic group, that includes at least one ring heteroatom. Where fused rings are present, one or more of those rings may contain a ring heteroatom.

The heteroarylene is optionally substituted, such as substituted. In one embodiment, the heteroarylene is unsubstituted. Preferably, when -A- and -B- are heteroarylene it is mono-substituted and when -L- is heteroarylene it is unsubstituted.

The C₅₋₁₀ heteroarylene group is a divalent aryl group having from 5 to 10 atoms forming the heteroaryl ring(s). For example, the heteroarylene group may be a 6 membered heteroarylene group, such as pyridinylene, or a 5 membered heteroarylene group, such as thiophenylene or furanylene, or a 9 membered heteroarylene group, such as divalent benzimidazole.

The carboarylene is a divalent carboaromatic group, that is including only carbon in the aryl ring. The carboarylene is optionally substituted, such as substituted. In one preferred embodiment, the carboarylene is unsubstituted.

The C₆₋₁₄ carboarylene group is a divalent aryl group having from 6 to 14 atoms forming the aryl ring(s). For example, the carboarylene group may be a 6 membered carboarylene group, such as phenylene, or a 9 membered carboarylene group, such as naphthalene, or a 14 membered carboarylene group, such as anthracene.

The alkenylene is a divalent alkene group. The alkenylene is optionally substituted, such as substituted. Preferably, the alkenylene is unsubstituted.

The C₂₋₆ alkenylene is a divalent alkene group having from 2 to 6 carbon atoms forming the alkene chain. The alkene may be linear or branched. For example, the alkenylene may be a 2 membered alkenylene group, such as ethylene, or a 3 membered alkenylene group, such as propylene or allylene, or a 4 membered alkenylene group, such as buta-1,3-diene, or a 6 membered alkenylene group such as hexa-1,3,5 triene or 2-ethylbuta-1,3-diene.

The alkynylene is a divalent alkyne group. The C₂₋₄ alkynylene is a divalent alkyne group having from 2 to 4 carbon atoms forming the alkyne chain. For example, the alkynylene may be a 2 membered alkynylene group, such as ethynene, or a 4 membered alkylnylene group, such as buta-1,3-diynene.

Typically, all atoms (e.g. carbon atoms) in the groups -[L]_{c}- forming the link between -A- and -B- are sp or sp2 hybridised, in order to provide conjugation between the groups -A- and -B-. Branches not directly linking the groups -[L]_{c}- may have alternative hybridisation.

The hydrophilic group is a group having a good affinity for water. The hydrophilic group typically includes polar groups, such as groups capable of hydrogen bonding. The hydrophilic group typically includes one or more heteroatoms, such as halo, oxygen, sulfur, nitrogen, phosphorous. The hydrophilic group may be charged. The hydrophilic group may be appended to an alkylene or arylene group, preferably an alkylene group.

Preferably the hydrophilic group is uncharged or has the same charge polarisation (i.e., anionic or cationic) as the arylene core (-A-[L]_{c}-B-). For example, where the arylene core is a cationic, such as a viologen or extended viologen, the hydrophilic group is preferably uncharged or cationic. In this way, the redox-active species is not zwitterionic, which may lead to aggregation and poor solubility.

The hydrophilic groups are preferably one or more of the groups —R^{A} and —R^{B}, and where present —R^{C}. Preferably, the hydrophilic groups are the groups —R^{A} and —R^{B}. The description of these groups herein apply to the hydrophilic groups. The groups —R^{A} and —R^{B}, and where present —R^{C} and —R^{D} may attach to any point on the -A-, -B-, -L- and -L¹-, such as a carbon or nitrogen atoms.

The hydrophilic groups are thought to improve the water solubility of the redox-active species. The hydrophilic groups are placed on the periphery of the redox-active species, to enhance water solubility, while the conjugated arylene group, which typically have poor water solubility, are present at the core of the redox-active species. The poorly water soluble conjugated arylene has an increased tendency to dimerise when in an aqueous solution, while the hydrophilic groups keep the redox-active species in solution, preventing precipitation.

Where multiple —R^{A}, —R^{B}, and where present —R^{C}, groups are present each group may be the same or different. For example, where two or more of —R^{A} or —R^{B} are present, each —R^{A} or —R^{B} appended to a heteroatom of -A- or -B- (e.g. the pyridinylene nitrogen) may be different to the —R^{A} or —R^{B} appended to a carbon of -A- or -B-.

The counter anions are any suitable anion required for charge neutrality of the organic redox-active molecule.

In Formula (I), two or more of -A-, -B- and -L- are independently a C₅₋₁₀ heteroarylene. Preferably, each of -A- and -B- are independently a C₅₋₁₀ heteroarylene.

In some embodiments, C₅₋₁₀ heteroarylene comprises one or more heteroatoms each independently selected from oxygen, nitrogen and sulfur, preferably one heteroatom selected from oxygen, nitrogen and sulfur. Preferably the C₅₋₁₀ heteroarylene comprises nitrogen as the heteroatom.

The C₅₋₁₀ heteroarylene may be C₅₋₆ heteroarylene, preferably C₆ heteroarylene. Preferably the C₅₋₆ heteroarylene comprises one or more nitrogen as the heteroatom. More preferably the C₆ heteroarylene comprises one or more nitrogen as the heteroatom, such as one nitrogen as the heteroatom.

The nitrogen containing C₆ heteroarylene may be connected to adjacent groups (e.g. -L- and R^{A}/R^{B}) at the 1,2 position, 1,3 position, or 1,4 position. Preferably, the nitrogen containing C₆ heteroarylene is connected to adjacent groups (e.g. L and R^{A}/R^{B}) at the 1,4 position.

Preferably, the C₅₋₁₀ heteroarylene is pyridiylene. Preferably -A- and -B- are both pyridiylene.

The pyridiylene may be pyridiyl-1,2-ene, pyridiyl-1,3-ene or pyridiyl-1,4-ene. Preferably, the pyridiylene is connected to the adjacent groups (e.g. L and R^{A}/R^{B}) at the 1,4 position. More preferably, where -A- and -B- are pyridiylene, the pyridiylene is connected to L at the 4 position and R^{A}/R^{B} at the 1 position (i.e. via the nitrogen).

Typically, two or more of -A-, -B- and -L- are conjugated, such that -A- and -L-, or -B- and -L-, or -A-, -B- and -L- are conjugated. Preferably, -A- and -B- are conjugated. For example, where -L- is a bond -A- and -B- may be conjugated directly, or when -L- is not a bond -A-, -B- and -L- are conjugated.

Dimerisation typically occurs by non-covalent interactions between the two or more conjugated heteroarylene groups. Preferably, the non-covalent interactions are between the groups -A-, -B- and -[L]_{c}-, more preferably between the group -[L]_{c}-.

In some embodiments, the length of the group [L]_{c} is 0.5 nm or less, such as 0.4 nm or less. In some embodiments, the length of the group [L]_{c} is 0.1 nm or more, such as 0.2 nm or more. When the length of the group [L]_{c} is about 0.1 to 0.5 nm, such as 0.2 to 0.4 nm, it is thought that the group [L]_{c} can provide non-covalent interactions between the redox-active molecules leading to dimerisation. The length of the group [L]_{c} can be calculated using average bond lengths.

In some embodiments, the length of the group [L]_{c} is 3 to 8 atoms directly linking the groups -A- and -B-. Preferably, the length of the group [L]_{c} is 3 to 8 sp₂ carbons and/or heteroatoms directly linking the groups -A- and -B-, such as 3 to 6 sp₂ carbons and/or heteroatoms directly linking the groups -A- and -B-.

In some embodiments, the organic redox-active molecule is a viologen or extended viologen molecule. In some embodiments:
-A- is

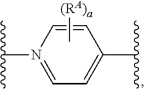

and
-B- is

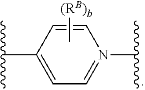

In some additional embodiments, the organic redox-active molecule comprises a unit of formula (II-A):

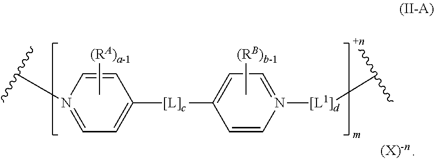

wherein -L-, -L¹-, —R^{A}, —R^{B}, —R^{c}, —R^{D}, X, n, m a, b, c and d are as defined above for formula (I), (I-A) and (I-B).

The preferences for -L-, -L1-, —RA, —RB, —Rc, —RD, X, n, m a, b, c and d and as described herein.

In some additional embodiments, the organic redox-active molecule comprises a unit of formula (II-B):

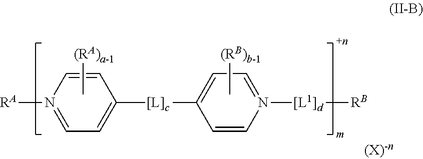

wherein -L-, -L¹-, —R^{A}, —R^{B}, —R^{c}, —R^{D}, X, n, m a, b, c and d are as defined above for formula (I), (I-A) and (I-B).

The preferences for -L-, -L¹-, —R^{A}, —R^{B}, —R^{c}, —R^{D}, X, n, m a, b, c and d and as described herein.

In some embodiments, the organic redox-active molecule is of formula (II):

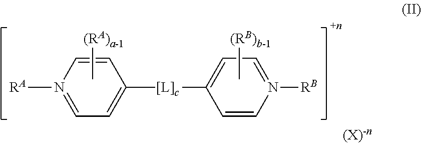

wherein L, R^{A}, R^{B}, X, n, a, b and c are as defined for formula (I).

The linker [L]_{c} connects the groups -A- and -B- in formula (I). The linker [L]_{c} links the pyridinylene groups in formula (II).

The linker [L]_{c} comprises c groups L, wherein c is from 1 to 5. Preferably c is from 1 to 4, more preferably 1 to 3, yet more preferably 1 or 2. In some embodiments, c is 1.

Each -L- is independently selected from C₅₋₁₄ arylene, a bond, C₂₋₆ alkenylene and C₂₋₄ alkynylene, wherein the alkenylene and arylene are optionally substituted with one or more R^{C} groups.

Where -L- is a bond, the pyridinylene groups are directly connected (bi-pyridinylene). A bond refers to a covalent bond.

Each -L- may be independently selected from C₆₋₁₄ carboarylene or C₅₋₁₀ heteroarylene, a bond, C₂₋₆ alkenylene and C₂₋₄ alkynylene. Where c is more than 1, then preferably each -L- is not C₂₋₆ alkenylene or each -L- is not C₂₋₄ alkynylene.

Preferably, each -L- is independently selected from C₆₋₁₄ carboarylene, C₅₋₁₀ heteroarylene, a bond, C₂ alkenylene, and C₂ alkynylene, more preferably C₆₋₁₀ carboarylene, C₅₋₆ heteroarylene and a bond.

In some embodiments each -L- is independently selected from C₆₋₁₀ carboarylene or C₅₋₁₀ heteroarylene. Preferably, each -L- is independently selected from naphthylene, anthracenylene and C₅₋₁₀ heteroarylene.

Where -L- is a C₂₋₆ alkenylene, the C₂₋₆ alkenylene may be independently selected from:

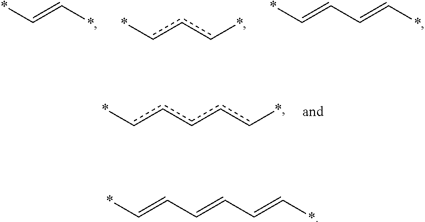

Where -L- is a C₂₋₄ alkynylene, the C₂₋₄ alkynylene may be independently selected from:

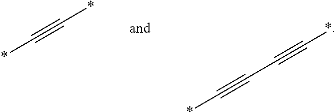

Each -L- may be C₅₋₁₄ arylene, such as C₅₋₁₄ carboarylene or C₅₋₁₄ heteroarylene

Where -L- is a heteroarylene, the heteroarylene comprises one or more ring heteroatoms, such as one, two or three ring heteroatoms, each independently selected from oxygen, nitrogen and sulfur (O, N(H) and S). The heteroarylene may have only one ring heteroatom selected from oxygen, nitrogen and sulfur. The heteroarylene may comprises two or more heteroatoms selected from oxygen, nitrogen and sulfur, such as two heteroatoms selected from oxygen, nitrogen and sulfur. The heteroarylene may be a thiazolene, such as a 1,2-thiazolene, a 1,3-thiazolene or a 1,4,2-dithiazolene.

Where -L- is a heteroarylene the heteroarylene may comprise a sulfur or oxygen heteroatom, preferably a sulfur heteroatom. Preferably, where -L- is a heteroarylene, the heteroarylene is thiophenylene or furanylene. Preferably, where -L- is a heteroarylene, the heteroarylene is thiophenylene.

Typically, the -L- groups in [L]_{c} are arranged in a linear configuration.

Alternatively, in some embodiments, where c is 3 or more, such as 3 or 4, the -L-groups may be arranged in a cyclic configuration. In some such embodiments the group [L]c may be a porphyrin group, such as porphyrin, porphycene, corrphycene, hemiporphycene, or isoporphycene.

Where -L- is a carboarylene, the carboarylene may be independently selected from anthracenylene, naphthylene and phenylene. Preferably, the carboarylene is selected from naphthylene and phenylene.

In some embodiments, -L- is independently selected from a bond, and a group selected from anthracenylene, naphthylene, phenylene and thiophenylene. Preferably, -L- is independently selected from a bond, and a group selected from anthracenyl-1,4-ene, anthracenyl-1,6-ene naphthyl-1,8-ene, phenyl-1,4-ene and thiophenyl-2,5-ene.

In some embodiments, -L- is independently selected from a bond, and a group selected from

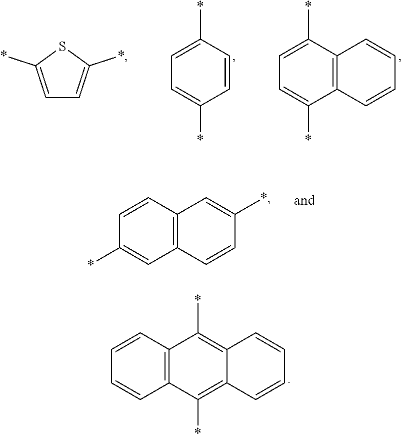

In some such embodiments, c is 1 or 2.

In some embodiments, each -L- is independently selected from a bond, and a group selected from

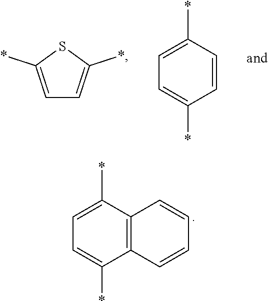

In some such embodiments, c is 1 or 2.

Preferably, where -L- is

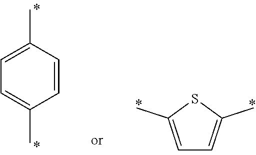

or then c is 1 or 2, and where -L- is a bond,

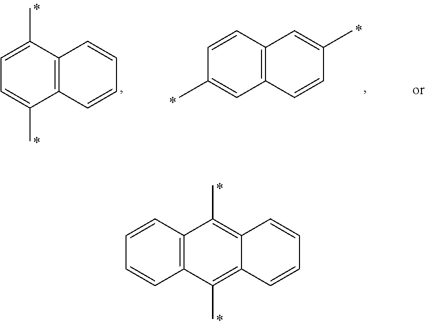

then c is 1.

In one embodiment, -L- is not thiazolo[5,4-d]thiazole.

The groups —R^{A}, —R^{B}, —R^{C} and —R^{D} are substituents of -A-, -B-, -L- and -L¹-respectively. The number of groups —R^{A} and —R^{B} is defined by a and b respectively. —R^{C} and —R^{d} are optional substituents. Where multiple —R^{A}, —R^{B}, —R^{C} and —R^{D} are present, they may be the same or different.

The groups —R^{A}, —R^{B} and —R^{C} are substituents of -A-, -B- and -L- respectively. The number of groups —R^{A} and —R^{B} is defined by a and b respectively. —R^{C} is an optional substituent. Where multiple —R^{A}, R^{B} and —R^{C} are present they may be the same or different.

For example, where two or more of —R^{A} or —R^{B} are present, the —R^{A} or —R^{B} appended to a heteroatom of -A- or -B- (e.g. the pyridinylene nitrogen) may be different to the —R^{A} or —R^{B} appended to a carbon of -A- or -B-.

Each of —R^{A} and —R^{B}, and —R^{C} and —R^{D} where present, may be independently selected from:
C₁₋₆ alkyl optionally substituted with a one or more groups selected from —N(R^{N})₂, —N⁺(R^{N})₃, —P⁺(R^{N})₃, —OH, —C(O)OH, —NHC(NH)NH₂, —NHC(O)NH₂ and halogen,
C₅₋₁₄ aryl optionally substituted with one or more groups selected from —(CH₂)ₙ—N(R^{N})₂, —(CH₂)ₙ—N⁺(R^{N})₃, —(CH₂)ₙ—P⁺(R^{N})₃, —(CH₂)ₙ—OH, —(CH₂)ₙ—C(O)OH, —(CH₂)ₙ—NHC(NH)NH₂, —(CH₂)ₙ—NHC(O)NH₂ and —(CH₂)ₙ-halogen, wherein n is from 0 to 6, and
—(CH₂O)ₐ₁—(C₂H₄O)ₐ₂—(C₃H₆O)ₐ₃—(CH₂C(O))ₐ₄—R^{N}, wherein a1, a2, a3 and a4 are each independently selected from 0 to 12 and the sum of a1, a2, a3 and a4 is from 1 to 12, wherein R^{N} is H or C₁₋₆ alkyl.

R^{N} is preferably C₁₋₆ alkyl, such as methyl or ethyl, such as methyl. Where R^{N} is C₁₋₆ alkyl it may be optionally substituted, such as monosubstituted. The C₁₋₆ alkyl may be substituted, such as monosubstituted, with —NH₂, —OH, —C(O)OH, —NHC(NH)NH₂, —NHC(O)NH₂ or halogen

Preferably where R^{N} is C₁₋₆ alkyl it is unsubstituted, such as unsubstituted methyl or ethyl, such as methyl.

The C₁₋₆ alkyl may be poly-substituted, such as disubstituted or trisubstituted, with groups selected from —N(R^{N})₂, —N⁺(R^{N})₃, —P⁺(R^{N})₃, —OH, —C(O)OH, —NHC(NH)NH₂, —NHC(O)NH₂ and halogen. Preferably, the C₁₋₆ alkyl is monosubstituted with a group selected from —N⁺(R^{N})₃, —P⁺(R^{N})₃, —OH, —C(O)OH, —NHC(NH)NH₂, —NHC(O)NH₂ and halogen.

The C₅₋₁₄ aryl may be poly-substituted, such as disubstituted or trisubstituted, with groups selected from —(CH₂)ₙ—N(R^{N})₂, —(CH₂)ₙ—N⁺(R^{N})₃, —(CH₂)ₙ—P⁺(R^{N})₃, —(CH₂)ₙ—OH, —(CH₂)ₙ—C(O)OH, —(CH₂)ₙ—NHC(NH)NH₂, —(CH₂)ₙ—NHC(O)NH₂ and —(CH₂)ₙ-halogen, wherein n is from 0 to 6. Preferably the C₅₋₁₄ aryl is monosubstituted with a group selected from —(CH₂)ₙ—N⁺(R^{N})₃, —(CH₂)ₙ—P⁺(R^{N})₃, —(CH₂)ₙ—OH, —(CH₂)ₙ—C(O)OH, —(CH₂)ₙ—NHC(NH)NH₂, —(CH₂)ₙ—NHC(O)NH₂ and —(CH₂)ₙ-halogen, wherein n is from 0 to 6.

The C₅₋₁₄ aryl is preferably substituted opposite the attachment point to -A- or -B-. For example, where C₅₋₁₄ aryl is phenylene the substitution is preferably at the 4-position. For example, —R^{A} and —R^{B} may be phenyl substituted at the 4-position with —N⁺(R^{N})₃, such as —N⁺(CH₃)₃.

Each of —R^{A} and —R^{B}, and —R^{C} where present, may be independently selected from:
C₁₋₆ alkyl optionally monosubstituted with a group selected from —N(R^{N})₂, —N⁺(R^{N})₃, —P⁺(R^{N})₃, —OH, —C(O)OH, —NHC(NH)NH₂, —NHC(O)NH₂ and halogen,
C₅₋₁₄ aryl optionally monosubstituted with a group selected from —(CH₂)ₙ—N(R^{N})₂, —(CH₂)ₙ—N⁺(R^{N})₃, —(CH₂)ₙ—P⁺(R^{N})₃, —(CH₂)ₙ—OH, —(CH₂)ₙ—C(O)OH, —(CH₂)ₙ—NHC(NH)NH₂, —(CH₂)ₙ—NHC(O)NH₂ and —(CH₂)ₙ-halogen, wherein n is from 0 to 6, and
—(CH₂O)ₐ₁—(C₂H₄O)ₐ₂—(C₃H₆O)ₐ₃—(CH₂C(O))ₐ₄—R^{N}, wherein a1, a2, a3 and a4 are each independently selected from 0 to 12 and the sum of a1, a2, a3 and a4 is from 1 to 12, wherein R^{N} is C₁₋₆ alkyl.

One or each of —R^{A} and —R^{B}, and —R^{C} and —R^{D} where present, may be C₁₋₆ alkyl. C₁₋₆ alkyl is a monovalent alkyl group having from 1 to 6 carbon atoms forming the alkyl chain. The alkyl chain may be linear or branched. For example, the alkyl group may be selected from methyl, ethyl, and propyl, including n-propyl and i-propyl, butyl, pentyl or hexyl. Preferably the C₁₋₆ alkyl is C₁₋₄ alkyl, such as C₁₋₃ alkyl, such as C₃ alkyl.

Where —R^{A}, —R^{B}, —R^{C} and —R^{D} is C₁₋₆ alkyl, it may be substituted with one or more groups, preferably one group, selected from —N(R^{N})₂, —N⁺(R^{N})₃, —P⁺(R^{N})₃, —OH, —C(O)OH, —NHC(NH)NH₂, —NHC(O)NH₂, NO₂, —OCH₃ and halogen. Where R^{A}, R^{B}, R^{C} and R^{D} are C₁₋₆ alkyl, it may be substituted with one or more groups selected from —N⁺(R^{N})₃, —P⁺(R^{N})₃, —OH, —C(O)OH, —NHC(NH)NH₂, —NHC(O)NH₂ and halogen. In one embodiment, the C₁₋₆ alkyl is substituted with one group selected from —N⁺(R^{N})₃, —P⁺(R^{N})₃, —OH, —C(O)OH, —NHC(NH)NH₂, —NHC(O)NH₂ and halogen.

One or each of —R^{A} and —R^{B}, and —R^{C} where present, may be C₁₋₆ alkyl. C₁₋₆ alkyl is a monovalent alkyl group having from 1 to 6 carbon atoms forming the alkyl chain. The alkyl chain may be linear or branched. For example, the alkyl group may be selected from methyl, ethyl, and propyl, including n-propyl and i-propyl, butyl, pentyl or hexyl. Preferably the C₁₋₆ alkyl is C₁₋₄ alkyl, such as C₁₋₃ alkyl, such as C₃ alkyl.

Where —R^{A}, —R^{B} and —R^{C} is C₁₋₆ alkyl, it may be substituted with one or more groups selected from —N(R^{N})₂, —N⁺(R^{N})₃, —P⁺(R^{N})₃, —OH, —C(O)OH, —NHC(NH)NH₂, —NHC(O)NH₂, NO₂, —OCH₃ and halogen. Where R^{A}, R^{B} and R^{C} are C₁₋₆ alkyl, it may be substituted with one or more groups selected from —N⁺(R^{N})₃, —P⁺(R^{N})₃, —OH, —C(O)OH, —NHC(NH)NH₂, —NHC(O)NH₂ and halogen. In one embodiment, the C₁₋₆ alkyl is substituted with one group selected from —N⁺(R^{N})₃, —P⁺(R^{N})₃, —OH, —C(O)OH, —NHC(NH)NH₂, —NHC(O)NH₂ and halogen.

The substitution may be a terminal substitution.

The alkyl group may be per-substituted with halogen, such as per-substituted with fluoro (e.g. trifluoromethyl).

Preferably the C₁₋₆ alkyl is substituted with —N⁺(R^{N})₃. The —N⁺(R^{N})₃ may be present as a terminal substitution. In one embodiment, the C₁₋₆ alkyl is —CH₂—CH₂—CH₂—N⁺(R^{N})₃.

One or each —R^{A} and —R^{B}, and —R^{C} and —R^{D} where present, may be C₅₋₁₄ aryl. C₅₋₁₄ aryl is a monovalent aromatic group having from 5 to 14 atoms forming the aryl ring or fused aryl rings. For example, the aryl group may be a 5 membered aryl group, such as thiophenyl, or a 6 membered aryl group, such as phenyl or pyridinyl, or a 10 membered aryl group, such as naphthyl, or a 14 membered aryl group, such as anthracenyl. An aryl may be carboaryl or heteroaryl.

One or each —R^{A} and —R^{B}, and —R^{C} and —R^{D} where present, may be C₅₋₁₄ aryl, preferably as C₅₋₁₀ aryl, more preferably C₅₋₆ aryl. —R^{A} and —R^{B}, and —R^{C} where present, may be C₅₋₁₀ heteroaryl or C₆₋₁₀ carboaryl.

Where —R^{A}, —R^{B}, —R^{C} and —R^{D} is C₅₋₁₄ aryl, it may be substituted with one or more groups selected from —N(R^{N})₂, —N⁺(R^{N})₃, —P⁺(R^{N})₃, —OH, —C(O)OH, —NHC(NH)NH₂, —NHC(O)NH₂, NO₂, —OCH₃ and halogen. Where —R^{A}, R^{B}, —R^{C} and —R^{D} are C₅₋₁₄ aryl, it may be substituted with one or more groups selected from —(CH₂)ₙ—N(R^{N})₂, —(CH₂)ₙ—N⁺(R^{N})₃, —(CH₂)ₙ—P⁺(R^{N})₃, —(CH₂)ₙ—OH, —(CH₂)ₙ—C(O)OH, —(CH₂)ₙ—NHC(NH)NH₂, —(CH₂)ₙ—NHC(O)NH₂ and —(CH₂)ₙ-halogen, wherein n is from 0 to 6. In one embodiment, the C₅₋₁₄ aryl is substituted with one group selected from —(CH₂)ₙ—N⁺(R^{N})₃, —(CH₂)ₙ—P⁺(R^{N})₃, —(CH₂)ₙ—OH, —(CH₂)ₙ—C(O)OH, —(CH₂)ₙ—NHC(NH)NH₂, —(CH₂)ₙ—NHC(O)NH₂ and —(CH₂)ₙ-halogen.

One or each of —R^{A} and —R^{B}, and —R^{C} where present, may be C₅₋₁₄ aryl. C₅₋₁₄ aryl is a monovalent aromatic group having from 5 to 14 atoms forming the aryl ring or fused aryl rings. For example, the aryl group may be a 5 membered aryl group, such as thiophene, or a 6 membered aryl group, such as phenyl or pyridine, or a 10 membered aryl group, such as naphthyl, or a 14 membered aryl group, such as anthracene. An aryl may be carboaryl or heteroaryl.

One or each of —R^{A} and —R^{B}, and —R^{C} where present, may be C₅₋₁₄ aryl, preferably as C₅₋₁₀ aryl, more preferably C₅₋₆ aryl. R^{A} and R^{B}, and R^{C} where present, may be C₅₋₁₀ heteroaryl or C₆₋₁₀ carboaryl.

Additionally, where —R^{A}, —R^{B} and —R^{C} are C₅₋₁₄ aryl, it may be substituted with one or more groups selected from —N(R^{N})₂, —N⁺(R^{N})₃, —P⁺(R^{N})₃, —OH, —C(O)OH, —NHC(NH)NH₂, —NHC(O)NH₂, NO₂, —OCH₃ and halogen.

Where —R^{A}, —R^{B} and —R^{C} is C₅₋₁₄ aryl, it may be substituted with one or more groups selected from —(CH₂)ₙ—N⁺(R^{N})₃, —(CH₂)ₙ—P⁺(R^{N})₃, —(CH₂)ₙ—OH, —(CH₂)ₙ—C(O)OH, —(CH₂)ₙ—NHC(NH)NH₂, —(CH₂)ₙ—NHC(O)NH₂ and —(CH₂)ₙ-halogen, wherein n is from 0 to 6. In one embodiment, the C₅₋₁₄ aryl is substituted with one group selected from —(CH₂)ₙ—N⁺(R^{N})₃, —(CH₂)ₙ—P⁺(R^{N})₃, —(CH₂)ₙ—OH, —(CH₂)ₙ—C(O)OH, —(CH₂)ₙ—NHC(NH)NH₂, —(CH₂)ₙ—NHC(O)NH₂ and —(CH₂)ₙ-halogen.

In some embodiments n is from 0 to 6, such as from 0 to 3. Preferably n is 0 or 3, such as 3.

Preferably the C₅₋₁₄ aryl is substituted with —(CH₂)ₙ—N⁺(R^{N})₃. The —N⁺(R^{N})₃ may be present as a terminal substitution. In one embodiment, the C₅₋₁₄ aryl is substituted with —CH₂—CH₂—CH₂—N⁺(R^{N})₃.

In addition, in one embodiment the C₅₋₁₄ aryl is substituted with —N⁺(R^{N})₃. In a preferred embodiment, C₅₋₁₄ aryl is —(C₆H₆)—N⁺(R^{N})₃, such as —(C₆H₆)—N⁺(CH₃)₃. Where the C₅₋₁₄ aryl is phenyl, it may be substituted at the 4-position.

One or each of —R^{A} and —R^{B}, and —R^{C} and —R^{D} where present, may be —(CH₂O)ₐ₁—(C₂H₄O)ₐ₂—(C₃H₆O)ₐ₃—(CH₂C(O))ₐ₄—R^{N}. The group —(CH₂O)ₐ₁—(C₂H₄O)ₐ₂—(C₃H₆O)ₐ₃—(CH₂C(O))ₐ₄—R^{N} is a polyglycol chain.

—R^{A} and —R^{B}, and —R^{C} where present, may be —(CH₂O)ₐ₁—(C₂H₄O)ₐ₂—(C₃H₆O)ₐ₃—(CH₂C(O))ₐ₄—R^{N}. The group —(CH₂O)ₐ₁—(C₂H₄O)ₐ₂—(C₃H₆O)ₐ₃—(CH₂C(O))ₐ₄—R^{N} is a polyglycol chain.

The repeating unit —(CH₂O)ₐ₁— is a methylene glycol repeating unit. The number of repeating units a1 is typically 0-12. In some embodiments, a1 is 0. In other embodiments, a1 is from 1 to 12, preferably from 2 to 6.

The repeating unit —(C₂H₄O)ₐ₂— is an ethylene glycol repeating unit. The number of repeating units a2 is typically 0-12. In some embodiments, a2 is 0. In other embodiments, a2 is from 1 to 12, preferably from 2 to 6.

The repeating unit —(C₃H₆O)ₐ₃— is a propylene glycol repeating unit. The number of repeating units a3 is typically 0-12. In some embodiments, a3 is 0. In other embodiments, a3 is from 1 to 12, preferably from 2 to 6.

The —(CH₂C(O))ₐ₄— is an acetyl repeating unit. The number of repeating units a4 is typically 0-12. In some embodiments, a4 is 0. In other embodiments, a4 is from 1 to 12, preferably from 2 to 6.

Typically, a1, a2, a3 and a4 are each independently selected from 0 to 12, and the sum of a1, a2, a3 and a4 is 1 to 12. Preferably, a1, a2, a3 and a4 are each independently selected from 0 to 6, and the sum of a1, a2, a3 and a4 is 2 to 6.

R^{N} is H or C₁₋₆ alkyl. Where —R^{N} is a C₁₋₆ alkyl, it is preferably a C₁₋₄ alkyl, such as C₁₋₃ alkyl, such as C₁₋₂ alkyl. Preferably —R^{N} is methyl. Where —R^{A} and —R^{B}, and —R^{C} where present, is a polyglycol chain then R^{N} is preferably H.

In some embodiments, —R^{A} and —R^{B} are each independently a C₁₋₆ alkyl substituted with N⁺(R^{N})₃ or -P⁺(R^{N})₃. Preferably, —R^{A} and —R^{B} are each independently a C₂₋₄ alkyl, preferably a C₃ alkyl group, substituted with N⁺(R^{N})₃ or P⁺(R^{N})₃, preferably monosubstituted with N⁺(R^{N})₃

In some embodiments, —R^{A} and —R^{B} are each independently a C₅₋₁₄ aryl substituted with one or more groups selected from —(CH₂)ₙ—N⁺(R^{N})₃ or —(CH₂)ₙ—P⁺(R^{N})₃, wherein n is from 0 to 6. Preferably, —R^{A} and —R^{B} are each independently a C₅₋₁₄ aryl substituted with one group selected from —(CH₂)ₙ—N⁺(R^{N})₃ or —(CH₂)ₙ—P⁺(R^{N})₃, preferably monosubstituted with —(CH₂)ₙ—N⁺(R^{N})₃.

In some embodiments, a and b are independently from 1 to 3. Preferably, a and b are both 1.

In some embodiments, —R^{C} is selected from C₁₋₆ alkyl and —(CH₂O)ₐ₁—(C₂H₄O)ₐ₂—(C₃H₆O)ₐ₃—(CH₂C(O))ₐ₄—R^{N}. Preferably, —R^{C} is C₁₋₆ alkyl, preferably C₁₋₃ alkyl, more preferably C₁₋₂ alkyl. R^{C} preferably has a low steric bulk, so as not to inhibit dimerisation of the organic redox molecule. Preferably —R^{C} is methyl or ethyl.

In some embodiments, [L]_{c} is substituted with one or more —R^{C} groups, such as one to four —R^{C} groups, such as one or two —R^{C} groups. In other embodiments, -L- is unsubstituted.

Additionally, in some embodiments, —R^{D} is selected from C₁₋₆ alkyl and —(CH₂O)ₐ₁—(C₂H₄O)ₐ₂—(C₃H₆O)ₐ₃—(CH₂C(O))ₐ₄—R^{N}. Preferably, —R^{D} is C₁₋₆ alkyl, preferably C₁₋₃ alkyl, more preferably C₁₋₂ alkyl. —R^{D} preferably has a low steric bulk, so as not to inhibit dimerisation of the organic redox molecule. Preferably —R^{D} is methyl or ethyl.

Additionally, in some embodiments, [L¹]_{d} is substituted with one or more —R^{D} groups, such as one to four R^{D} groups, such as one or two R^{D} groups. In other embodiments, -L¹- is unsubstituted.

Typically, the redox-active species has a positive charge, n, in the unreduced state. When the redox-active species is reduced, the singly reduced form has a charge of n−1. When the redox-active species is doubly reduced, the doubly reduced form has a charge of n−2.

In general, n is from 2 to 4. Preferably n is 4.

In addition, the redox-active species is typically not zwitterionic. The redox-active species is preferably not zwitterionic in the singly reduced form or the doubly reduced form. The redox-active species preferably has a positive charge, n, of 2 or more in the unreduced form. This is particularly preferred where the hydrophilic groups are positively charged. This is such that the double reduced form of the redox-active species retains a neutral or positive charge. Where n is 1 or less, the arylene core of the redox-active species may take on a negative charge in the reduced forms, which may give a zwitterionic character with positively charged hydrophilic groups. It is thought that Zwitterionic character increases the propensity for stacking and aggregation in an aqueous environment.

The redox-active species has a counter anion, X, such that the redox-active species and the counterion have a net zero charge. The counter anion(s) have a total charge per redox-active molecule of −n.

X is typically a redox in-active species. In some embodiment, X is halide, hexafluorophosphate, p-toluenesulfonate, triflouromethane-sulfonate, methyl sulfonate. Preferably X is a halide, such as Cl⁻ or Br⁻. In one embodiment X is Br⁻.

In an additional embodiment, the organic redox-active molecule is selected from:

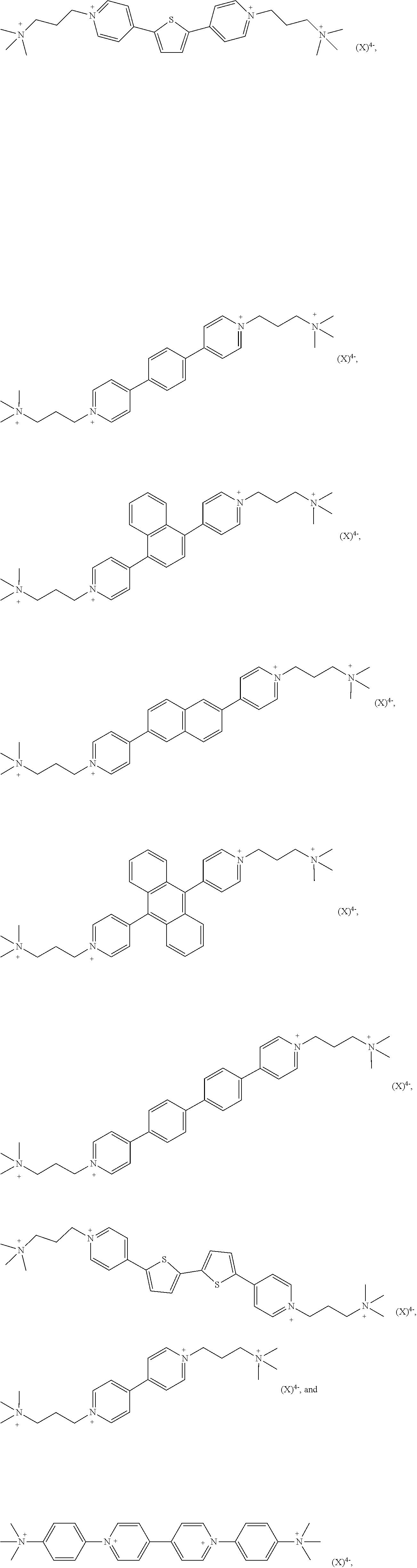

wherein X is defined as above.

In some embodiments, the organic redox-active molecule is selected from:

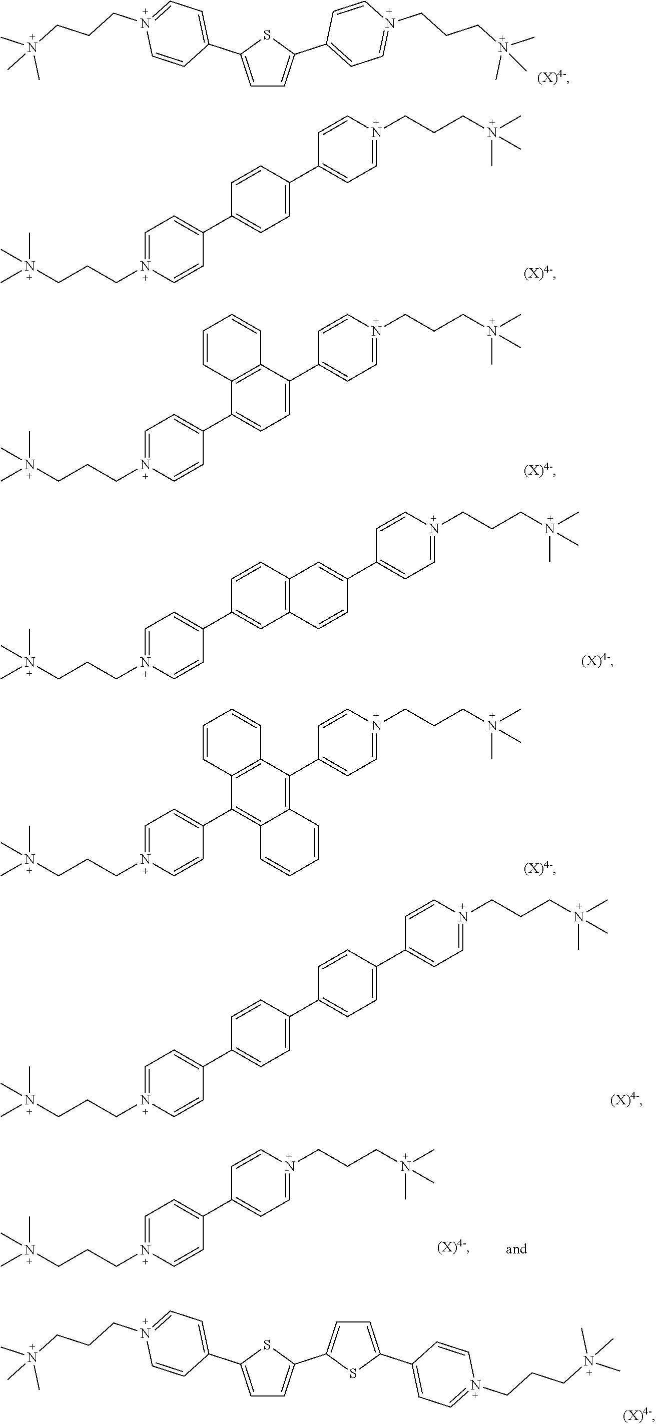

wherein X is defined as above.

Preferably, the organic redox-active molecule is selected from:

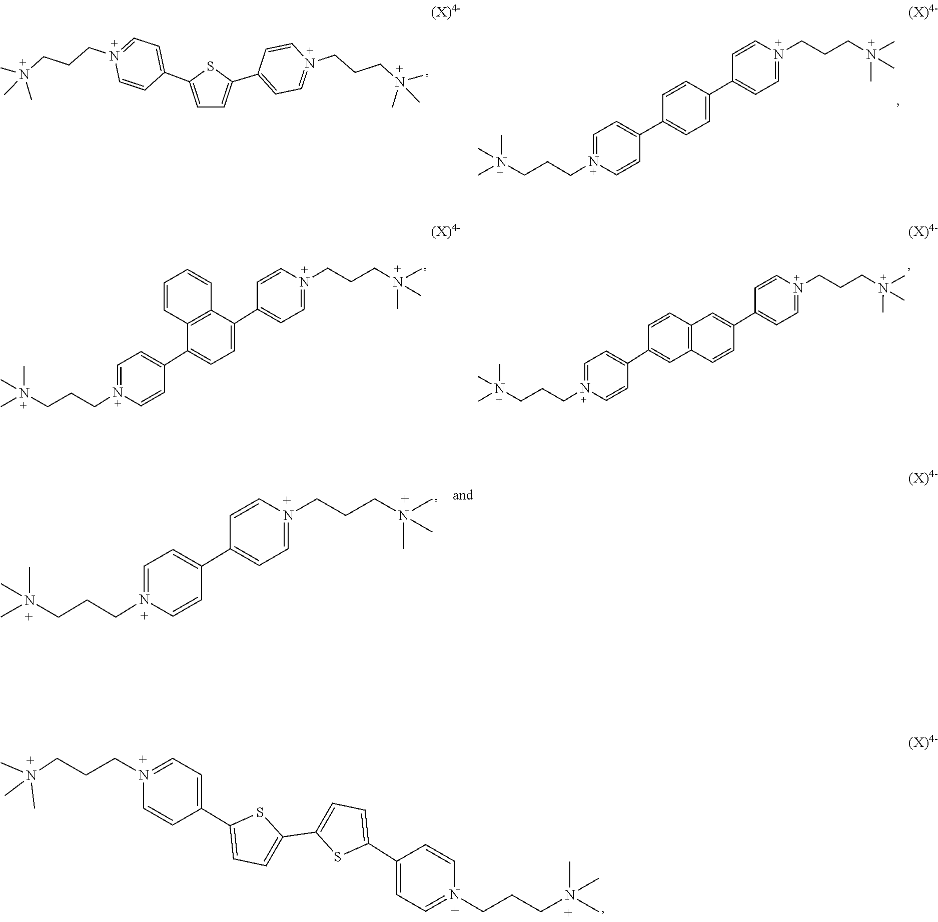

wherein X is defined as above.

Additionally or alternatively, the organic redox-active molecule may be selected from:

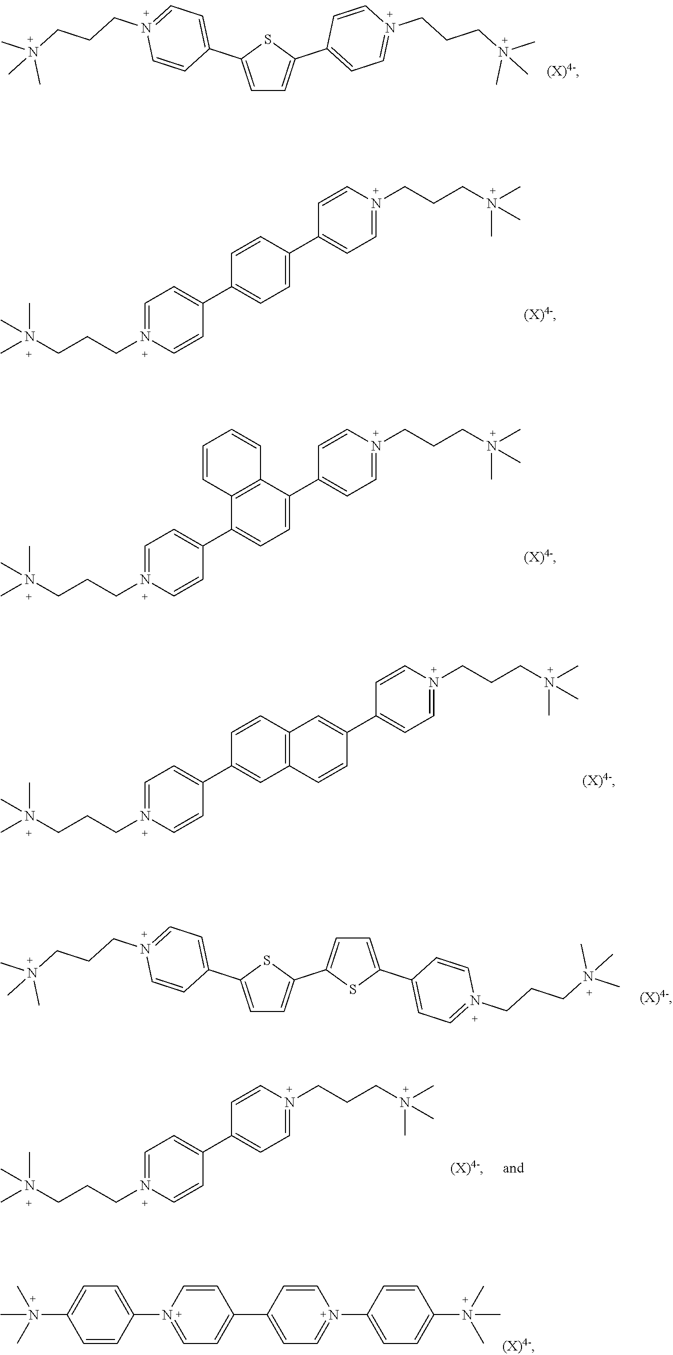

wherein X is defined as above.

### Preparation of an RFB

In a second aspect of the invention there is provided a method of preparing a redox flow battery, the method comprising:
preparing an electrolyte by combining an organic redox-active molecule with a liquid carrier, wherein the organic redox-active molecule comprises a redox-active unit with two or more heteroarylene groups and the two or more heteroarylene groups are conjugated within the redox-active unit;
adding the electrolyte to the redox flow battery wherein molecular dioxygen (O₂) is dissolved in the electrolyte, and
reducing the organic redox-active molecule to provide a singly reduced form of the redox-active unit which forms a complex,
where the complex is an intermolecular complex of redox-active units, such as a homodimer, an intramolecular complex of redox-active units, or the complex is a combination of intermolecular and intermolecular complexed redox-active units.

The organic redox-active molecule is as described herein. The organic redox-active molecule is preferably of formula (I), more preferably of formula (II). Preferably the organic redox-active molecule is a viologen or extended viologen.

Typically, molecular dioxygen is present in the electrolyte. In general, molecular dioxygen is not removed from the electrolyte and/or the battery headspace during preparation of the cell. For example, the method does not include a step of purging the electrolyte and/or the battery headspace of molecular dioxygen.

The RFB and the presence of dioxygen in the RFB is as described herein. The description of the RFB itself is also applicable to the method of preparing the RFB.

In a third aspect, the present invention also provides a RFB obtained or obtainable by the method of preparation of the second aspect.

Charging and/or Discharging a RFB

In a fourth aspect, the present invention provides a method of charging and/or discharging a redox flow battery in the presence of molecular dioxygen, the redox flow battery comprising an electrolyte, the electrolyte comprising:
an organic redox-active molecule comprising a redox active unit with two or more heteroarylene groups wherein the two or more heteroaryl groups are conjugated within the redox-active unit, and
molecular dioxygen (O₂) dissolved in the electrolyte;
   the method comprising:
reducing the redox-active unit to provide a complex formed of a singly reduced form of the redox-active unit, and/or
oxidising a double reduced form of the redox-active unit to provide a complex formed of a singly reduced form of the redox-active unit,
   where the complex is an intermolecular complex of redox-active units, such as a homodimer, an intramolecular complex of redox-active units, or the complex is a combination of intermolecular and intermolecular complexed redox-active units.

The RFB, organic redox-active molecule and its singly and doubly reduced form are as described herein. The organic redox-active molecule is preferably of formula (I), more preferably of formula (II). Preferably the organic redox-active molecule is a viologen or extended viologen.

Charging typically occurs by applying a potential difference across the RFB. Discharging typically occurs by providing a means for electron transfer across the RFB. Discharging typically provides power to a load.

The Coulombic efficiency during discharging may be 70% or more, preferably 75% or more, more preferably 80% or more, yet more preferably 85% or more.

The discharge capacity retention over 100 charge and discharge cycles may be 80% or more, preferably 85% or more, more preferably 90% or more.

The discharge capacity retention compared to cycling in the absence of dioxygen is 50% or more.

A high coulombic efficiency and good capacity retention is thought to be associated with a low degree of degradation and dioxygen tolerance of the redox-active species. It is thought that a high coulombic efficiency and a small decrease in capacity indicates that π-dimerisation is acting as a competing pathway to dioxygen mediated side reactions, through which viologen reactivity with dioxygen can be supressed. The discharge capacity decrease compared to the capacity in the absence of dioxygen is acceptable in view of the high coulombic efficiency and low degree of degradation.

In some embodiments, the step of reducing and/or oxidising the organic redox-active molecule occurs at a per cell voltage of 1.23 V or more, preferably 1.5 V or more. At these high per cell voltages, an aqueous liquid carrier typically undergoes electrolytic splitting of water. This provides molecular dioxygen in the electrolyte. The cell voltage required to cause electrolytic water splitting depends on the pH of the water (Gesser, Applied Chemistry)

In general, RFBs having an aqueous electrolyte which do not include an dioxygen tolerant redox-active species are not able to cycle at these higher per cell voltages. Dioxygen is generated in the electrolyte in situ, and thus contributes to degradation of the redox-active species. Alternatively, the known cells have to continually purge the electrolyte using an inert gas to remove any dioxygen generated in situ. In the present invention, the redox-active species is dioxygen tolerant—and so is able to cycle at these higher voltages without significant redox-active species degradation and without purging of the electrolyte.

In some embodiments, the step of reducing and/or oxidising the organic redox-active molecule uses a current density of 20 mA cm⁻² or more, preferably 30 mA cm⁻² or more, more preferably 40 mA cm⁻² or more.

At these higher current densities, it is thought that the rate of electron transfer is such that the redox process can effectively compete with electron transfer reactions to dioxygen molecules in the electrolyte. As a result, higher current densities kinetically favour the redox of the redox-active species, rather than oxygen side-reactions, meaning the effect of molecular dioxygen is further reduced. In some embodiments, this means that the RFB can be cycled for long periods in the presence of dioxygen, avoiding the need for purging with inert gas.

### Use

In a fifth aspect, the invention provides a use of redox flow battery for charging and/or discharging in the presence of molecular dioxygen, the redox flow battery comprising an electrolyte, the electrolyte comprising:
an organic redox-active molecule comprising a redox-active unit with two or more heteroarylene groups wherein the two or more heteroarylene groups are conjugated within the redox-active unit, and at least a portion of the redox-active units are present as a complex formed of a singly reduced form of the redox-active unit, and
molecular dioxygen (O₂) dissolved in the electrolyte;
where the complex is an intermolecular complex of redox-active units, such as a homodimer, an intramolecular complex of redox-active units, or the complex is a combination of intermolecular and intermolecular complexed redox-active units.

The RFB, organic redox-active molecule and its singly and doubly reduced form are as described herein. The organic redox-active molecule is preferably of formula (I), more preferably of formula (II). Preferably the organic redox-active molecule is a viologen or extended viologen.

The charging and/or discharging of the redox flow battery is as described above for the method of charging and/or discharging.

Preferably, the use of the RFB is for charging and/or discharging at a per cell voltage of 1.23 V or more, preferably 1.5 V or more.

Preferably, the use of the RFB is at a current density of 20 mA cm⁻² or more, preferably 30 mA cm⁻² or more, more preferably 40 mA cm⁻² or more.

The molecular dioxygen dissolved in the electrolyte is as described above for the redox flow battery.

Preferably, the dioxygen is dissolved in the electrolyte (e.g. anolyte) at a partial pressure equivalent to a concentration of 1% by volume or more, preferably at a concentration of 10% by volume or more, more preferably at a concentration of 15% by volume or more, yet more preferably at a concentration of about 20% by volume.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### EXAMPLES

The following examples are provided to further illustrate the present invention and are not intended to limit the scope of the invention.

### Materials

4-pyridinylboronic acid (97%), potassium carbonate (anhydrous), and sodium chloride (analytical) were purchased from Fisher Scientific. 1,4-dibromobenzene (>98%), 4,4′-dibromobiphenyl (98%), 2,5-dibromothiophene (96%), 1,4-dibromonapthalene (98%), 2,6-dibromonapthalene (97%), 2,7-dibromonapthalene (99%), 9,10-dibromoanthracene (98%), 2,6-dibromopyridine (98%), 5,5′-dibromo-2,2′-bithiophene (99%), tetrakis(triphenylphosphine) palladium(0) (99.8% (metals basis), Pd 9% min), and palladium on carbon (10 wt. %) were purchased from Sigma Aldrich. N,N-dimethylformamide (>99%, anhydrous), dichloromethane (>99%), ethyl acetate (>99%), acetonitrile (>99%), diethyl ether (>99%), hydrochloric acid (99%), 4,4′-bipyridine (99%), methyl viologen dichloride hydrate (98%), 4-hydroxy-2,2,6,6-tetramethylpiperidine 1-oxyl (97%), and deuterium oxide (99.9% atom % D) were purchased from Sigma-Aldrich. Milli-Q water was used for preparation of all non-deuterated aqueous solutions. Materials were used as obtained without further purification.

### Measurement Apparatus

NMR measurements were carried out using a 300 MHz, Bruker Avance III. EPR measurements were carried out using a benchtop EPR (MS5000, Magnettech). UV/Vis spectra were collected using a UV/Vis spectrometer (Horiba, Duetta).

### Synthesis of Compounds 1 to 9

Compounds 1, 2, 3, 4, 5, 6, 7, 8 and 9 (pictured below) were synthesised via Suzuki-Miyaura coupling. 4-pyridinylboronic acid (1.25 g, 10 mmol), aryl dibromide (4.2 mmol) and potassium carbonate (2.8 g, 20.4 mmol) were added to a 7:1 mixture of degassed DMF and water (120 ml). Tetrakis(triphenylphosphine)palladium(0) (0.39 g, 0.34 mmol) was added to the reaction mixture and the solution heated to 100° C. under N₂ for 72 h. Thereafter, the reaction mixture was cooled to room temperature and filtered. The organic phase was concentrated under vacuum and the residue dissolved in CH₂Cl₂ (150 mL) and washed three times with water (50 mL each). Concentrated HCl was then added dropwise to the collected organic phase, resulting in precipitation of the product. The precipitate was collected by filtration and then dissolved in H₂O. Finally, aqueous NaOH (10 M) was added dropwise to the H₂O layer until the pH was 8-9, resulting in the precipitation of the pure product of compounds 1, 2, 3, 4, 5, 6, 7, 8 and 9 respectively.

### Characterization of Compounds 1 to 9

The compounds were characterized by ¹H NMR.

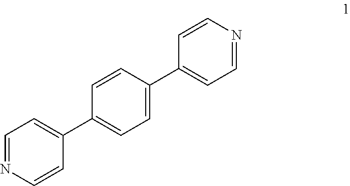 [SMILES: c1cc(-c2ccc(-c3ccncc3)cc2)ccn1]

¹H NMR (400 MHz, CDCl₃) δ [ppm]: 8.70 (dd, J=4.4, 1.6 Hz, 4H), 7.77 (s, 4H), 7.56 (dd, J=4.4, 1.6 Hz, 4H).

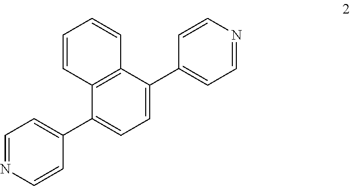 [SMILES: c1ccc2c(-c3ccncc3)ccc(-c3ccncc3)c2c1]

¹H NMR (400 MHz, CDCl₃) δ [ppm]: 8.77 (dd, J=4.4, 1.6 Hz, 4H), 7.92 (dd, J=6.4, 3.2 Hz, 2H), 7.52 (dd, J=6.4, 3.2 Hz; 2H), 7.49 (s, 2H), 7.48 (dd, J=4.4, 1.6 Hz, 4H).

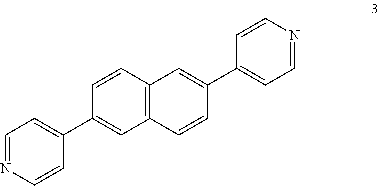 [SMILES: c1cc(-c2ccc3cc(-c4ccncc4)ccc3c2)ccn1]

¹H NMR (400 MHz, CDCl₃) δ [ppm]: 8.73 (dd, J=4.4, 1.6 Hz, 4H), 8.16 (s, 2H), 8.05 (d, J=8.5 Hz, 2H), 7.83 (d, J=8.5 Hz, 2H), 7.66 (dd, J=4.4, 1.6 Hz, 4H).

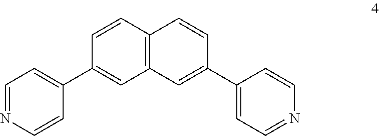 [SMILES: c1cc(-c2ccc3ccc(-c4ccncc4)cc3c2)ccn1]

¹H NMR (400 MHz, CDCl₃) δ [ppm]: 8.74 (dd, J=4.4, 1.6 Hz, 4H), 8.21 (dd, J=1.6, 0.8 Hz, 2H), 8.02 (d, J=8.7 Hz, 2H), 7.82 (dd, J=8.6, 1.8 Hz, 2H), 7.66 (dd, J=4.4, 1.6 Hz, 4H).

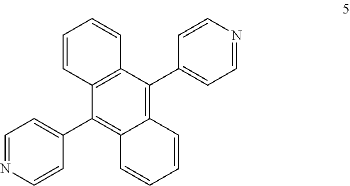 [SMILES: c1ccc2c(-c3ccncc3)c3ccccc3c(-c3ccncc3)c2c1]

¹H NMR (400 MHz, CDCl₃) δ [ppm]: 8.89 (dd, J=4.0, 1.6 Hz, 4H), 7.62 (dd, J=6.8, 3.2 Hz, 4H), 7.45 (dd, J=4.0, 1.6 Hz, 4H), 7.40 (dd, J=6.9, 3.2 Hz, 4H).

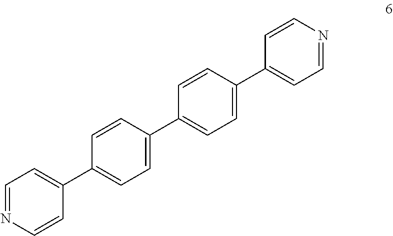 [SMILES: c1cc(-c2ccc(-c3ccc(-c4ccncc4)cc3)cc2)ccn1]

¹H NMR (400 MHz, CDCl₃) δ [ppm]: 8.70 (dd, J=4.4, 1.6 Hz, 4H), 7.77 (s, 8H), 7.57 (dd, J=4.4, 1.6 Hz, 4H).

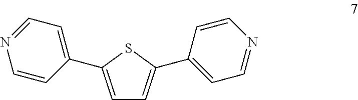 [SMILES: c1cc(-c2ccc(-c3ccncc3)s2)ccn1]

¹H NMR (400 MHz, CDCl₃) δ [ppm]: 8.64 (dd, J=4.4, 1.6 Hz, 4H), 7.55 (s, 2H), 7.51 (dd, J=4.4, 1.6 Hz, 4H).

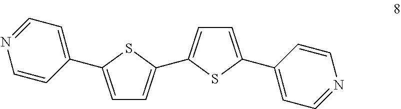 [SMILES: c1cc(-c2ccc(-c3ccc(-c4ccncc4)s3)s2)ccn1]

¹H NMR (400 MHz, CDCl₃) δ [ppm]: 8.62 (dd, J=4.4, 1.6 Hz, 4H), 7.48-7.44 (m, 6H), 7.25 (s, 2H).

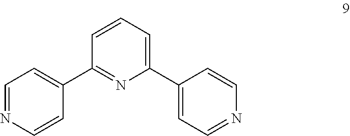 [SMILES: c1cc(-c2ccncc2)nc(-c2ccncc2)c1]

¹H NMR (400 MHz, CDCl₃) δ [ppm]: 8.79 (dd, J=4.0, 1.6 Hz, 4H), 8.08 (dd, J=4.0, 1.6 Hz, 4H), 7.99 (dd, J=7.5 Hz, 7.0 Hz, 2H), 7.92 (t, J=6.0 Hz 1H).

### Alternative Synthesis of Compounds 1

Compounds 1 was also synthesised using a Pd-C catalysed processes, opposed to the Tetrakis(triphenylphosphine)palladium(0) described above. 4-pyridinylboronic acid (1.72 g, 14 mmol), 1,4-dibromobenzene (1.00 g, 4.2 mmol) and potassium carbonate (3.52 g, 25 mmol) were added to a 1:1 mixture of degassed DMF and water (120 ml). Palladium on activated carbon (100 mg) was added to the reaction mixture and the solution heated to 100° C. under N₂ for 72 h. Thereafter, the reaction mixture was cooled to room temperature and filtered. The organic phase was concentrated under vacuum and the residue dissolved in CH₂Cl₂ (150 mL) and washed three times with water (50 mL each). Concentrated HCl was then added dropwise to the collected organic phase, resulting in precipitation of the product. The precipitate was collected by filtration and then dissolved in H₂O. Finally, aqueous NaOH (10 M) was added dropwise to the H₂O layer until the pH was ca. 8-9, resulting in the precipitation of the pure product (89 mg, 9%).

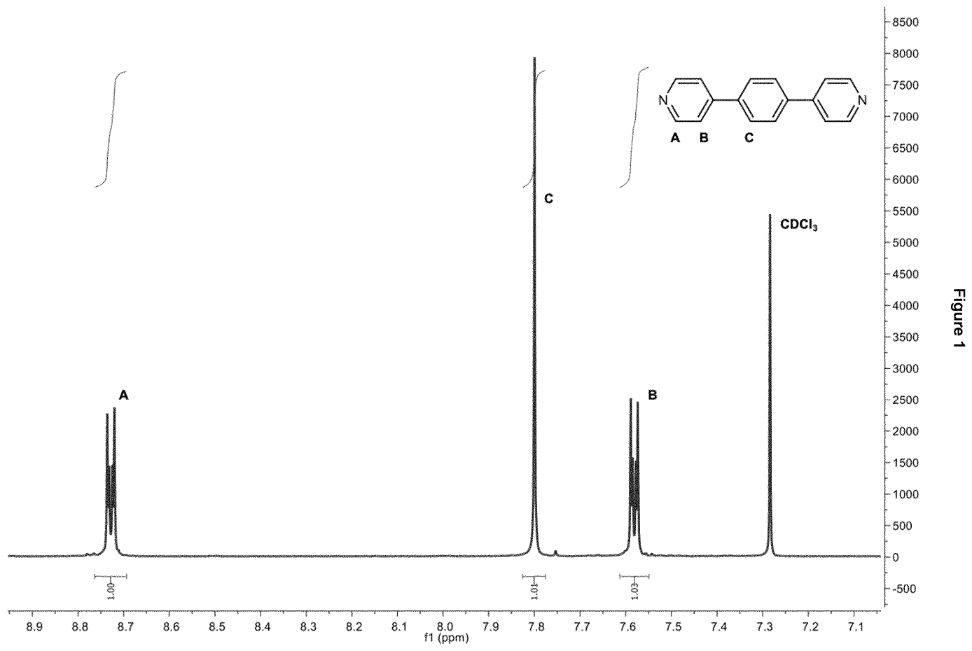

NMR spectra of compound 1 (see FIG. 1) prepared by this method revealed product purities in excess of 99%—higher than those obtained using tetrakis(triphenylphosphine)palladium(0).

### Synthesis of Compounds 10, 11, 12, 13, 15, 16, 17, 18 and Comparative 14 and 19

Compounds 10, 11, 12, 13, 15, 16, 17, 18 and Comparative Compounds 14 and 19 (pictured below) were synthesised via the Anderson/Menshutkin reaction. (3-bromopropyl)trimethylammonium bromide) (1.00 g, 3.83 mmol) was added to a stirred solution of bipyridine (1.29 mmol) in anhydrous and degassed DMF (50 mL). The reaction mixture was heated to 100° C. and stirred for 48 h. Thereafter, the reaction mixture was cooled to 0° C. and the resulting precipitate was filtered and washed with cold DMF (3×20 mL), MeCN (3×20 mL) and diethyl ether (3×20 mL) to obtain the pure product. To obtain the corresponding tetrachloride salts, isolated bispyridinium salts were loaded onto an ion exchanged column. Tetrachloride salts were collected using three portions of water (50 mL each). Upon concentration under vacuum, compounds 10, 11, 12, 13, 14, 17, 18 and 19 were obtained. To obtain purities in excess of 99.9%, suitable for electrochemical studies, compounds 10, 11, 12, 13, 14, 17, 18 and 19 were triturated six times from water using acetone.

### Characterization of Compounds 10, 11, 12, 13, 15, 16, 17, 18 and Comparative 14 and 19

Compounds 10, 11 and 17 were characterized by ¹H NMR, and compounds 12, 13, 15, 16, 18 and Comparative Compounds 14 and 19 were characterized by ¹H and C¹³ NMR, FTIR and MS. Bromide counterions are omitted from the structures for clarity.

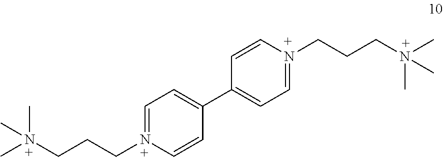

¹H NMR (400 MHz, D₂O) δ [ppm]: 9.22 (d, J=6.0 Hz, 4H), 8.65 (d, J=6.0 Hz, 4H), 4.88 (t, J=7.6 Hz, 4H), 3.63-3.59 (m, 4H), 3.22 (s, 18H), 2.75-2.67 (m, 4H).

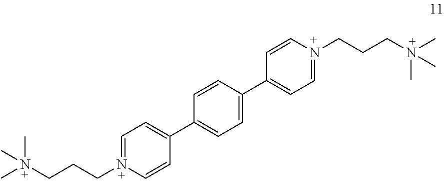

¹H NMR (400 MHz, D₂O) δ [ppm]: 8.99 (d, J=7.0 Hz, 4H), 8.49 (d, J=6.9 Hz, 4H), 8.21 (s, 4H), 4.83-4.75 (m, 4H), 3.62-3.57 (m, 4H), 3.22 (s, 18H), 2.73-2.63 (m, 4H).

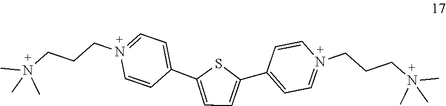

¹H NMR (400 MHz, D₂O) δ [ppm]: 8.89 (d, J=6.4 Hz, 4H), 8.39 (d, J=6.0 Hz, 4H), 8.19 (s, 2H), 4.73 (t, J=7.7 Hz, 4H), 3.66-3.50 (m, 4H), 3.21 (s, 18H), 2.73-2.60 (m, 4H).

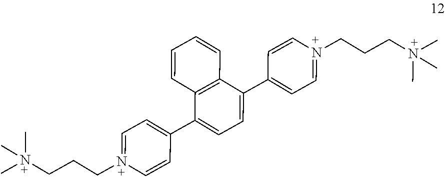

¹H NMR (400 MHz, D₂O) δ [ppm]: 9.08 (d, J=5.2 Hz, 4H), 8.39 (d, J=5.0 Hz, 4H), 8.04-8.01 (m, 2H), 7.85 (s, 2H), 7.79-7.75 (m, 2H), 4.87 (t, J=8.0 Hz, 4H), 3.66-3.62 (m, 4H), 3.24 (s, 18H), 2.78-2.70 (m, 4H). ¹³C NMR (100 MHz, D₂O) 9 [ppm]: 157.70, 144.26, 136.31, 130.01, 129.52, 128.42, 127.62, 125.08, 62.47, 57.65, 53.20, 53.16, 53.13, 24.60. MS ESI-MS: m/z [M]⁴⁺ calc for C₃₂H₄₄N₄: 121.0886, found: 121.0888. FTIR v [cm⁻¹]: 667, 742, 768, 832, 845, 878, 912, 929, 963, 1063, 1120, 1190, 1232, 1313, 1361, 1393, 1426, 1472, 1520, 1558, 1635, 3020, 3370. 80% yield.

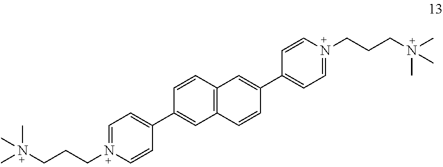

¹H NMR (400 MHz, D₂O) δ [ppm]: 8.97 (d, J=5.0 Hz, 4H), 8.69 (s, 2H), 8.56 (d, J=5.2 Hz, 4H), 8.36 (d, J=8.0 Hz, 2H), 8.16 (d, J=8.0 Hz, 2H), 4.79-4.76 (m, 4H), 3.61-3.57 (m, 4H), 3.24 (s, 18H), 2.78-2.70 (m, 4H). ¹³C NMR (100 MHz, D₂O) δ [ppm]: 156.27, 144.27, 134.06, 133.06, 130.73, 128.82, 125.65, 125.23, 62.46, 57.17, 53.18, 24.56. MS ESI-MS: m/z [M]⁴⁺ calc for C₃₂H₄₄N₄: 121.0886, found: 121.0885. FTIR v [cm⁻¹]: 741, 768, 833, 846, 887, 930, 964, 1039, 1065, 1120, 1148, 1190, 1233, 1313, 1361, 1392, 1424, 1472, 1520, 1558, 1636, 1711, 3021, 3367. 89% yield.

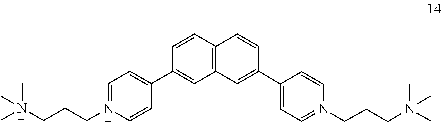

¹H NMR (400 MHz, D₂O) δ [ppm]: 8.98 (d, J=5.6 Hz, 4H), 8.75 (s, 2H), 8.56 (d, J=6.2 Hz, 4H), 8.28 (d, J=8.8 Hz, 2H), 8.18 (d, J=8.8 Hz, 2H), 4.79-4.76 (m, 4H), 3.61-3.59 (m, 4H), 3.22 (s, 18H), 2.72-2.64 (m, 4H). ¹³C NMR (100 MHz, D₂O) δ [ppm]: 156.42, 144.23, 135.64, 132.72, 132.24, 130.21, 129.54, 126.46, 125.63, 62.51, 57.20, 53.15, 24.54. MS ESI-MS: m/z [M]⁴⁺ calc for C₃₂H₄₄N₄: 121.0886, found: 121.0887. FTIR v [cm⁻¹]: 848, 923, 940, 968, 1057, 1066, 1175, 1241, 1349, 1394, 1409, 1477, 1532, 1559, 1623, 1638, 2901, 2988, 3351, 3661. 85% yield.

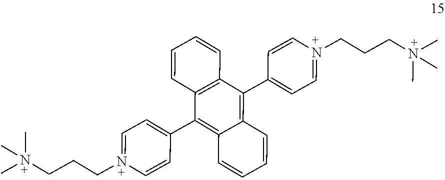

¹H NMR (400 MHz, D₂O) δ [ppm]: 9.23 (d, J=9.2 Hz, 4H), 8.38 (d, J=6.0 Hz, 4H), 7.68-7.61 (m, 8H), 4.96 (t, J=7.2 Hz, 4H), 3.73-3.69 (m, 4H), 3.28 (s, 18H), 2.87-2.78 (m, 4H). ¹³C NMR (100 MHz, D₂O) δ [ppm]: 157.54, 144.69, 132.48, 131.46, 128.06, 127.43, 125.31, 62.56, 57.98, 53.22, 24.72. MS ESI-MS: m/z [M]⁴⁺ calc for C₃₆H₄₆N₄: 133.5925, found: 133.5925. FTIR v [cm⁻¹]: 679, 734, 819, 831, 893, 923, 960, 1032, 1109, 1139, 1160, 1183, 1216, 1292, 1341, 1394, 1418, 1448, 1477, 1519, 1559, 1640, 3059, 3121, 3352. 83% yield.

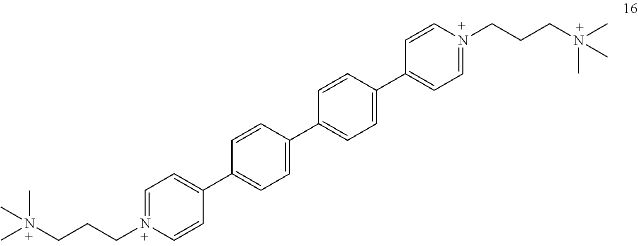

¹H NMR (400 MHz, D₂O) δ [ppm]: 8.92 (d, J=6.0 Hz, 4H), 8.46 (d, J=5.6 Hz, 4H), 8.16 (d, J=7.6 Hz, 4H), 8.07 (d, J=7.2 Hz, 4H), 4.75 (t, J=7.2 Hz, 4H), 3.59-3.56 (m, 4H), 3.21 (s, 18H), 2.70-2.62 (m, 4H). ¹³C NMR (100 MHz, D₂O) δ [ppm]: 156.41, 144.16, 142.75, 133.38, 128.80, 128.24, 125.20, 62.48, 57.10, 53.08, 24.47. MS ESI-MS: m/z [M]⁴⁺ calc for C₃₄H₄₆N₄: 127.5925, found: 127.5925. FTIR v [cm⁻¹]: 739, 756, 817, 836, 872, 927, 964, 1057, 1066, 1187, 1201, 1231, 1295, 1394, 1404, 1469, 1492, 1525, 1543, 1570, 1603, 1635, 2901, 2989, 3363, 3662. 81% yield.

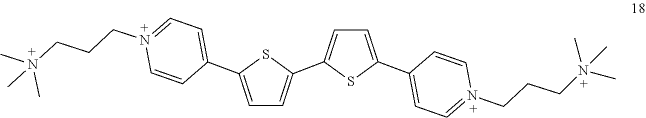

¹H NMR (400 MHz, D₂O) δ [ppm]: 8.76 (d, J=6.8 Hz, 4H), 8.26 (d, J=6.0 Hz, 4H), 8.07 (d, J=3.6 Hz, 2H), 7.70 (d, J=3.6 Hz, 2H), 4.66 (t, J=7.8 Hz, 4H), 3.57-3.53 (m, 4H), 3.20 (s, 18H), 2.65-2.57 (m, 4H). ¹³C NMR (100 MHz, D₂O) δ [ppm]: 148.90, 143.94, 142.97, 137.00, 133.22, 128.33, 122.70, 62.47, 56.82, 53.14, 53.11, 53.08, 24.41. MS ESI-MS: m/z [M]⁴⁺ calc for C₃₀H₄₂N₄S₂: 130.5707, found: 130.5706. FTIR v [cm⁻¹]: 667, 728, 741, 772, 805, 845, 875, 942, 964, 1000, 1048, 1071, 1084, 1118, 1174, 1204, 1225, 1240, 1307, 1330, 1357, 1381, 1407, 1433, 1465, 1492, 1528, 1553, 1628, 3002, 3016, 3041, 3423. 82% yield.

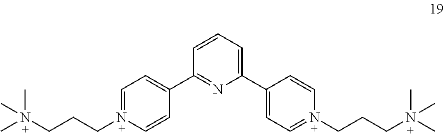

¹H NMR (400 MHz, D₂O) δ [ppm]: 9.08 (d, J=5.4 Hz, 4H), 8.90 (d, J=5.2 Hz, 4H), 8.48 (d, J=8.0 Hz, 2H), 8.37 (t, 7.5 Hz, 1H), 4.82 (t, J=7.6 Hz, 4H), 3.62-3.58 (m, 4H), 3.21 (s, 18H), 2.73-2.65 (m, 4H). ¹³C NMR (100 MHz, D₂O) δ [ppm]: 153.88, 150.95, 144.96, 140.36, 125.77, 125.64, 62.54, 57.66, 53.24, 24.64. MS ESI-MS: m/z [M]⁴⁺ calc for C₂₇H₄₁N₅: 108.8335, found: 108.8337. FTIR v [cm-1]: 722, 811, 871, 925, 962, 991, 1066, 1099, 1183, 1230, 1293, 1349, 1408, 1451, 1477, 1520, 1568, 1590, 1638, 2494, 2989, 3363, 3671. 76% yield.

### Additional Synthesis and Characterisation of Compound 20

Compound 20 (pictured below) was synthesised via the Zincke reaction. First, the 4,4′-bipyridine and 1-chloro-2,4-dinitrobenzene (excess) were refluxed for 72 h in ethanol. The reaction mixture was then cooled to room temperature and concentrated under vacuum. It was precipitated with diethyl ether and dried to afford the corresponding Zincke salt. In a second step, this was reacted with 4-trimethylammonium aniline (excess) for 72 h under reflux in ethanol. The crude product was collected by filtration and purified by washing with three portions of ethanol. 20 was obtained in purity in excess of 99.9%, suitable for electrochemical studies, by triturating six times from water using acetone.

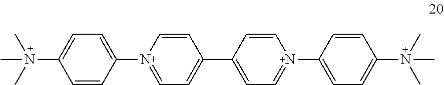

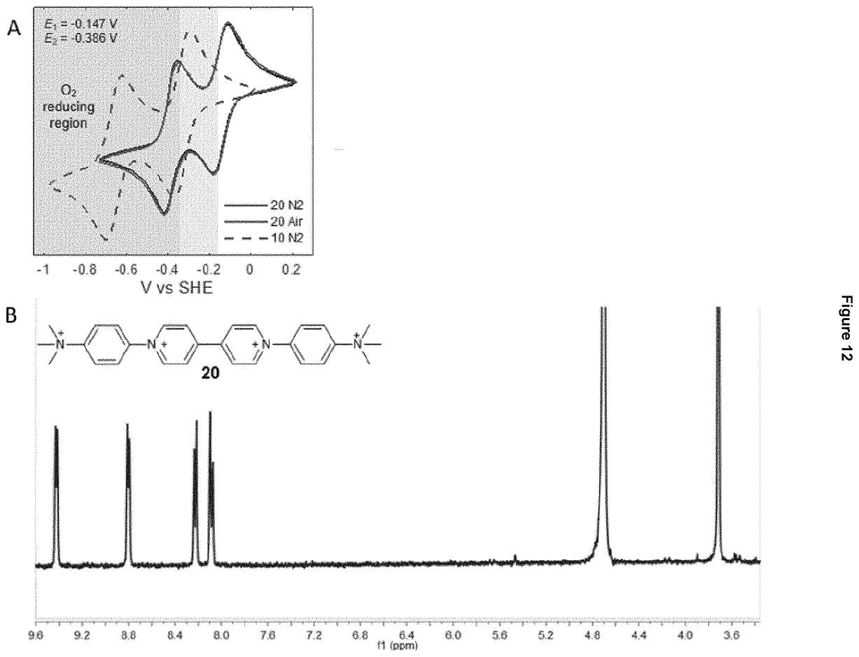

Compound 20 was characterized by ¹H NMR, and the NMR is shown in FIG. 12C. Chloride counterions are omitted from the structures for clarity.

### Calculated Singlet-Triplet Energy Gaps

Singlet-triplet gaps (E_{ST}) were calculated by taking the difference in free energies obtained for optimised structures for both the singlet and triplet forms of the respective doubly reduced compounds. Free energy values were calculated from geometry optimised structures based on DFT carried out at the UB3LYP/6-31++G(d,p) level using an UltraFine integration grid, GD3BJ and the SMD implicit solvation model as implemented in Gaussian 09.

Bispyridinium compounds are generally known to exhibit closed-shell singlet structures when doubly reduced. However, when conjugation is increased, population of thermally-accessible triplet diradical states is thought to occur. The accessibility of these triplet diradical states can be predicted using the difference in Gibbs free energy of the corresponding singlet and triplet states, the ‘singlet-triplet energy gap’ E_{ST}.

E_{ST} for compounds 10, 11, 12, 13, 17, and 18 ranged from E_{ST}=−27.9 kcal mol⁻¹ to −8.0 kcal mol⁻¹ (FIG. 2e), with more negative values being indicative of a greater propensity to form closed shell structures. The compounds all exhibited an E_{ST}<−6.0 kcal mol⁻¹ (10, 11, 12, 13, 17, 18). For these compounds the voltammetry indicated reversible redox processes. Homocyclic-core electrolytes exhibited more negative potentials than heterocyclic-core electrolytes. More conjugated molecules exhibiting more negative potentials than less conjugated molecules also.

E_{ST} for compounds 15 and 16 are −5.4 kcal mol⁻¹ and −1.6 kcal mol⁻¹ respectively (FIG. 2e). The higher E_{ST} of −6.0 kcal mol⁻¹<E_{ST}<0 kcal mol⁻¹ are thought to result in a loss of redox reversibility when tested using cyclovoltammetry (CV). Without wishing to be bound by theory, this is thought to be a result of diradical species generation and subsequent participation in parasitic side reactions (e.g. proton or halide abstraction, σ-dimerisation, and cyclisation). These parasitic side reactions are magnified in CV experiments, because the redox activity occurs are the electrode surface—causing a high local concentration of diradical species around the electrode which can participate in parasitic side reactions. It is thought that the compounds with an E_{ST} of −6.0 kcal mol⁻¹<E_{ST}<0 kcal mol⁻¹ would show redox reversibility when cycled in a RFB as the redox occurs in the bulk electrolyte solution (opposed to only at the electrode surface), therefore the local concentration of diradical species is lower and side reactions are reduced. It is also thought that redox reversibility can be enhanced by cycling the compounds at lower temperatures. At lower temperatures, the triplet diradical state is less populated, lowering the diradical concentration and supressing side reactions.

E_{ST} for comparative compounds 14 and 19 are 3.6 kcal mol⁻¹ and 2.3 kcal mol⁻¹ respectively (see FIG. 2e). At these yet higher E_{ST}>0 kcal mol⁻¹, compounds are thought to adopt non-Kekule (or open shelled) doubly reduced structures, and thus have ground state triplet diradicals. Notably, the first and second redox events for compounds 14 and 19 are very close together (see FIG. 2e) so that immediately after they are reduced they form the double reduced open shell state. As a result, comparative compounds 14 and 19 have irreversible redox properties.

E_{ST} values also correlated with the degree of separation between first and second redox events, with more negative E_{ST} values corresponding to wider gaps between redox events.

### Electrochemical Characterization: Dioxygen-Free Electrolyte

### Cyclic Voltammetry

Cyclic voltammetry experiments were carried out at 25° C. in N₂ purged 0.1 M NaCl aqueous solutions with a Metrohm Eco Chemie Autolab PGSTAT12 potentiostat, working on GPES 4.9 software. A three-electrode configuration was used with a 3 mm or 1.6 mm glassy carbon working electrode, a platinum counter electrode, and RE-5B Ag/AgCl BASI reference electrode. The glassy carbon electrode was polished before each measurement using a 0.05 μm alumina-H₂O slurry on a polishing cloth. CV was performed at 1 mM concentrations of the respective compound using a scan rate of 20 mV s⁻¹.

By cyclic voltammetry (CV), compounds 10, 11, 12, 13, 17, and 18 exhibited reversible potentials spanning −0.35 to −0.82 V vs standard hydrogen electrode (SHE) for the first reduction (see FIGS. 2d). Compounds 10, 11, and 17 exhibited reversible potentials of −0.35 V & −0.68 V, −0.76 V, and −0.56 V & −0.67 V respectively. Notably, however, compounds 12 and 13 possessed first redox potentials of −0.77 V and −0.82 V respectively—which are very negative and thought to be the most negative first redox potential for any pyridinium RFB electrolytes featuring unsubstituted cores to date.

It is thought that the viologen derivatives where the doubly reduced structure can adopt a Kekule structure (e.g. 12, 13) are more likely to have a reversible potential. It is also thought that compounds exhibiting lesser degrees of conjugation have a more reversible redox potential.

Compounds 15 and 16 show a similarly negative first reduction potential to 12 and 13, however as discussed above under CV conditions the redox of 15 and 16 are electrochemically irreversible due to the small negative E_{ST}. It is thought that cycling in a redox flow cell and/or at lower temperatures would result in reversible redox for compound 15 and 16.

In contrast, comparative compounds 14 and 19 does not have a reversible potential, thought to be due to the positive E_{ST}.

### In-Situ NMR and EPR of RFB

A flow battery was purchased from Scribner Associates. Ultrahigh-purity sealed graphite flow plates with serpentine flow patterns were used for both electrodes. Each electrode comprised carbon felt (SGL) with a 5 cm² active area. An anion exchange membrane (120 μm thickness, <10 Å pore size, Selemion, Japan) was placed between the two electrodes. PTFE frames with a thickness of 3 mm were used to position the electrodes with Viton gaskets 0.7 mm in thickness on each side of the frames. The current collectors were gold-plated copper plates. Anodised aluminium end plates with reactant input/output ports were used. A Masterflex L/S peristaltic pump (Cole-Parmer, Vernon Hills, IL) was used to circulate the electrolytes through the electrodes at a flow rate of 40 r.p.m. (ca. 20 mL min-). Custom-made glassware made from Pyrex with gas inlet, outlet, liquid inlet and outlet were used as electrolyte reservoirs.

In-situ NMR and EPR characterization was carried out using a flow battery as described above, two peristaltic pumps, an electrochemical cycler (SP-150, BioLogic SAS), a benchtop EPR (MS5000, Magnettech), and an NMR (300 MHz, Bruker Avance III) spectrometer. The battery and the EPR spectrometer were positioned outside the 5 G line of the NMR magnet. The electrolyte was pumped through the flow battery, then flowed through the EPR and NMR magnets, and finally back to the electrolyte reservoir. The direction of flow is from the bottom to the top of both magnets. PFA tubes ( 1/16 in.) are used to connect the electrolyte reservoir, the battery, and the EPR and NMR sampling tubes.

In the anolyte reservoir, the flow cell employed 30 mL of 0.01 M test compound in 0.1 M NaCl deuterated aqueous solution unless otherwise stated. In the catholyte reservoir, the flow cell employed 50 mL of a 0.02 M 4-hydroxy-TEMPO in 0.1 M NaCl deuterated aqueous solution unless otherwise stated. Both reservoirs were purged with N₂, degassed for 1 h and then kept under active N₂ flow during cycling. The flow cell was galvanostatically charged and discharged five times at room temperature on a portable electrochemical cycler at current of 10 mA.

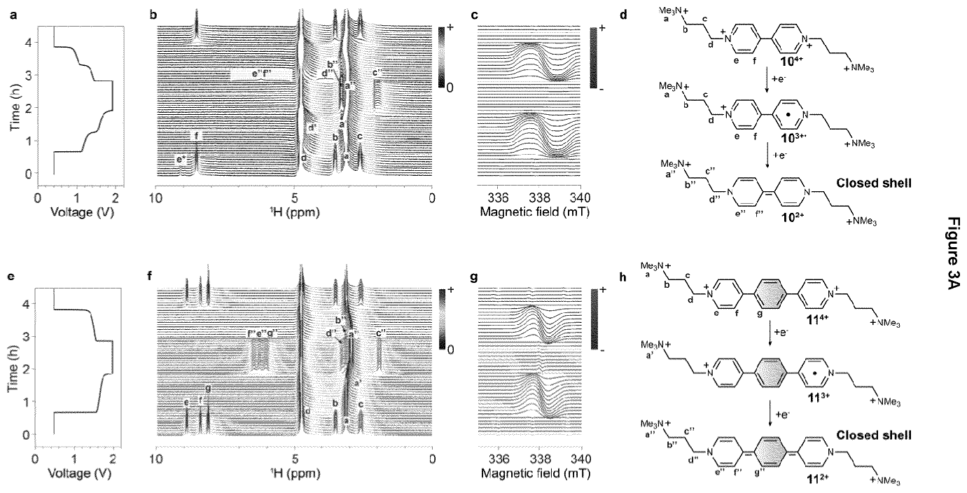

For compounds 10, 11 and 13, in situ NMR and EPR spectra were acquired while a full cell consisting of a 10 mM viologen and 20 mM 4-hydroxy-TEMPO both in D₂O was galvanostatically cycled for five full charge-discharge cycles. The second charge-discharge cycle is shown in FIG. 3. Voltage of a 10 mM (a) 10, I 11, (i) 13 in 100 mM NaCl and 20 mM 4-hydroxy-TEMPO in 100 mM NaCl full cell as a function of time for one full charge-discharge cycle. Cutoff voltages of 0.5 V (10, 11 & 13), 1.90 V (10), 1.95 V (11) and 2.00 V (13) were used with 1 h potential holds being applied at the respective cutoff values. NMR are shown in FIG. 3 (b,f,j) and EPR in FIG. 3 (c,g,k). The spectra were collected over the charge-discharge cycle. The oxidation states of 10, 11 and 13 and their respective NMR proton assignments are shown in (d,h,l). Chloride counterions are omitted for clarity. The proton assignment e* indicates that proton e undergoes fast hydrogen-deuterium exchange, reducing its intensity and limiting observation by NMR.

On charging the full cell containing compound 10, plateaus corresponding to the two well-separated single-electron redox events were observed. For compounds 11 and 13, redox events are sufficiently narrowly spaced such that single charge and discharge plateaus were observed in each case. Starting at 0.50 V vs. 4-hydroxy-TEMPO, protons assigned to both the aliphatic and aromatic parts of the unreduced 10⁴⁺, 11⁴⁺, and 13⁴⁺ ions were visible by NMR, with low degrees of signal intensity for proton e of 10⁴⁺ occurring as a result of near-complete hydrogen-deuterium exchange within the first charge-discharge cycle.

Above 0.50 V, all signals with the exception of a (the terminal quaternary amine protons) disappeared almost immediately with the concomitant emergence of EPR resonances, which are assigned to the radicals 10^{3+⋅}, 11^{3+⋅}, and 13^{3+⋅}.

At high states of charge (1.90 V, 1.95 V, or 2.00 V for 10, 11, or 13, respectively), the potential was held constant for 1 h.

During this period, new resonances appeared in the NMR spectra for compounds 10 and 11 that were shifted substantially to lower frequencies relative to those observed at low states of charge. These features were assigned to the diamagnetic, doubly reduced species 10²⁺ and 11²⁺. For 10²⁺, substantial broadening of all resonances was observed, suggesting the presence of residual levels of radicals that exist in equilibrium with closed shell ion 10²⁺.

For compound 13 no new resonances were observed during the potential hold. Instead, all NMR resonances were broadened substantially, including a″. Additionally, no radical species were observed by EPR. As the E_{ST} for 13 is small, population of paramagnetic thermally-accessible triplet states may be responsible for the dramatic NMR line broadening observed. That no triplet diradical is directly observed by EPR suggests fast singlet-triplet interconversion on experimental timescales, or low radical concentrations, either intrinsically or as a result of spin pairing of triplet diradicals to form EPR-silent dimers.

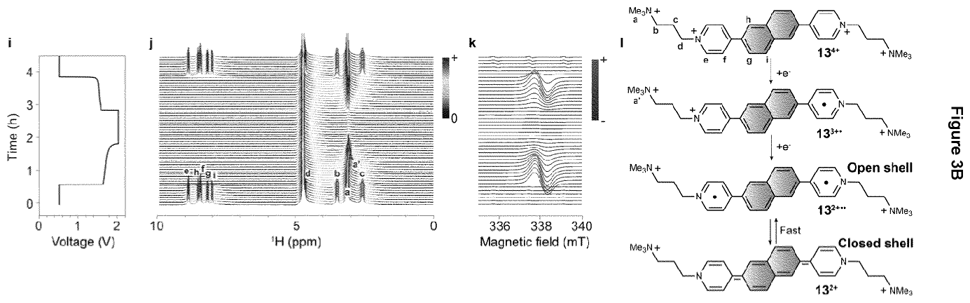

For compounds 17 and 18, in situ NMR and EPR spectra were acquired while a full cell including 10 mM viologen and 20 mM 4-hydroxy-TEMPO both in D₂O was galvanostatically cycled for five full charge-discharge cycles, the second of which is shown in FIG. 4. Voltage of a 10 mM (a) 17, I 18 in 100 mM NaCl and 20 mM 4-hydroxy-TEMPO in 100 mM NaCl full cell as a function of time for one full charge-discharge cycle. A current of 2 mA cm⁻² was used. Cutoff voltages of 0.5 V (17 & 18), 1.75 V (17), and 1.85 V (18) were used with 1 h potential holds being applied at the respective cutoff values. NMR (b,f) and EPR (c,g) spectra collected over the charge-discharge cycle. (d,h) Oxidation states of 17 and 18 and their respective NMR proton assignments are shown. Chloride counterions are omitted for clarity.

Analogous NMR and EPR characteristics for heteroatom-based compounds 17 (wide E_{ST}) and 18 (narrow E_{ST}) (FIG. 4) suggest that these phenomena are general and give rise to two distinct regimes of electrochemical performance delineated by E_{ST}.

For variable concentration experiments, currents of 1 mA, 5 mA, and 10 mA were used for 1 mM, 5 mM, and 10 mM concentrations respectively.

For compound 11, in situ NMR and EPR results spectra were acquired for a full cell including of 1 mM of violgen in 100 mM NaCl and 2 mM 4-hydroxy-TEMPO in 100 mM NaCl full cell as a function of time for one full charge-discharge cycle. A current of 0.2 mA cm⁻² was used. Cutoff voltages of 0.5 V and 1.95 V were used with 1 h potential holds being applied at the respective cutoff values.

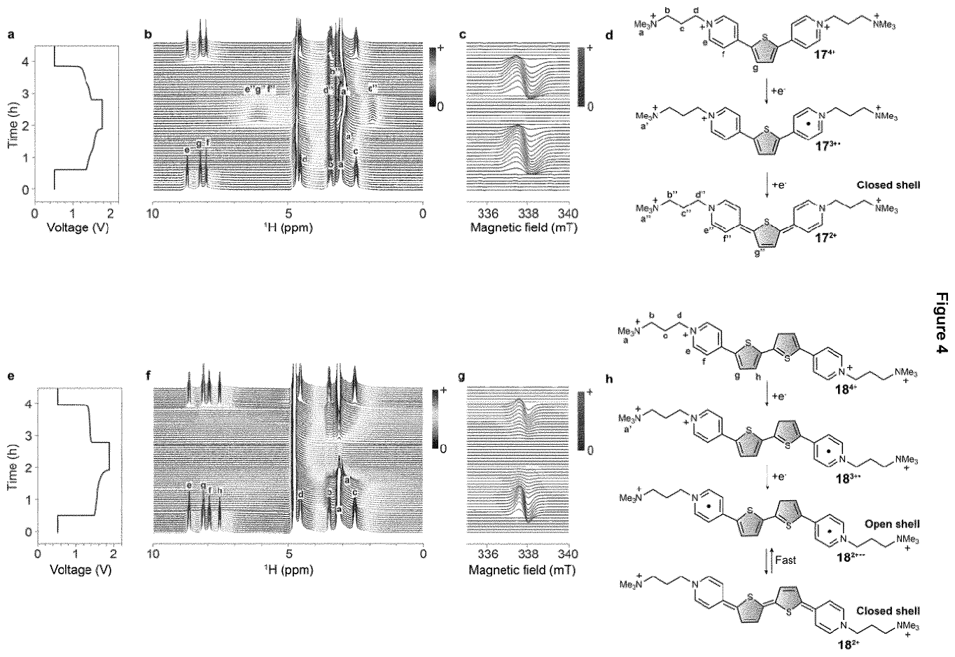

Results are shown in FIG. 5. NMR (b) and EPR (c) spectra collected over the charge-discharge cycle. EPR spectral features indicate the presence of ultra-trace quantities of 4-OH-TEMPO crossover. (d) Structure of 11 and its respective NMR proton assignments.

### Cycling Data

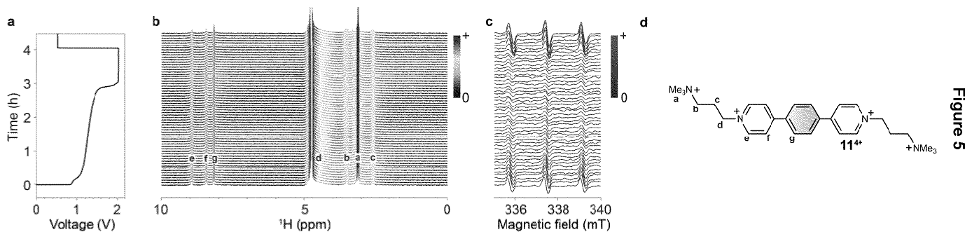

Galvanostatic cell cycling was carried out using the procedure described above from the in situ NMR/EPR studies. Voltage versus discharge capacity was measured over five full charge-discharge cycles for 10 mM compound 17 (FIG. 6a) and 18 (FIG. 6b) in 100 mM NaCl and 20 mM 4-hydroxy-TEMPO in 100 mM NaCl full cells. A current of 2 mA cm⁻² was used in all cases. Cutoff voltages of 0.5 V (17 and 18), 1.75 V (17) and 1.85 V (18) were used with 1 h potential holds being applied at the respective cutoff values.

Compound 17 and 18 are shown to have a relatively flat voltage profile throughout their discharge (see FIG. 6). This flat voltage profile is advantageous for energy storage applications and omits the need for additional circuitry to increase/decrease voltage or for systems that are tolerant of variable input voltages.

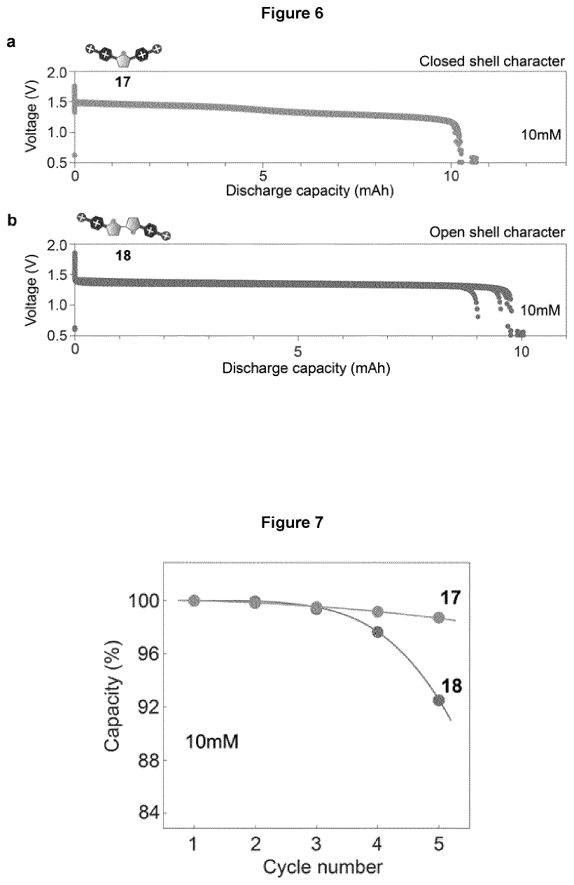

Discharge capacity of compounds 17 and 18 are shown to be relatively constant over their first three cycles (see FIG. 7). Compound 18 has a capacity of retention of about 92% over the first five cycles. Compound 17 has an excellent capacity retention of about 99% over the first five cycles. It is thought that the closed shell character of compound 17 results in improved capacity retention.

Coulombic efficiencies for compounds 17 and 18 were also measured at 78.6±0.3 and 79.7±2.8 respectively.

As the E_{ST} for 18 is less negative than for compound 17, it is thought that compound 18 has a higher population of paramagnetic thermally-accessible triplet states, which may be responsible for slightly poorer capacity retention of 18.

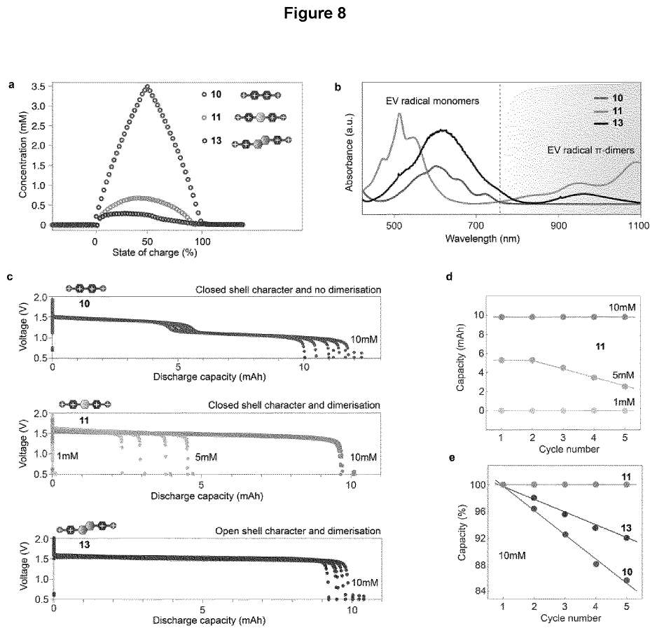

Further cycling data was measured for compounds 10, 11, and 13, which is shown in FIG. 8.

FIG. 8a shows radical concentration profiles for 10, 11, and 13 during charge derived from spin counting based on the EPR data shown in FIG. 3 (and discussed above).

FIG. 8b shows spectroelectrochemical data for 10, 11, and 13 at a concentration of 1 mM. Bands assigned to singly-reduced and π-dimeric species are labelled. UV-Vis Spectroelectro Chemical studies were carried out for compounds 10, 11, and 13. Degassed solutions of 10⁴⁺ (0.5 mM), 11⁴⁺ (0.5 mM), and 13⁴⁺ (0.5 mM) were prepared using the Schlenk technique. The solutions were transferred into quartz cuvettes (10 mm path length) under N₂ and the cuvettes and kept under a positive flow of N₂. The samples were electrochemically reduced using a carbon paper working electrode and a gold counter electrode. Spectral data were acquired using a UV/Vis spectrometer (Horiba, Duetta) immediately after the solutions were transferred into the cuvettes and electrochemically reduced.

FIG. 8c shows voltage versus discharge capacity over five full charge-discharge cycles for 10 mM 10, 11 and 13 in 100 mM NaCl and 20 mM 4-hydroxy-TEMPO in 100 mM NaCl full cells. A current of 2 mA cm⁻² was used in all cases. For compound 11, voltage versus discharge capacity data over five full charge-discharge cycles for 5 mM and 1 mM 11 full cells are overlaid. The 5 mM 11 in 100 mM NaCl and 10 mM 4-hydroxy-TEMPO in 100 mM NaCl full cell was cycled at a current of 1 mA cm⁻². The 1 mM 11 in 100 mM NaCl and 2 mM 4-hydroxy-TEMPO in 100 mM NaCl full cell was cycled at a current of 0.2 mA cm⁻². Cutoff voltages of 0.5 V (10, 11 & 13), 1.90 V (10), 1.95 V (11) and 2.00 V (13) were used with 1 h potential holds being applied at the respective cutoff values.

FIG. 8d shows the discharge capacity versus cycle number for 11 at 10 mM, 5 mM and 1 mM concentrations.

FIG. 8e shows the normalised discharge capacity versus cycle number for 10, 11, and 13 at 10 mM concentrations

### Dimerisation Study

### In Situ DOSY NMR

Pseudo-2D NMR experiments were performed on the flowing electrolyte solution by direct excitation with a 90° radiofrequency pulse. Each NMR spectrum is acquired by collecting eight free induction decays with a recycle delay of 15 s. The pulse width for a 90° pulse was 27 μs at 30 W. All spectra were referenced to the water chemical shift at 4.79 ppm. NMR data were processed using TopSpin 3.6.3 (Bruker). EPR data were processed using EasySpin version 5.2.30. Electrochemical data were processed using EC-lab 11.36 (BioLogic).

The flow was stopped during the acquisition period (12 min) to carry out the DOSY NMR.

In situ DOSY NMR experiments carried out for 10, 11, and 13 at 0%, 50%, and 100% SOC (Table 1). This indicated a general decrease in diffusivity (D) from 0-100% SOC, especially for compounds 11 and 13, which exhibit low radical concentrations at all SOCs. These results suggest an increase in size of the cations upon mono-radical generation, consistent with the formation of dimers which have double the molecular weight of the monomer (a decrease in diffusivity is attributable to an increase in molecular weight).

Compound 10 produces a much smaller decrease in diffusivity, indicating that no or very little dimer is formed upon mono-radical generation.

TABLE 1
Summary of bispyridinium diffusivities at
various SOCs derived from in situ DOSY NMR

| | D at 0% SOC | D at 50% SOC | D at 100% SOC |
|---|---|---|---|
| Compound | (×10⁻¹⁰ m² s⁻¹) | (×10⁻¹⁰ m² s⁻¹) | (×10⁻¹⁰ m² s⁻¹) |
| 10 | 3.6 ± 0.1 | 3.6 ± 0.2 | 3.4 ± 0.1 |
| 11 | 3.1 ± 0.1 | 2.4 ± 0.2 | 1.6 ± 0.1 |
| 13 | 2.8 ± 0.1 | 1.9 ± 0.2 | 2.1 ± 0.5 |

The presence of dimers could not be determined directly (as a result of both high radical concentrations, affecting observation by NMR, and the known EPR silence of viologen π-dimers affecting observation by EPR).

### EPR and CV Modelling Studies

An analysis of compounds 10, 11, and 13 associated redox equilibria was carried out. Expressing the two single electron reductions as a comproportionation equilibrium with an equilibrium constant of comproportionation, K_{c}, an equation for radical fraction as a function of battery SOC was obtained.

The difference between redox events is related to the comproportionation equilibrium constant K_{c} by:

$${E}_{1} - {E}_{2} = \frac{R T ln ( {K}_{c} )}{F}$$

For the compounds comproportionation equilibrium:

$${V}^{4 +} + {V}^{2 +} ⇌ 2 {V}^{3 +} , {K}_{c} = \frac{{[ {V}^{3 +} ]}^{2}}{[ {V}^{2 +} ] [ {V}^{4 +} ]}$$

fits to experimental radical concentration data were obtained by:

$${K}_{c} \neq 4$$

$$x = \frac{{K}_{c} \pm \sqrt{{K}_{c}^{2} - ( {K}_{c} - 4 ) ( 2 n - {n}^{2} ) {K}_{c}}}{{K}_{c} - 4}$$

$${K}_{c} = 4$$

$$x = n - \frac{1}{2} {n}^{2}$$

Where n is the number of electrons that have been removed from the system, starting from 100% SOC and x is the fraction of radicals.

For π-dimerisation equilibria, K_{d} values were estimated as follows. At 50% SOC, 1 electron equivalent of the starting concentration of viologen, V₀, has been added to create reduced species, thus giving the previous result:

$$2 {{K}_{d} [ {V}^{3 +} ]}^{2} + [ {V}^{3 +} ] - 2 \frac{[ {V}^{3 +} ]}{\sqrt{{K}_{c}}} - [ {V}_{0} ] = 0$$

As the initial concentration (V₀), K_{c} and the radical concentration (V³⁺·) at this state of charge is known, the dimerisation constant can be calculated with:

$${K}_{d} = \frac{( [ {V}_{0} ] + 2 \frac{[ {V}^{3 +} ]}{\sqrt{{K}_{c}}} - [ {V}^{3 +} ] )}{{2 [ {V}^{3 +} ]}^{2}}$$

This equation was used to fit experimental radical fraction data obtained by the EPR-based method of spin counting, from which the observed comproportionation equilibrium constant K_{c,obs} was extracted. Upon fitting, K_{c,obs} values of 0.75, 0.021 and 0.0021 were found for 10, 11, and 13, respectively (Table 2). However, fits based on EPR-data were modest at best and deviated substantially from experimental data especially for compound 13, suggesting the presence of other phenomena not accounted for by the simple comproportionation model.

The equation was also used for CV curve fitting, from which much better agreement with experimental data was obtained. Relating the difference in first and second redox events obtained by CV curve fitting to K_{c}, ‘true’ K_{c} values could be estimated and compared to K_{c,obs} values. Respective Ko values for 10, 11, and 13 were 3.2×10⁵, 1.3 and 2.9 (see Table 2)—substantially higher than the K_{c,obs} values. This discrepancy indicates that besides comproportionation, additional reaction equilibria likely exist that result in lower observed radical fractions. The strongest candidates for these are dimerisation equilibria.

Extracting the K_{c} value from the radical concentration for 10, 11 and 13, gives an average K_{c} of 0.7, 0.2 and 0.002, respectively. The notably low values of 13 are also unreliable, as there is a large asymmetry in the radical concentration as a function of SOC meaning that some assumptions are likely being violated.

TABLE 2
Summary of bispyridinium equilibrium
data and Coulombic efficiencies

| Com- | K_{c, obs} from | K_{c} from | K_{d} | E_{ST} (kcal | Coulombic |
|---|---|---|---|---|---|
| pound | EPR | CV | (mM⁻¹) | mol⁻¹) | efficiency (%) |
| 10 | 0.75 | 3.2 × 10⁵ | 0.28 | −27.9 | 80.5 ± 0.3 |
| 11 | 0.021 | 1.3 | 11 | −12.3 | 76.8 ± 0.3 |
| 13 | 0.0021 | 2.9 | 76 | −8.0 | 74.2 ± 2.7 |

### Capacity Fade Rates and Coulombic Efficiencies

Capacity fade rates and Coulombic efficiencies were calculated for 10, 11, 13, 17, and 18 based on the five full charge-discharge cycles (see FIGS. 7 and 8 and Galvanostatic cycling data section) and compared to respective values of K_{c}, K_{d} and E_{ST} (see Table 2 and EPR and CV modelling studies). For all compounds, while Coulombic efficiencies fell within a narrow range (74%-81%), values for capacity fade revealed a series of trends.

First, extended viologens with lower E_{ST} values (e.g. compounds 13, 18) exhibited significantly higher degrees of capacity fade relative to those with higher E_{ST} values (e.g. compounds 11, 17). Together with NMR and EPR findings this is through to suggest the presence of two distinct regimes of electrochemical performance. It is also thought to indicate that thermally accessible triplet species are tied to parasitic processes—possibly similar in nature to those observed by CV for compounds 14, 15, 16 and 19 (FIG. 2 and Cyclic Voltammetry).

Second, among compounds with a higher E_{ST} (e.g. compound 10, 11, 17), those that exhibit high radical concentrations (e.g. compound 10) at all states of charge also exhibit greater degrees of capacity fade (FIGS. 8a, 8c 8e and Galvanostatic cycling data). Collectively, these results suggest that capacity fade in bispyridinium compounds is primarily linked to the formation of open shell structures—either monoradicals or diradicals. Thus, processes that lower radical concentrations at all SOCs (low K_{c}, high K_{d}, and high E_{ST}) should correlate with improved capacity retention. While low K_{c} and high E_{ST} processes give rise to closed shell structures, high K_{d} processes retain monoradicals as spin-paired π-dimers, which are currently thought to contribute directly to capacity fade.

As π-dimerisation is a concentration-dependent process favouring higher degrees of dimerisation at higher monoradical concentrations, an additional set of RFB runs was carried out for compound 11 (i.e. a high K_{d} compound) at concentrations of 1 mM, 5 mM, and 10 mM to determine the extent to which π-dimerisation contributes to capacity fade (FIG. 8d). As the concentration of 11 increased, corresponding to higher degrees of π-dimerisation, both capacity retention and Coulombic efficiencies increased. At 10 mM, Coulombic efficiencies of 77% were observed. These dropped slightly to 74% at 5 mM and then dramatically to 18% at 1 mM. Concomitant with this, at 10 mM capacity fade rates of 0.01% per cycle were obtained, while at 5 mM they rose sharply to 9.64% per cycle. Even at a Coulomic efficiency of 77%, capacity fade is minimal, whereas at 74%, corresponding to half the concentration (5 mM), it is substantial. At concentrations of 1 mM, consistent with low degrees of π-dimerisation, however, a completely different set of charge-discharge characteristics was observed. Instead of charging processes corresponding to reduction of 11, a new set of processes with an onset voltage of 0.82 V vs. 4-hydroxy-TEMPO emerged (FIG. 5). These processes proceeded over much longer timescales than those characteristic of viologen charging, and resulted in both an accumulation of hydroxide increasing the pH from 7 to 12, and an almost complete loss of system capacity within the first charge-discharge cycle, with no evidence for chemical degradation from in situ NMR or EPR.

### Electrochemical Characterization: Dioxygen Exposed Electrolyte

### In Situ Mass Spectrometry

Online electrochemical mass spectrometry (OEMS) experiments were performed using a custom-made H-cell, connected to gas flow system previously described Zhao et al., using 1% dioxygen in argon at 1.2 bar.

In situ online electrochemical mass spectrometry of a 1 mM 11 in 100 mM NaCl and 2 mM 4-hydroxy-TEMPO in 100 mM NaCl full cell during one full charge discharge cycle in an atmosphere of 1% O₂ in Ar. A current density of 0.2 mA was used. A potential hold of 2 h was applied at 1.95 V after 8 h of charging.

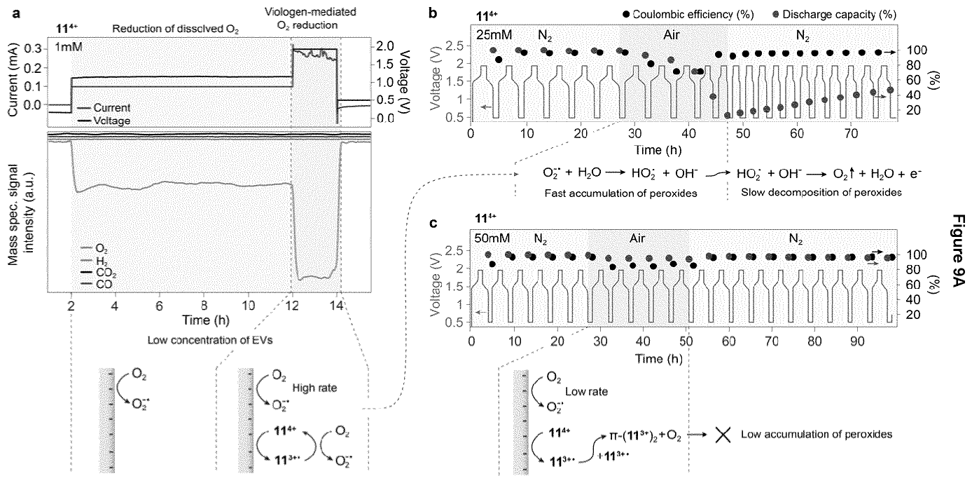

This revealed a sharp steady-state decrease in dioxygen partial pressure in the headspace above the electrolyte solution during charging under a continuous flow of 1% O₂ in Ar (FIG. 9a). This dioxygen consumption became substantially more pronounced once the viologen reduction potential had been reached. At no stage during operation was any change detected in the hydrogen partial pressure, despite operating at cell voltages outside the thermodynamic stability window of water (1.23 V). Collectively, these results suggest that the increases in pH during cycling are tied to consumption of gaseous dioxygen, not water splitting, and that reduced viologen species facilitate this process. On the basis of these findings, the two-electron direct reduction of trace dissolved dioxygen via the peroxide pathway to form hydroxide anions is proposed as a parasitic process (E=−0.065 V vs. SHE; 0.87 V vs. 4-hydroxy-TEMPO)—for which reduced forms of 11 (such as 11^{3+⋅}) serve as a redox mediator.

At higher concentrations, the usual viologen redox behaviour was recovered with no additional evidence for charge plateaus corresponding to other processes, but with similar increases in pH being observed. This suggests that oxygen reduction (whether direct or viologen-mediated) still occurs. It is thought that the onset of dimerisation typically occurs at around 0.1 mM in water and π-dimerisation favours higher degrees of association at higher concentrations of corresponding monoradical, so it was hypothesised that higher degrees of π-dimerisation, and hence K_{d}, may play a role in mitigating competing side reactions between monoradical species and trace impurities such as oxygen during operation.

OEMS experiments were also performed using 50 mM H-cells subjected to a 2 h potential hold at 1.95 V under atmospheres of 1% O₂ in Ar and 20% O₂ in Ar respectively, relative to that of the 1 mM H-cell described above. A current of 1.55 mA was used in both cases. The normalised dioxygen consumption is shown in FIG. 9d. The dioxygen consumption at 50 mM concentration is significantly lower than at 1 mM. The dioxygen consumption at 50 mM concentration is only slightly increased in the presence of 20% dioxygen (partial pressure in argon) compared to 1% dioxygen. This revealed dioxygen consumption per mole of 11 to be substantially lower in the 50 mM case than in the 1 mM case. This suggests the dimerised electrolyte species (which is more prevalent at higher concentrations) is tolerant to the presence of dioxygen, even up to atmospheric partial pressures.

### Galvanostatic Cycling in Air

Flow cells were assembled as described above. For the 25 mM test, full cells were assembled from 25 mM 11 in 500 mM NaCl (30 mL) and 50 mM 4-hydroxy-TEMPO in 500 mM NaCl (50 mL). For the 50 mM test, full cells were assembled from 50 mM 11 in 500 mM NaCl (15 mL) and 100 mM 4-hydroxy-TEMPO in 500 mM NaCl (25 mL). A current of 5 mA cm⁻² was used in both tests. Both reservoirs were purged with N₂, degassed for 1 h and then kept under active N₂ flow during cycling. The flow cell was galvanostatically charged and discharged at room temperature using a portable potentiostat. The cycling sequence consisted of six full charge and discharge cycles, after which the N₂ was disconnected and the reservoirs opened to air. After 1 h, cells were cycled a further five times in air, at which point the reservoirs were closed, purged with N₂ for 1 h and kept under a positive N₂ flow for ten subsequent cycles under N₂. Electrochemical data were processed using EC-lab 11.36 (BioLogic).

The results are shown in FIGS. 9b and 9c. At these concentrations, cells were galvanostatically cycled at the same current six times under N₂, after which electrolyte solutions were exposed to air for one hour and cycled a further five times in air. In both cases, capacity was stable under N₂. However, upon introduction of air, while capacity fell sharply over five cycles for the 25 mM test, it remained almost unchanged for the 50 mM test, but with slightly decreased Coulombic efficiencies. This suggests, that while parasitic process still exist, π-dimerisation can be used as a competing pathway through which viologen reactivity with dioxygen can be supressed. It is thought that the open shell viologen radical cations transfer electrons to dioxygen regenerating their unreduced states and forming reactive dioxygen species (i.e. peroxides, superoxides, and hydroxyl radicals) as side products (FIG. 9). The latter set of species can also be produced via direct reduction of dioxygen on the electrode. π-dimerisation is thought to be a reversible competing pathway from which viologens can both retain their charge and be further reduced.

The 25 mM and 50 mM systems that were exposed to air were further sparged with N₂ for 1 h and cycled an additional ten times under N₂. Without wishing to be bound by theory, as capacity fade is tied to dioxygen-based parasitic processes, re-introduction of N₂ results in capacity recovery—albeit at a lower rate than that of initial fade, as a result of possible accumulation of peroxide species, which re-introduce dioxygen upon decomposition. In line with the proposed mechanism, at 25 mM capacity recovered steadily over the ten cycles run, with recovery rates being lower than fade rates. At 50 mM, capacity and Coulombic efficiency recovered completely within one cycle providing evidence for robust air tolerance, which may be further improved at RFB-relevant concentrations.

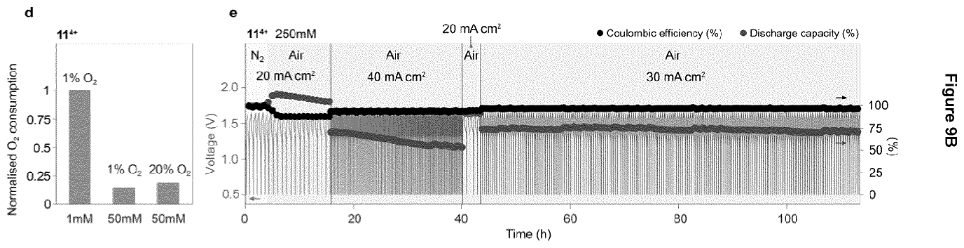

The experiment was repeated with 50 mM of compound 17 in a full RFB cell (FIG. 10). Voltage, normalised discharge capacity and Coulombic efficiency of a 50 mM 17 in 500 mM NaCl and 100 mM 4-hydroxy-TEMPO in 500 mM NaCl full cell cycled 5 times in N₂, 5 times in air, and 8 times in N₂. A current of 5 mA cm⁻² was used.

Capacity remained almost unchanged upon exposure to air, but with slightly decreased Coulombic efficiencies. This supports that while parasitic process still exist, π-dimerisation can be used as a competing pathway through which viologen reactivity with dioxygen can be supressed.

### Additional Cyclic Voltammetry

Cyclic voltammetry experiments were carried out for aqueous solutions of compound 20 and 10 at 25° C. and a concentration of 1 mM in 0.1 M NaCl with a Metrohm Eco Chemie Autolab PGSTAT12 potentiostat, working on GPES 4.9 software. Where the CV was carried out under nitrogen the solution was purged with nitrogen. A three-electrode configuration was used with a 3 mm glassy carbon working electrode, a platinum counter electrode, and RE-5B Ag/AgCl BASI reference electrode. The glassy carbon electrode was polished before each measurement using a 0.05 μm alumina-H₂O slurry on a polishing cloth. CV was performed using a scan rate of 20 mV s⁻¹.

The results for compound 20 and compound 10 are shown in FIG. 12A. Voltammograms for compound 10 under nitrogen (dashed line), 20 under nitrogen (dark blue line) and 20 under air (light blue line) were obtained.

Compound 20 was found to have reversible reduction potentials of −0.147V and −0.386V vs standard hydrogen electrode (SHE), as calculated from the voltammogram.

Notably, the voltammogram obtained for compound 20 under nitrogen (dark blue line) and under air (light blue line) are very similar, with similar reduction potentials. This suggests that compound 20 is highly tolerant to the presence of oxygen in the solution.

### Extended Galvanostatic Cycling Flow Cell Studies at 250 mM

Long term cycling was also tested at much higher electrolyte concentrations (see FIG. 9e and Table 3).

Flow cells were assembled as described above. Full cells were assembled from 250 mM 11 or 17 (12.5 mL) and 250 mM 4-hydroxy-TEMPO in 1 M NaCl (50 mL). Currents of 20 mA cm⁻² (at a flow rate of 40 r.p.m.), 30 mA cm⁻² (at a flow rate of 60 r.p.m.), and 40 mA cm⁻² (at a flow rate of 80 r.p.m.) were used in both cases. Both reservoirs were purged with N₂, degassed for 1 h and then kept under active N₂ flow during cycling for the first five cycles, after which the nitrogen flow was disconnected and the reservoirs opened to air. The flow cells were galvanostatically charged and discharged at room temperature using a portable potentiostat. Electrochemical data were processed using EC-lab 11.36 (BioLogic).

For compound 11 voltage, normalised discharge capacity and Coulombic efficiency measured for 250 mM of compound 11 and 250 mM 4-hydroxy-TEMPO in 1 M NaCl full cell cycled 5 times in N₂ at a current density of 20 mA cm⁻² (see FIG. 9e and Table 3). The cell was cycled 15 times in air at a current density of 20 mA cm⁻², 111 times in air at a current density of 40 mA cm⁻², 5 times in air at a current density of 20 mA cm⁻², and 200 times in air at a current density of 30 mA cm⁻². Cutoff voltages of 0.5 V and 1.65 V were used.

For cycling of compound 17, voltage, normalised discharge capacity and Coulombic efficiency of a 250 mM 17 and 250 mM 4-hydroxy-TEMPO in 1 M NaCl full cell cycled 5 times in N₂ at a current density of 20 mA cm⁻², 15 times in air at a current density of 20 mA cm⁻², 67 times in air at a current density of 40 mA cm⁻², 5 times in air at a current density of 20 mA cm⁻², and 100 times in air at a current density of 30 mA cm⁻². Cutoff voltages of 0.5 V and 1.60 V were used.

TABLE 3
Summary of extended galvanostatic
cycling performance for 11 and 17

| | Discharge | Discharge | |
|---|---|---|---|
| | capacity | capacity | Coulombic |
| | fade rate | fade rate | efficiency |
| | (% day⁻¹) | (% cycle⁻¹) | (%) |
| 250 mM 11 | | | |
| 5 N₂ - 20 mA cm⁻² | +1.328 | +0.039 | 98.87 ± 0.90 |
| 15 air - 20 mA cm⁻² | −17.928 | −0.602 | 87.53 ± 0.13 |
| 111 air - 40 mA cm⁻² | −23.760 | −0.219 | 93.62 ± 0.46 |
| 5 air - 20 mA cm⁻² | −1.476 | −0.040 | 94.52 ± 0.50 |
| 200 air - 30 mA cm⁻² | −1.411 | −0.021 | 96.64 ± 0.31 |
| 250 mM 17 | | | |
| 5 N₂ - 20 mA cm⁻² | −16.355 | −0.828 | 97.55 ± 0.18 |
| 15 air - 20 mA cm⁻² | −1.690 | −0.082 | 96.49 ± 0.71 |
| 67 air - 40 mA cm⁻² | +7.032 | +0.090 | 98.59 ± 2.87 |
| 5 air - 20 mA cm⁻² | −7.172 | −0.295 | 96.78 ± 0.69 |
| 100 air - 30 mA cm⁻² | −9.079 | −0.356 | 97.89 ± 1.17 |

For compound 11 (see FIG. 9e and Table 3) while during the first 130 cycles, an initial jump in capacity of 12.337% was observed upon exposure to air, a slow temporal fade followed that increased slightly with current. Towards the end of this step, however, fade slowed and in the following 255 cycles stabilised and reached values of 1.411% per day (0.021% per cycle, Table 3) at 30 mA cm⁻². Additionally, no substantial losses in capacity were observed when switching to and from 20 mA cm⁻² even after 111 cycles at 40 mA cm⁻² in-between, demonstrating the ability of the system to handle variable power demands as required in real RFB applications.

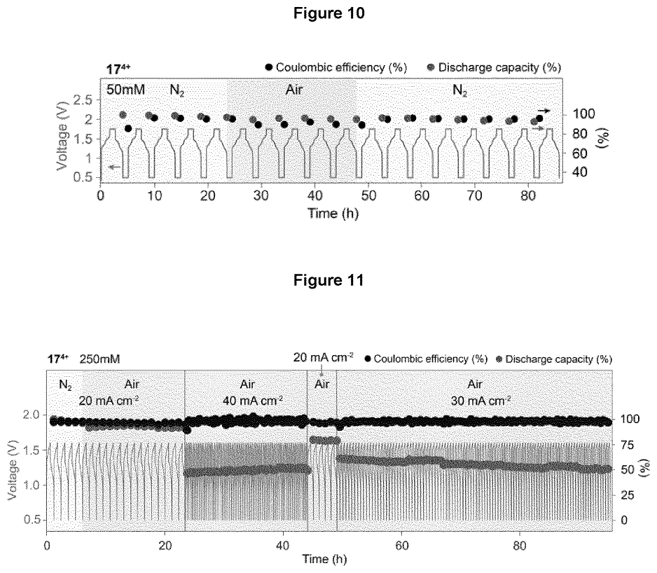

Similar results were obtained for compound 17 demonstrating generality of these performance characteristics (see FIG. 11 and Table 3).

It is thought that π-dimerisation affords added stability to dioxygen enabling suppression of viologen-mediated reduction mechanisms, but not direct reduction mechanisms. The cycling described above at 25 mM and 50 mM required re-introduction of an inert atmosphere to prevent peroxide accumulation. However, rates of electron transfer to compounds 11 and 17 (k_{0,11}=1.98×10⁻² cm s⁻¹, k_{0,17}=2.8×10⁻³ cm s⁻¹) compare favourably with similar rates for electron transfer to dioxygen (k_{0,O2}=8.4×10⁻⁴ cm s⁻¹). Thus, at sufficiently high currents as used in these tests, electron transfer to bispyridinium compounds is thought to be kinetically favoured. Coupled with the suppression of viologen-mediated reduction pathways through π-dimerisation, at such currents bispyridinium compounds should be preferentially reduced, and the effect of any dioxygen (trace or otherwise) should be rendered negligible—potentially eliminating the need for periodic purging with inert gas.

For comparison, Beh et al. describes cycling an unextended viologen electrolyte (corresponding to compound 10) at a similar current density of 40 mA cm⁻² with dioxygen in the headspace, which results in a very fast drop in discharge capacity and poor columbic efficiency (see Figure S5 of Beh et al.).

Collectively, these results evidence the role of π-dimerisation in capacity fade mechanisms and new dimer-mediated air stability, as well as for recovering capacity once initially lost. This suggests dimerisation is broadly applicable to organic redox flow electrolytes.

Typically, it may be suggestive that a RFB is cycled in the absence of oxygen if the initial coulombic efficiency is 96% or more. In known systems, where oxygen is present the initial coulombic efficiency is typically less than 96% as the oxygen present is reduced during initial cell cycling.

### REFERENCES

A number of publications are cited above in order to more fully describe and disclose the invention and the state of the art to which the invention pertains. Full citations for these references are provided below. The entirety of each of these references is incorporated herein.
Beh et al. A neutral pH aqueous organic-organometallic redox flow battery with extremely high capacity retention. ACS Energy Lett. 2, 639-644 (2017).
Bird, C. L., & Kuhn, A. T. Electrochemistry of the viologens. Chem. Soc. Rev. 10, 49-82 (1981).
DeBruler, C., et al. Designer two-electron storage viologen anolyte materials for neutral aqueous organic redox flow batteries. Chem 3, 961-978 (2017)
Hyman Gesser, Applied Chemistry pp. 16 (2002)
Janoschka, T., et al. An aqueous, polymer-based redox-flow battery using non-corrosive, safe, and low-cost materials. Nature 527, 78-81 (2015)
Kwabi, D. G., Ji, Y. & Aziz, M. J. Electrolyte lifetime in aqueous organic redox flow batteries: a critical review. Chem. Rev. 120, 6467-6489 (2020)
Luo et al. A π-conjugation extended viologen as a two-electron storage anolyte for total organic aqueous redox flow batteries. Angew. Chem. Int. Ed. 57, 231-235 (2018)
Nguyen, T. P., et al. Polypeptide organic radical batteries. Nature 593, 61-66 (2021)
Mike L. Perry., et al., ACS Energy Lett. 2022, 7, 2, 659-667
Sullivan et al., Adv. Energy Mater. 2023,13, 2203919
Tang et al. [JACS Au, 2022]
Zhao et al. In situ NMR metrology reveals reaction mechanisms in redox flow batteries. Nature 579, 224-228 (2020)
WO 2021/055275
WO 2023/046710
US 2022/0384834
US 2022/0190374
US 2022/0020990
CN 112500329
WO 2022/236241

1. A redox flow battery comprising an electrolyte, the electrolyte comprising:
an organic redox-active molecule comprising a redox-active unit with two or more heteroarylene groups wherein the two or more heteroarylene groups are conjugated within the redox-active unit, and at least a portion of the redox-active units in the electrolyte are present as a complex formed of a singly reduced form of the redox active unit, and molecular dioxygen (O₂) dissolved in the electrolyte;
where the complex is an intermolecular complex of redox-active units, such as a homodimer, an intramolecular complex of redox-active units, or the complex is a combination of intermolecular and intermolecular complexed redox-active units.

2. The redox flow battery of claim 1 wherein the organic redox-active molecule comprises a redox-active unit of Formula (I-A): 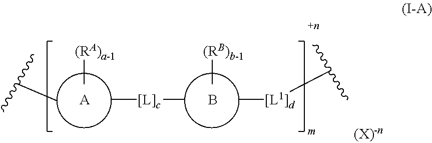
wherein:
-A- and -B- are each independently C₅₋₁₀ arylene;
each -L- is independently selected from C₅₋₁₄ arylene, a bond, C₂₋₆ alkenylene, C₂₋₄ alkynylene, wherein the C₅₋₁₄ arylene and C₂₋₄ alkenylene are optionally substituted with one or more —R^{C} groups;
-L¹- is independently selected from a bond, C₁₋₆ alkylene, C₅₋₁₄ arylene, —N(H)—, and —(CH₂O)ₐ₁—(C₂H₄O)ₐ₂—(C₃H₆O)ₐ₃—(CH₂C(O))ₐ₄—, wherein the C₁₋₆ alkylene and C₅₋₁₄ arylene are optionally substituted with one or more —R^{D} groups, and
a1, a2, a3 and a4 are each independently selected from 0 to 12 and the sum of a1, a2, a3 and a4 is from 1 to 12;
each of —R^{A}, —R^{B}, —R^{C} and —R^{D} where present, is a hydrophilic group;
X is one or more counter anions;
n is from 2 to 4;
a and b are independently from 1 to 5;
c and d are independently from 1 to 5;
two or more of -A-, -B- and -L- are C₅₋₁₀ heteroarylene; and
m is 1 or more.

3. The redox flow battery of claim 2 wherein the organic redox-active molecule is of Formula (I-B): 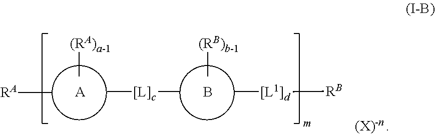
wherein -A-, -B-, -L-, -L¹-, —R^{A}, —R^{B}, —R^{C}, —R^{D}, X, a, b, c, d, n and m are as defined for Formula (I-A).

4. The redox flow battery of any one of claims 2 to 4 wherein -L¹- is independently selected from C₁₋₆ alkylene, C₅₋₁₄ arylene and —(CH₂O)ₐ₁—(C₂H₄O)ₐ₂—(C₃H₆O)ₐ₃—(CH₂C(O))ₐ₄—, preferably C₁₋₆ alkylene and C₅₋₁₄ arylene.

5. The redox flow battery of any one of claims 2 to 5 wherein d is from 1 to 4, preferably 1 to 3, more preferably 1 or 2.

6. The redox flow battery of claim 2 or claim 3 wherein the organic redox-active molecule is of Formula (I): 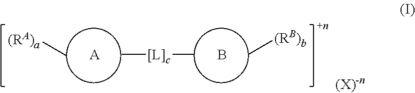
wherein:
-A- and -B- are each independently C₅₋₁₀ arylene;
each -L- is independently selected from C₅₋₁₄ arylene, a bond, C₂₋₆ alkenylene, and C₂₋₄ alkynylene, wherein the C₅₋₁₄ arylene and C₂₋₆ alkenylene are optionally substituted with one or more groups —R^{C};
at least one of —R^{A} and —R^{B}, and —R^{C} where present, is independently a hydrophilic group;
X is one or more counter anions;
n is from 2 to 4;
each of a, b and c is independently from 1 to 5; and
two or more of -A-, -B- and -L- are C₅₋₁₀ heteroarylene.

7. The redox flow battery of any one of claims 2 to 6 wherein each of -A- and -B- is independently C₅₋₁₀ heteroarylene, preferably C₅₋₆ heteroarylene, more preferably C₆ heteroarylene.

8. The redox flow battery of any one of claims 2 to 7 wherein each of -A- and -B- is independently C₅₋₁₀ heteroarylene having one heteroatom selected from oxygen, nitrogen and sulfur, preferably selected from nitrogen and sulfur.

9. The redox flow battery of any one of claims 2 to 8 wherein
-A- is 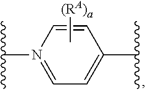
and
-B- is

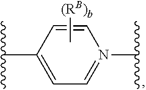

10. The redox flow battery of any one of claims 6 to 9 wherein the organic redox-active molecule is of Formula (II): 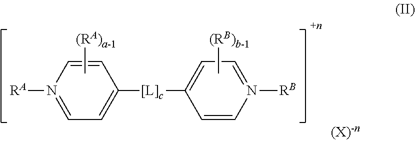
wherein -L-, —R^{A}, —R^{B}, X, n, a, b and c are as defined for Formula (I).

11. The redox flow battery of any one of claims 2 to 10 wherein each -L- is independently selected from C₆₋₁₄ carboarylene, C₅₋₁₀ heteroarylene, a bond, C₂ alkenylene, and C₂ alkynylene, more preferably -L- is independently selected from C₆₋₁₀ carboarylene and C₅₋₆ heteroarylene.

12. The redox flow battery of any one of claims 2 to 11 wherein at least one -L- is C₅₋₁₄ heteroarylene, the heteroarylene preferably having one heteroatom selected from oxygen, nitrogen and sulfur, more preferably wherein the heteroarylene is thiophenylene.

13. The redox flow battery of any one of claims 2 to 12 wherein at least one -L- is selected from anthracenylene, naphthylene and phenylene.

14. The redox flow battery of any one of claims 2 to 13 wherein -L- is independently selected from a bond and:

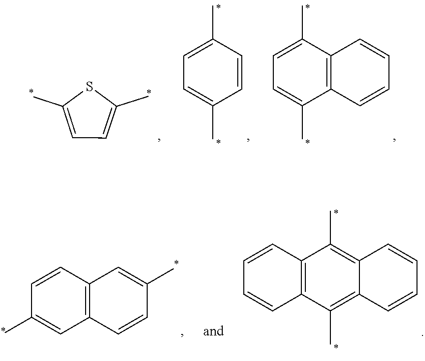

15. The redox flow battery of any one of claims 2 to 14 wherein c is 1 or 2, preferably wherein c is 1.

16. The redox flow battery of any one of claims 2 to 15 wherein each —R^{A} and —R^{B}, and each —R^{C} and —R^{D} where present, is each independently selected from:
C₁₋₆ alkyl optionally monosubstituted with a group selected from —N(R^{N})₂, —N⁺(R^{N})₃, —P⁺(R^{N})₃, —OH, —C(O)OH, —NHC(NH)NH₂, —NHC(O)NH₂ and halogen,
C₅₋₁₄ aryl optionally monosubstituted with a group selected from —(CH₂)ₙ—N(R^{N})₂, —(CH₂)ₙ—N⁺(R^{N})₃, —(CH₂)ₙ—P⁺(R^{N})₃, —(CH₂)ₙ—OH, —(CH₂)ₙ—C(O)OH, —(CH₂)ₙ—NHC(NH)NH₂, —(CH₂)ₙ—NHC(O)NH₂ and —(CH₂)ₙ-halogen, wherein n is from 0 to 6, and
—(CH₂O)ₐ₁—(C₂H₄O)ₐ₂—(C₃H₆O)ₐ₃—(CH₂C(O))ₐ₄—R^{N}, wherein a1, a2, a3 and a4 are each independently selected from 0 to 12 and the sum of a1, a2, a3 and a4 is from 1 to 12,
wherein each R^{N} is independently H or C₁₋₆ alkyl.

17. The redox flow battery of claim 16 wherein —R^{A} and —R^{B} are each independently C₂₋₄ alkyl, such as C₃ alkyl (propyl), such as n-propyl, monosubstituted with —N⁺(R^{N})₃ or —P⁺(R^{N})₃, such as monosubsituted with —N⁺(R^{N})₃.

18. The redox flow battery of claim 16 wherein —R^{A} and —R^{B} are each independently C₅₋₁₄ aryl, such as C₆ aryl, such as phenyl, monosubstituted with —N⁺(R^{N})₃, such as monosubsituted with —N⁺(R^{N})₃.

19. The redox flow battery of any one of claims 16 to 18 wherein each R^{N} is methyl or ethyl, preferably methyl.

20. The redox flow battery of any one of claims 2 to 19 wherein a and b are independently selected from 1 to 3, preferably wherein a and b are both 1.

21. The redox flow battery of claim 1 wherein the organic redox-active molecule is selected from: 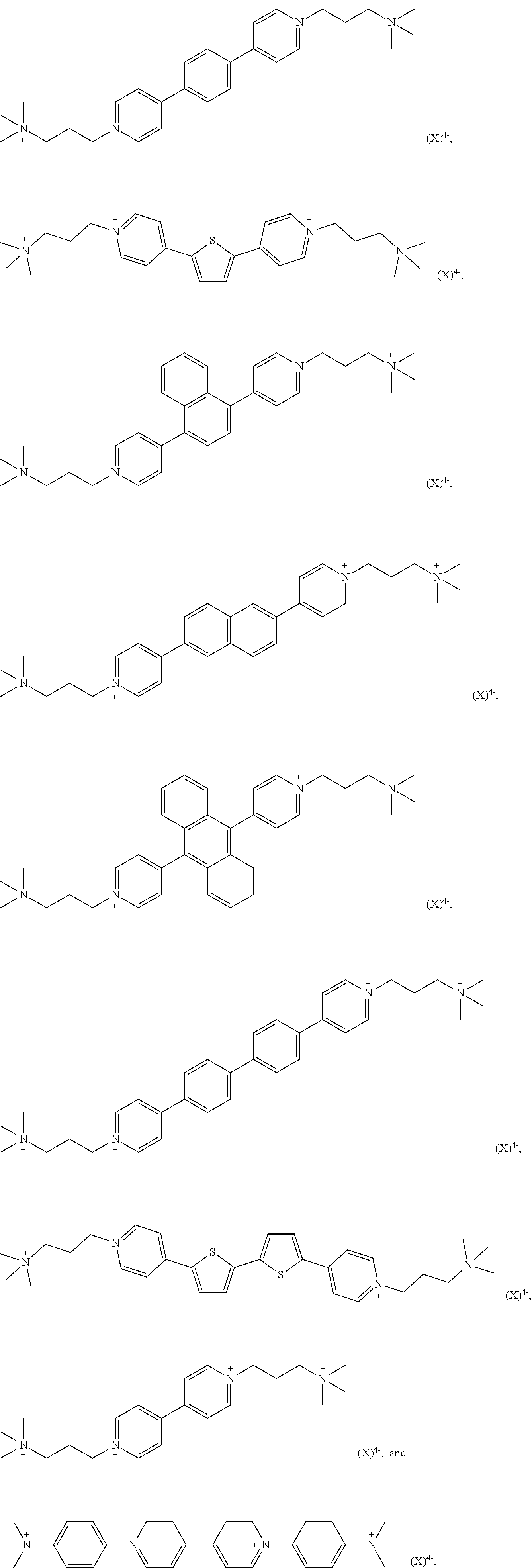
wherein X is defined as for formula (I).

22. The redox flow battery of claim 1 wherein the organic redox-active molecule is selected from: 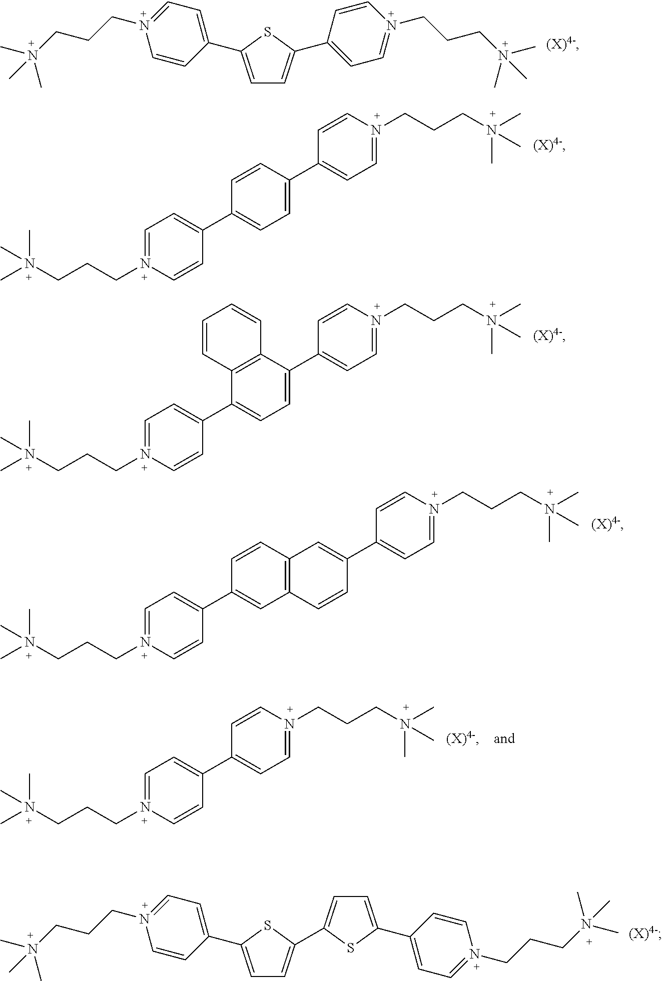
wherein X is defined as for formula (I).

23. The redox flow battery of claim 2 wherein the organic redox-active molecule is of Formula (I-C): 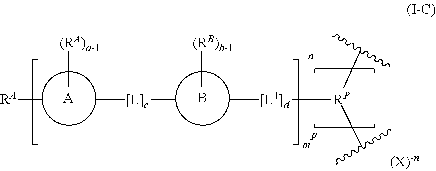
wherein:
-A-, -B-, -L-, -L¹-, —R^{A}, —R^{B}, —R^{C}, —R^{D}, X, a, b, c, d, n and m are as defined for Formula (I-A);
R^{P} is a polymer repeat unit;
p is 2 or more.

24. The redox flow battery of claim 23 wherein R^{P} is a repeat unit of a polymer selected from the group consisting of polyethylene, polypropylene, polystyrene, polyacrylate, polymethacrylate, polyester, polyamide, polyethyleneterephthalate, and polysiloxane repeat units.

25. The redox flow battery of claim 23 or claim 24 wherein p is from 2 to 200, preferably from 10 to 100.

26. The redox flow battery of claim 2 wherein the organic redox-active molecule is of Formula (I-D): 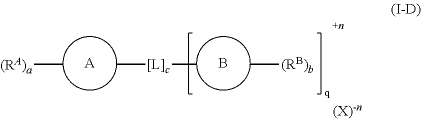
wherein:
-A-, -B-, -L-, —R^{A}, —R^{B}, —R^{C}, X, a, b, c, and n are as defined for Formula (I-A); and
q is from 1 to 5.

27. The redox flow battery of claim 26 wherein q is from 1 to 4, preferably from 1 to 3, more preferably 1 or 2.

28. The redox flow battery of any one of claims 2 to 27 wherein X is halide, hexafluorophosphate, p-toluenesulfonate, triflouromethane-sulfonate, methyl sulfonate, preferably halide, more preferably Cl⁻ or Br⁻, even more preferably Br⁻.

29. The redox flow battery of any one of claims 1 to 28 wherein the complex is a π-complex, such as a π-dimer, formed of a singly reduced form of the organic redox-active molecule.

30. The redox flow battery of any one of claim 1 to 28 wherein the complex is a dimer, such as a homodimer, formed of a singly reduced form of the organic redox-active molecule.

31. The redox flow battery of any one of claim 30 wherein the equilibrium constant for formation of the dimer from the monomer (K_{d}) is from 0.2 to 80 mM⁻¹, measured at a temperature of 20° C.

32. The redox flow battery of any one of claims 1 to 31 wherein the organic redox-active molecule is present at a concentration of 50 mM or more, preferably 150 mM or more, more preferably 250 mM or more.

33. The redox flow battery of any one of claims 1 to 32 wherein a doubly reduced form of the organic redox-active molecule has a singlet-triplet energy gap (E_{ST}) of less than 0 kcal mol⁻¹ (0 kJ mol⁻¹), preferably −6.0 kcal mol⁻¹ (−25.1 kJ mol⁻¹) or less.

34. The redox flow battery of any one of claim 1 to 33 wherein the singly reduced form of the organic redox-active molecule has an equilibrium constant for formation of a dimer from the monomer (K_{d}) (mM⁻¹) measured at a temperature of 20° C., and the doubly reduced form of the organic redox-active molecule has an E_{ST} (kcal mol⁻¹), wherein the K_{d} and E_{ST} satisfy equation (1):
$$Y \leq 3.64 * ln ( {K}_{d} ) - {E}_{ST} \qquad ( 1 )$$
wherein Y is from 15 to 30, preferably wherein Y is from 20 to 25.

35. The redox flow battery of any one of claims 1 to 34 wherein the electrolyte comprises molecular dioxygen dissolved at a partial pressure equivalent to a concentration of 1% by volume or more, preferably 10% by volume or more, more preferably 15% by volume or more yet more preferably 20% by volume or more.

36. The redox flow battery of any one of claims 1 to 35 wherein the electrolyte contacts a battery headspace, the battery headspace comprising molecular dioxygen, preferably at a concentration of 1% by volume or more, more preferably 10% by volume or more, yet more preferably 20% by volume or more.

37. A method of preparing a redox flow battery, the method comprising:
preparing an electrolyte by combining an organic redox-active molecule with a liquid carrier, wherein the organic redox-active molecule comprises a redox-active unit with two or more heteroarylene groups and the two or more heteroarylene groups are conjugated within the redox-active unit;
adding the electrolyte to the redox flow battery wherein molecular dioxygen (O₂) is dissolved in the electrolyte, and
reducing the organic redox-active molecule to provide a singly reduced form of the redox-active unit which forms a complex,
where the complex is an intermolecular complex of redox-active units, such as a homodimer, an intramolecular complex of redox-active units, or the complex is a combination of intermolecular and intermolecular complexed redox-active units.

38. The method of claim 37 wherein the method does not include purging the electrolyte and/or the battery headspace of molecular dioxygen.

39. A redox flow battery obtained or obtainable by the method of claim 37 or 38.

40. A method of charging and/or discharging a redox flow battery in the presence of molecular dioxygen, the redox flow battery comprising an electrolyte, the electrolyte comprising:
an organic redox-active molecule comprising a redox active unit with two or more heteroarylene groups wherein the two or more heteroaryl groups are conjugated within the redox-active unit, and
molecular dioxygen (O₂) dissolved in the electrolyte;
the method comprising:
reducing the redox-active unit to provide a complex formed of a singly reduced form of the redox-active unit, and/or
oxidising a double reduced form of the redox-active unit to provide a complex formed of a singly reduced form of the redox-active unit,
where the complex is an intermolecular complex of redox-active units, such as a homodimer, an intramolecular complex of redox-active units, or the complex is a combination of intermolecular and intermolecular complexed redox-active units.

41. The method of claim 40 wherein Coulombic efficiency during discharging is 75% or more, preferably 80% or more, more preferably 85% or more, even more preferably 90% or more.

42. The method of preparing a redox flow battery of claim 37 or 38 or the method of charging and/or discharging a redox flow battery of claim 40 or 41, wherein the complex is a dimer, such as a homodimer, formed of a singly reduced form of the organic redox-active molecule.

43. The method of preparing a redox flow battery of claim 37, 38 or 42, or the method of charging and/or discharging a redox flow battery of claims 40 to 42, wherein the step of reducing and/or oxidising the organic redox-active molecule occurs at a per cell voltage of 1.23 V or more, preferably 1.5 V or more.

44. Use of redox flow battery for charging and/or discharging in the presence of molecular dioxygen, the redox flow battery comprising an electrolyte, the electrolyte comprising:
an organic redox-active molecule comprising a redox-active unit with two or more heteroarylene groups wherein the two or more heteroarylene groups are conjugated within the redox-active unit, and at least a portion of the redox-active units are present as a complex formed of a singly reduced form of the redox-active unit, and
molecular dioxygen (O₂) dissolved in the electrolyte;
where the complex is an intermolecular complex of redox-active units, such as a homodimer, an intramolecular complex of redox-active units, or the complex is a combination of intermolecular and intermolecular complexed redox-active units.

45. The use of claim 44 wherein the complex is a dimer, such as a homodimer, formed of a singly reduced form of the organic redox-active molecule.
